(19) United States
(12) Patent Application Publication
(10) Pub. No.: US 2024/0385725 A1
(43) Pub. Date: Nov. 21, 2024

(54) Devices, Methods, and Graphical User Interfaces for Interacting with Three-Dimensional Environments

(71) Applicant: Apple Inc., Cupertino, CA (US)

(72) Inventors: Marcos Alonso Ruiz, Oakland, CA (US); Giancarlo Yerkes, San Francisco, CA (US); Philipp Rockel, San Francisco, CA (US); Stephen O. Lemay, Palo Alto, CA (US); William A. Sorrentino, III, Mill Valley, CA (US); Jeffrey M. Faulkner, Sisters, OR (US)

(21) Appl. No.: 18/665,189

(22) Filed: May 15, 2024

Related U.S. Application Data
(60) Provisional application No. 63/469,799, filed on May 30, 2023.
(60) Provisional application No. 63/467,576, filed on May 18, 2023.

(51) Int. Cl. G06F 3/04815; G06F 3/01; G06F 3/0488

(52) U.S. Cl. CPC G06F 3/04815; G06F 3/013; G06F 3/0488

(57) ABSTRACT

While a view of an environment is visible via the display generation component of a computer system, a first motion input that includes movement of the remote input device in a physical environment is detected. In response to detecting the first motion input and in accordance with a determination that a gaze detected by the computer system was directed to a first object when the first motion input was detected, the first object is moved in the environment in accordance with the first motion input. In response to detecting the first motion input and in accordance with a determination that the gaze detected by the computer system was not directed to the first object when the first motion input was detected, the computer system forgoes moving the first object in the environment in accordance with the first motion input.

### RELATED APPLICATIONS

This application claims priority to U.S. Provisional Patent Application No. 63/469,799, filed May 30, 2023, and U.S. Provisional Patent Application No. 63/467,576, filed May 18, 2023, each of which is hereby incorporated by reference in its entirety.

### TECHNICAL FIELD

The present disclosure relates generally to computer systems that are in communication with a display generation component and, optionally, one or more input devices that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has a touch-sensitive display (also known as a “touch screen” or “touch-screen display”). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a method is performed at a computer system that is in communication with a display generation component and with one or more input devices, including a remote input device. While a view of an environment is visible via the display generation component, a first motion input that includes movement of the remote input device in a physical environment is detected. In response to detecting the first motion input and in accordance with a determination that a gaze detected by the computer system was directed to a first object when the first motion input was detected, moving the first object in the environment in accordance with the first motion input. In response to detecting the first motion input and in accordance with a determination that the gaze detected by the computer system was not directed to the first object when the first motion input was detected, forgoing moving the first object in the environment in accordance with the first motion input.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing extended reality (XR) experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate an XR experience for the user in accordance with some embodiments.

FIG. 3 is a block diagram illustrating a display generation component of a computer system that is configured to provide a visual component of the XR experience to the user in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7R illustrate example techniques for controlling selection, placement, and manipulation of objects in a three-dimensional environment using a remote input device, in accordance with some embodiments.

FIG. 8 is a flow diagram of methods of techniques for controlling selection, placement, and manipulation of objects in a three-dimensional environment using a remote input device, in accordance with various embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system provides an improved input mechanism for controlling selection, placement, and manipulation of objects in an extended reality three-dimensional environment. Placement and/or movement of an object in the extended reality three-dimensional environment is controlled by movement inputs using a remote input device and optionally user's gaze. In some embodiments, the user's gaze is used to determine which object has input focus, and the object that has input focus is moved in accordance with characteristics of movement inputs that move the remote input device in the physical environment (e.g., including changing orientation, pose, and/or position of the remote device). In some embodiments, movement inputs also include touch inputs that are detected on a touch-sensitive surface of the remote input device or a combination of touch inputs and movements of the remote device. The input mechanism described herein provides an additional input modality (e.g., use of remote device in addition to input through gaze and/or air gestures) for target selection and movement in the extended reality three-dimensional environment, thereby allowing a user to efficiently perform complex input gestures in the extended reality three-dimensional. Controlling placement and/or movement of an object based on movement inputs performed using the remote device, reduces the amount of time, the number of inputs, and/or the complexity of inputs needed to move a selected object in the extended reality three-dimensional environment (e.g., by requiring less precision of the inputs and reducing or eliminating the needs to use user interface controls to perform the aforementioned operations).

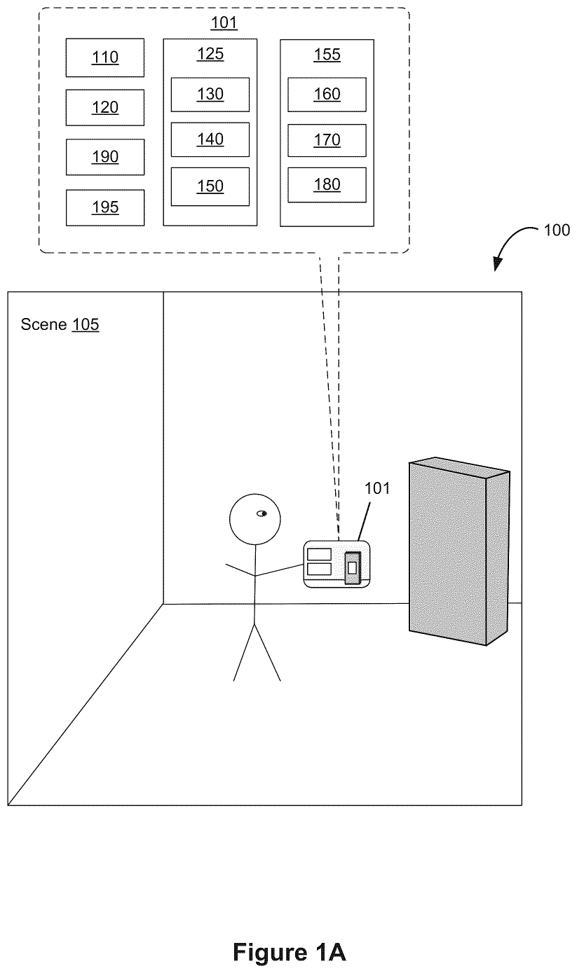

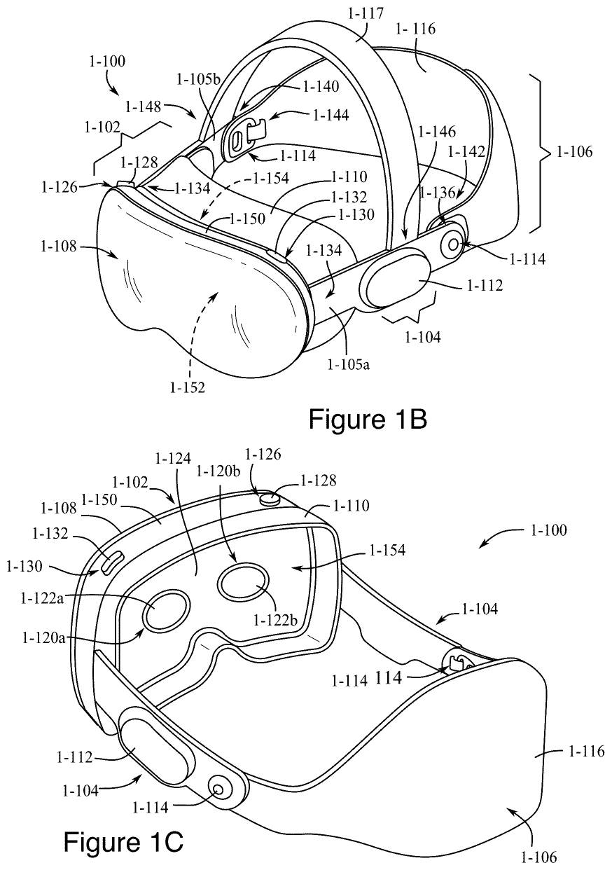

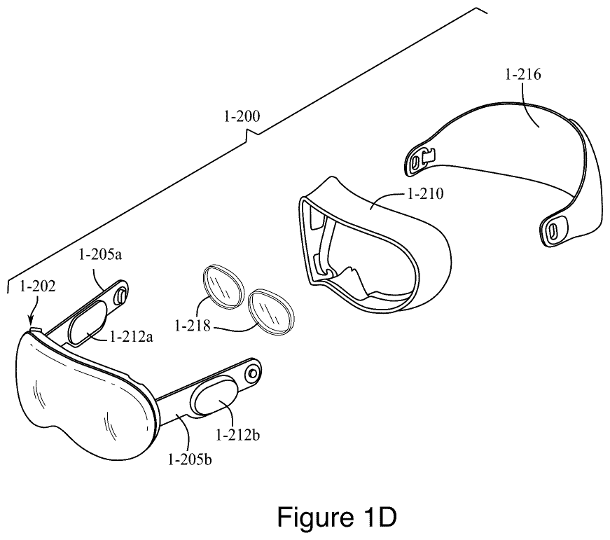

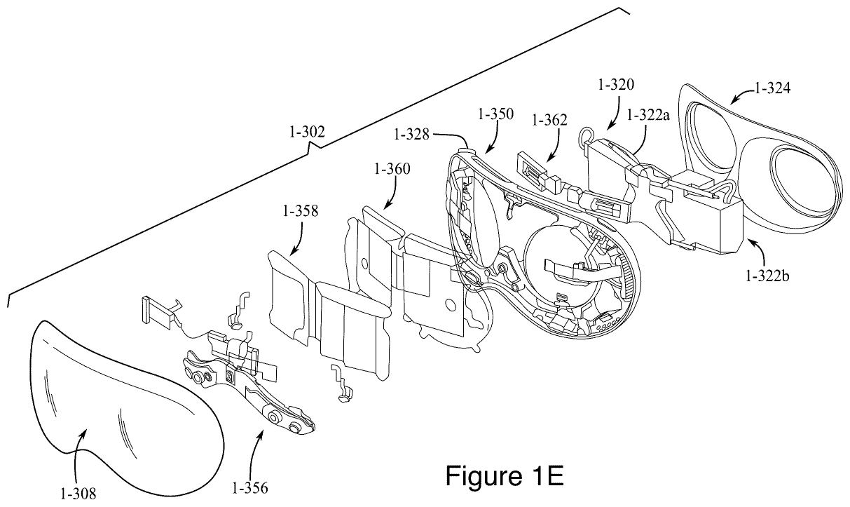

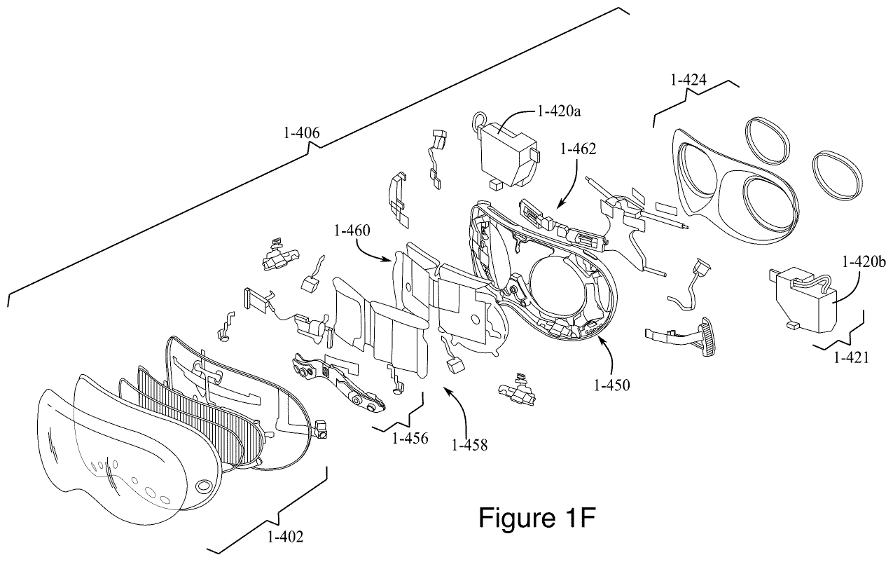

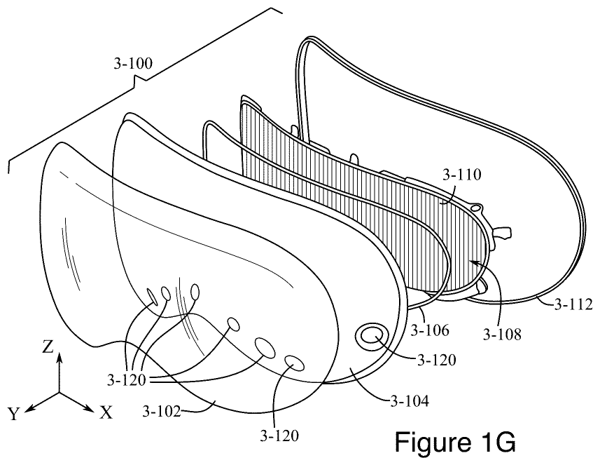

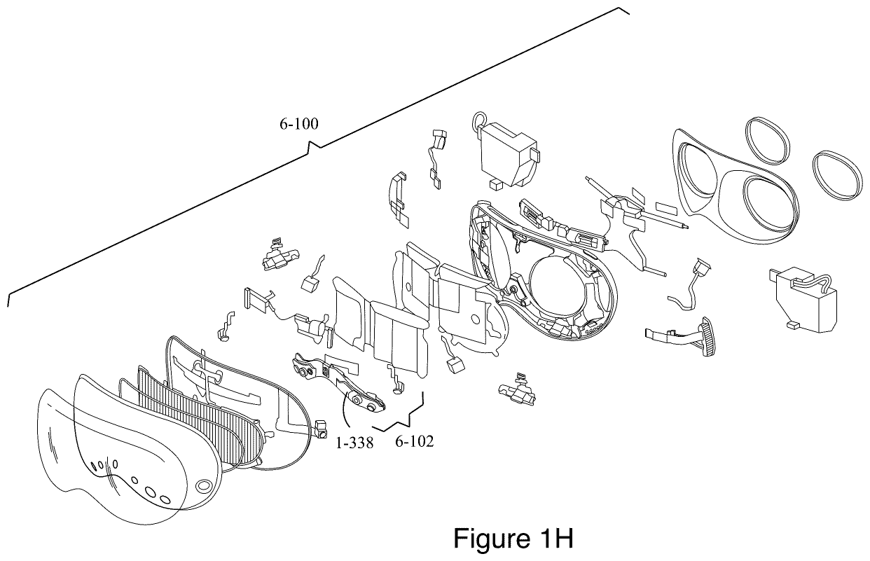

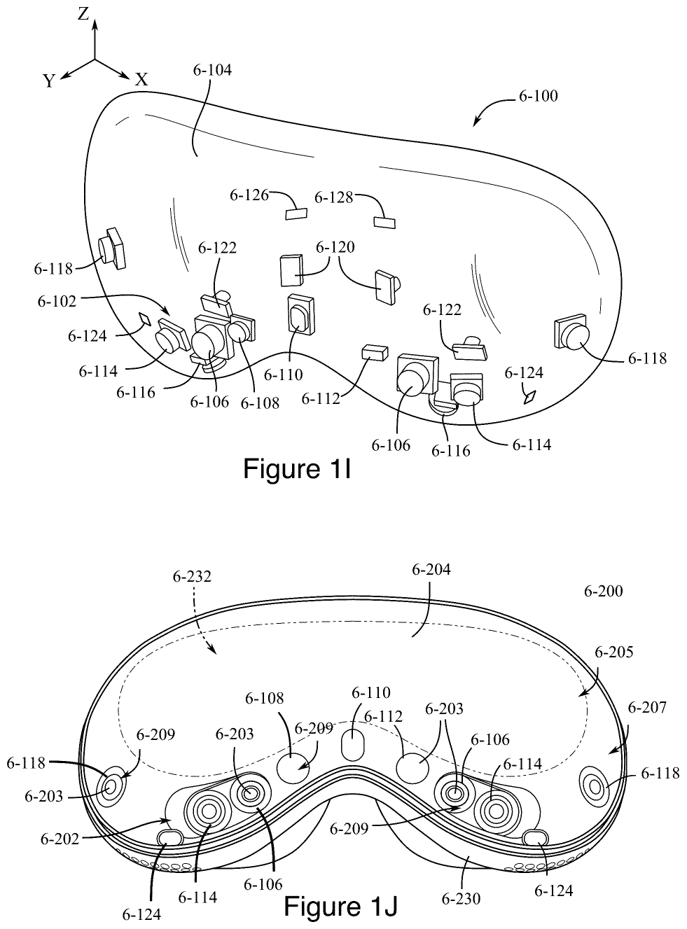

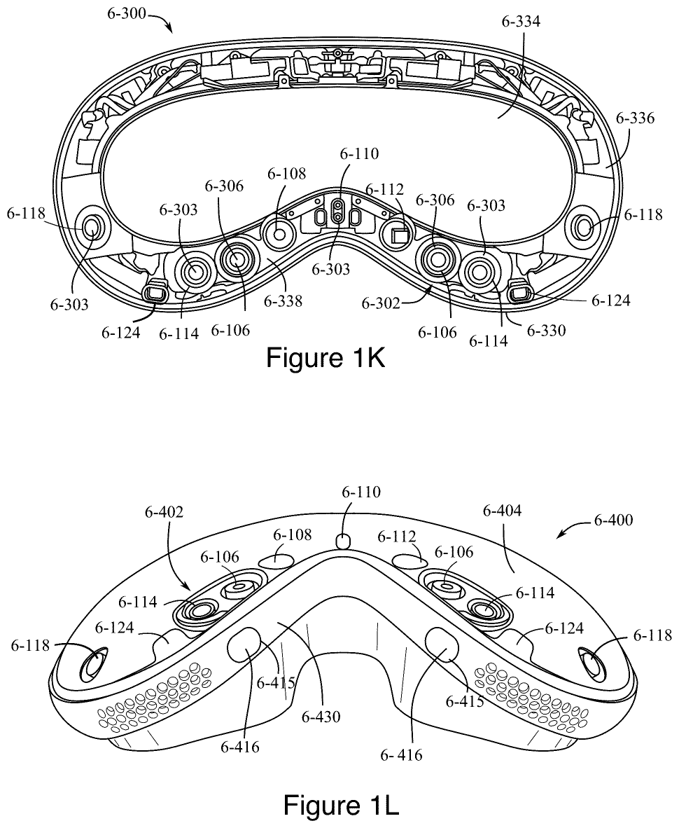

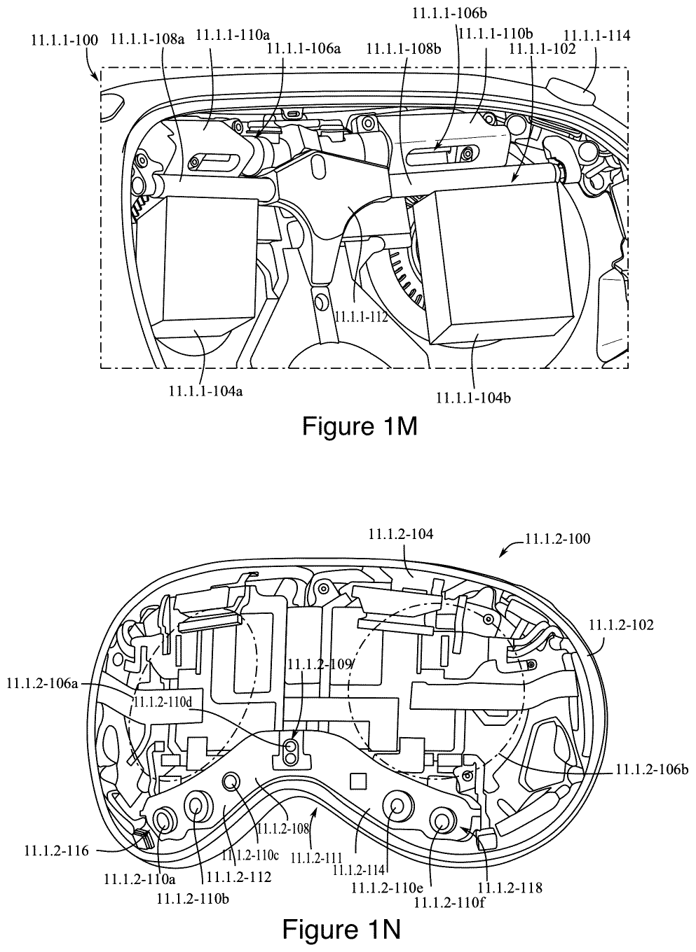

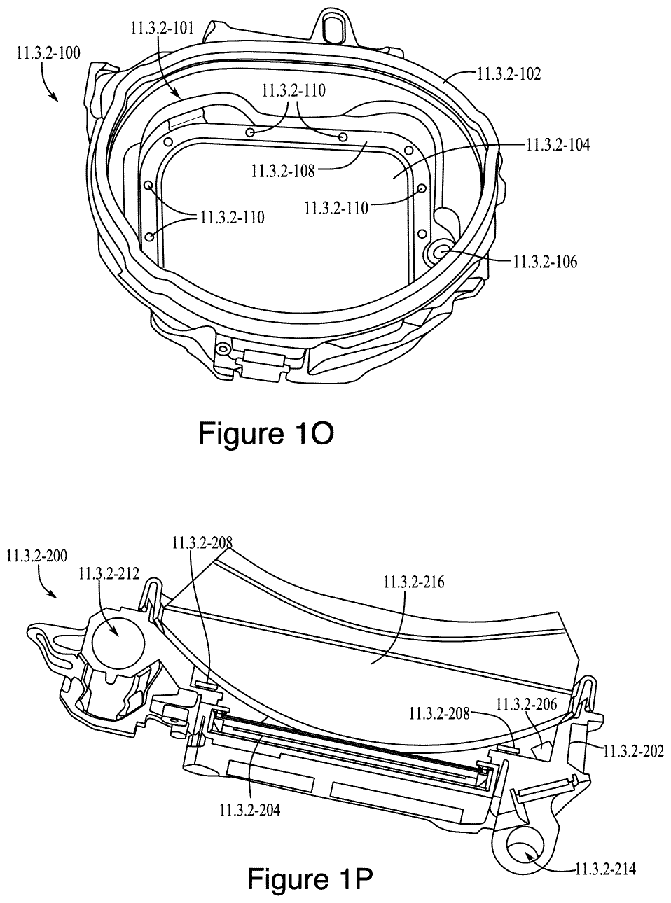

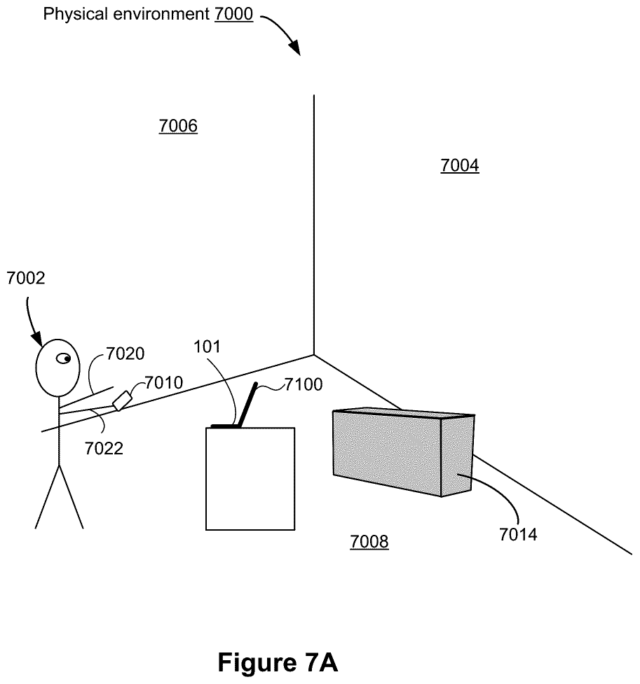

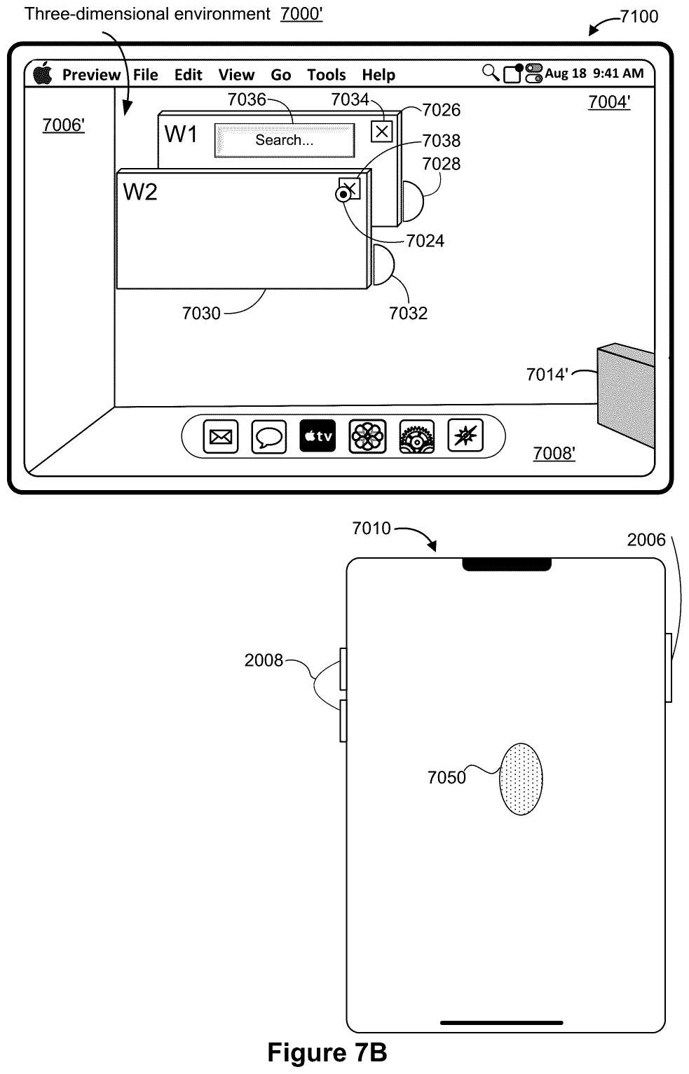

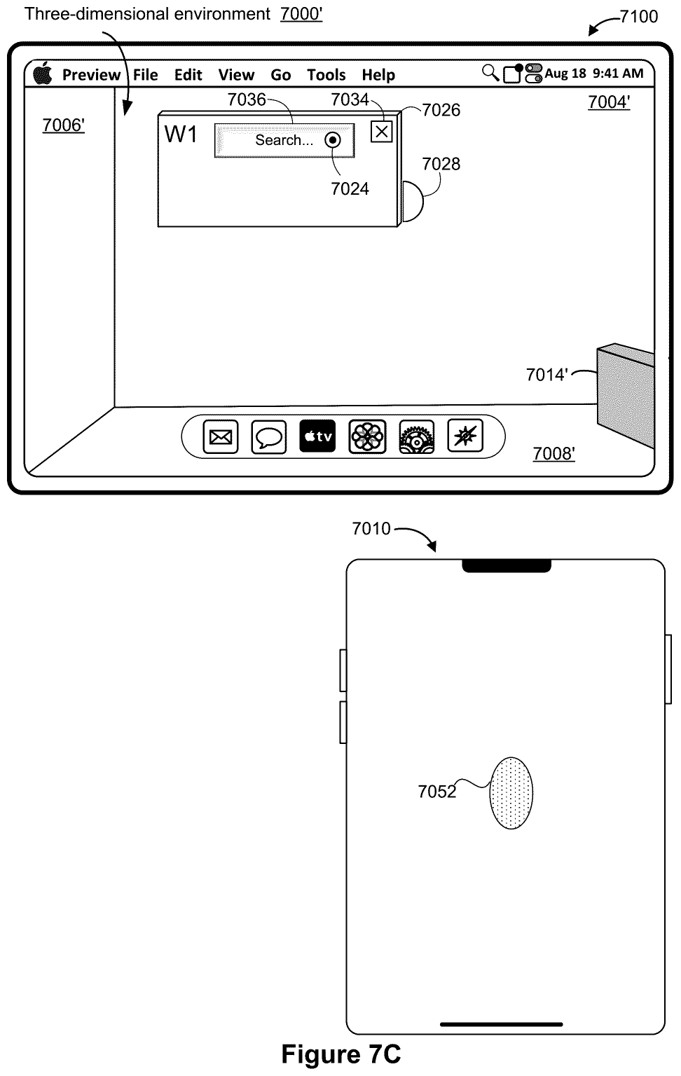

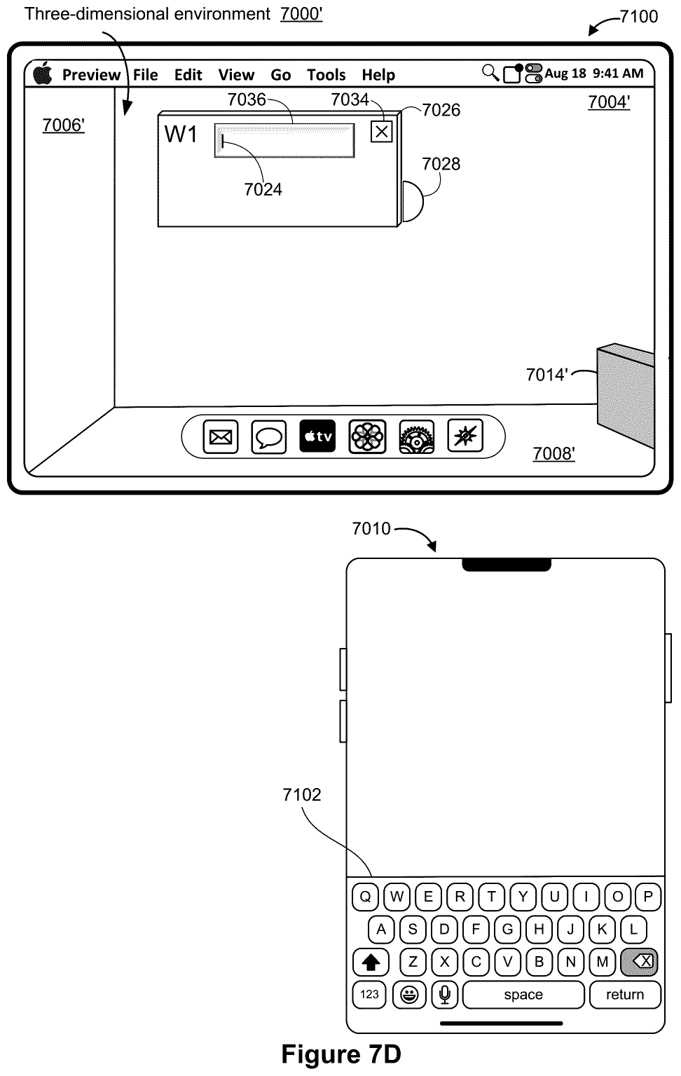

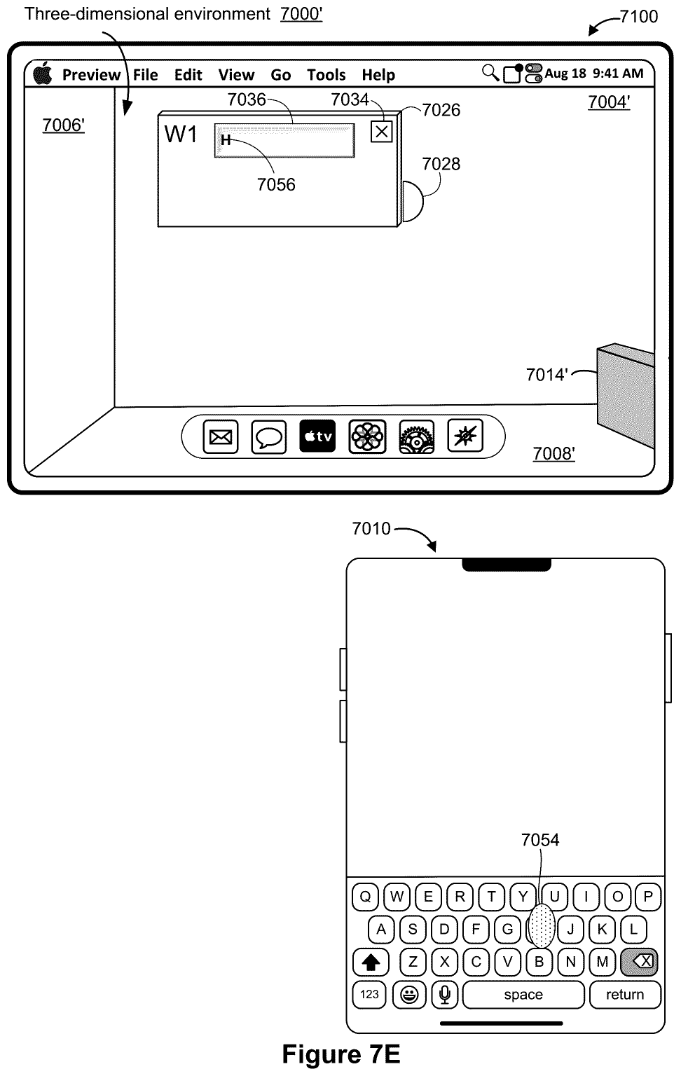

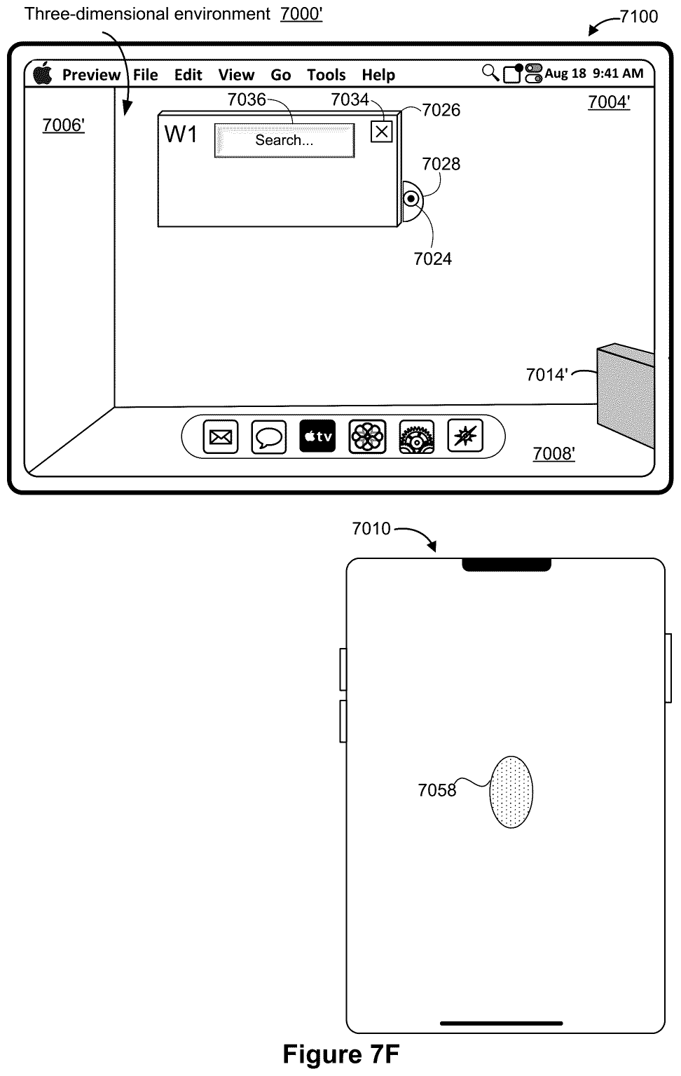

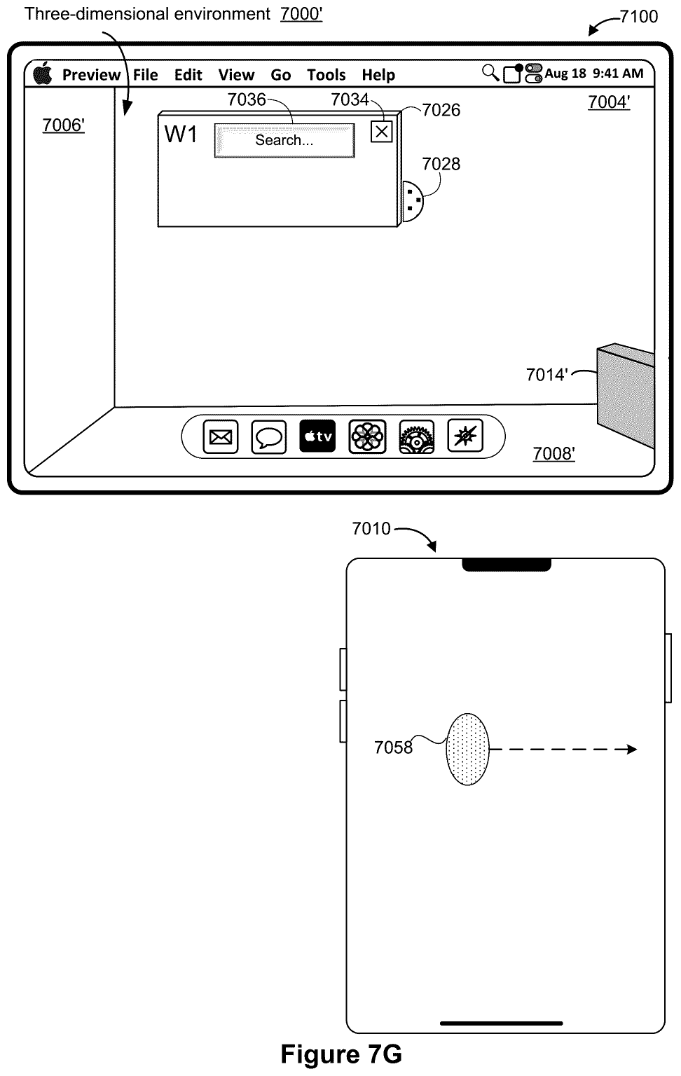

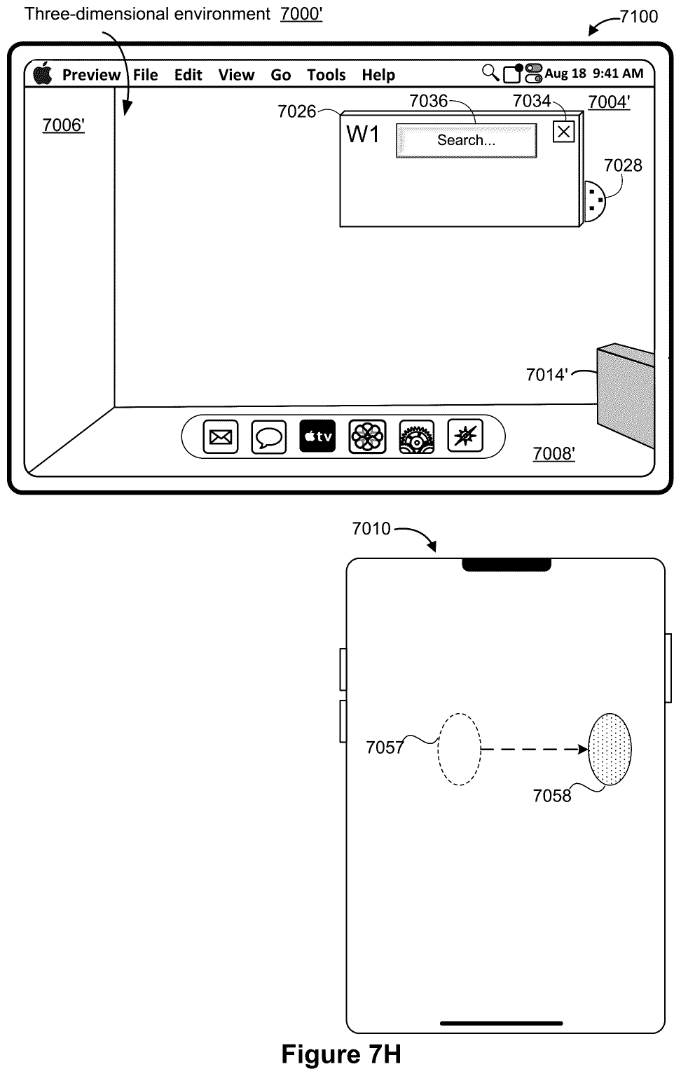

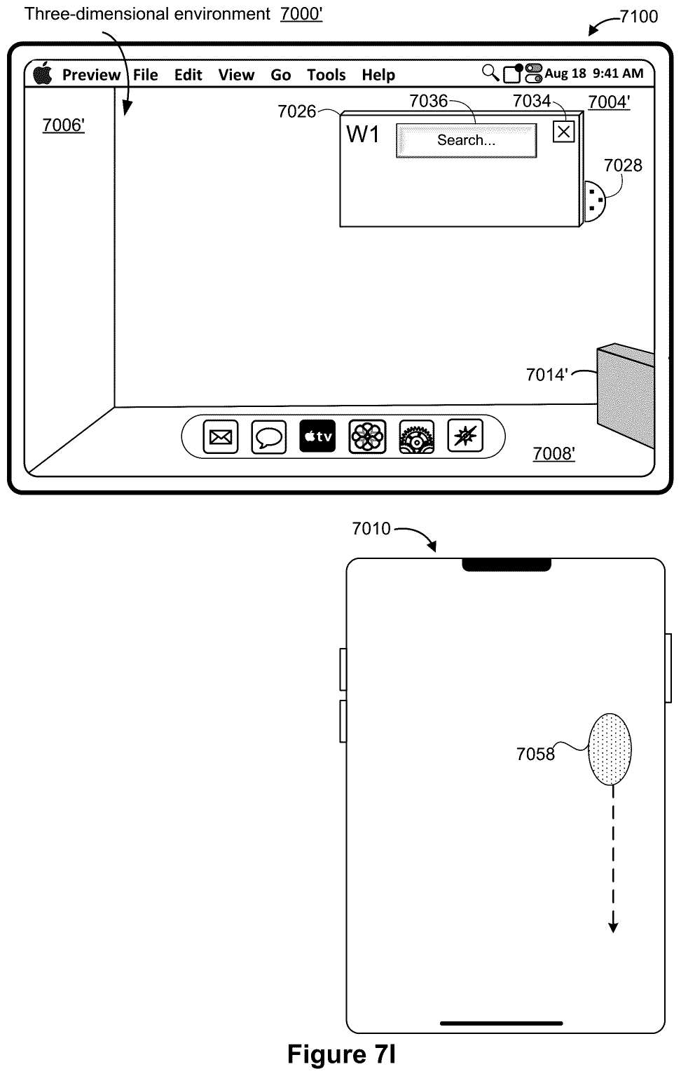

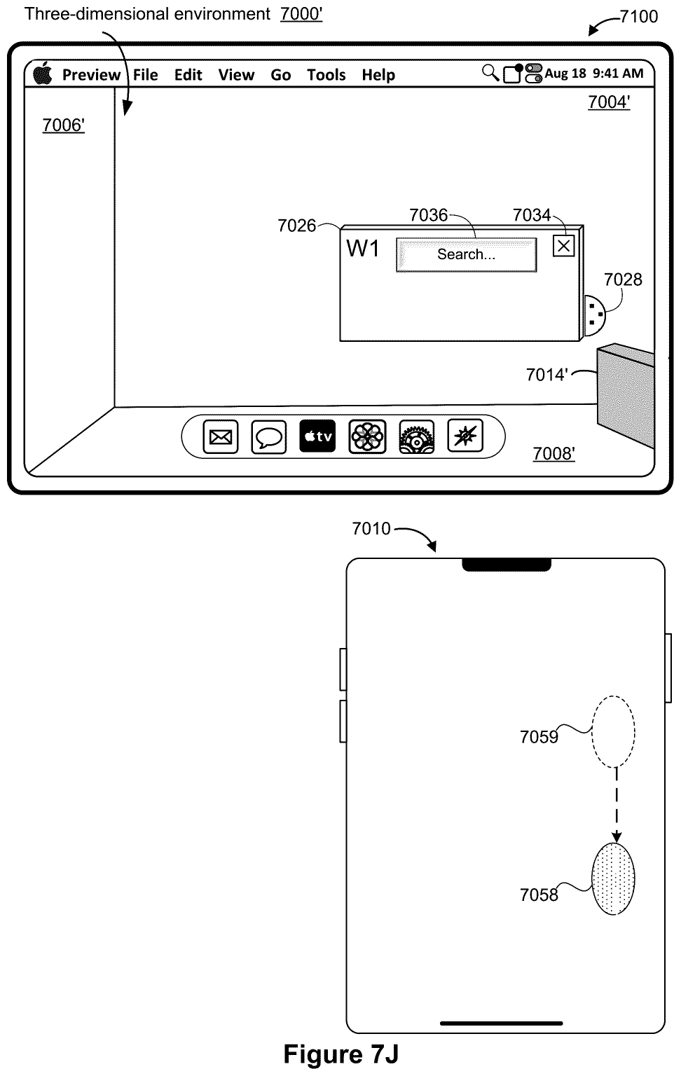

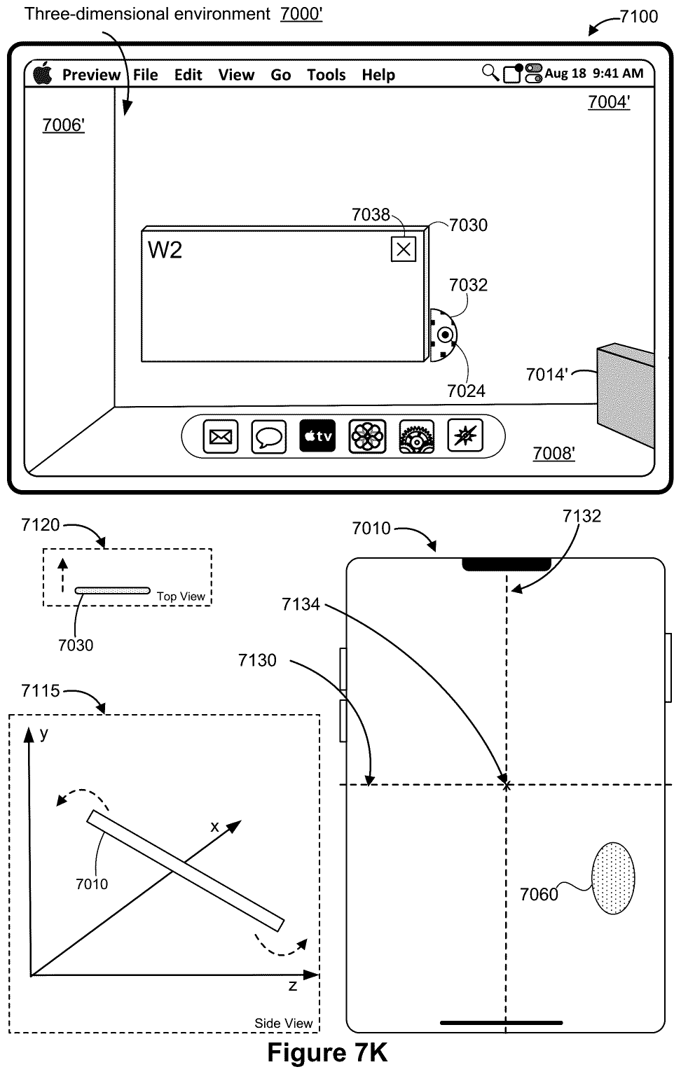

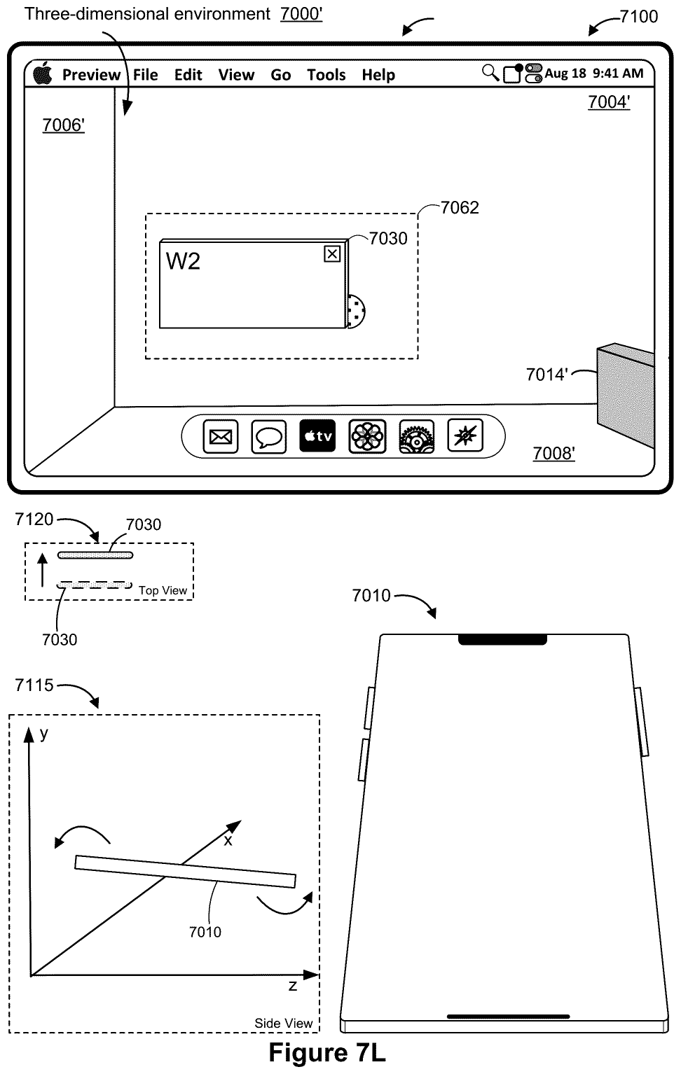

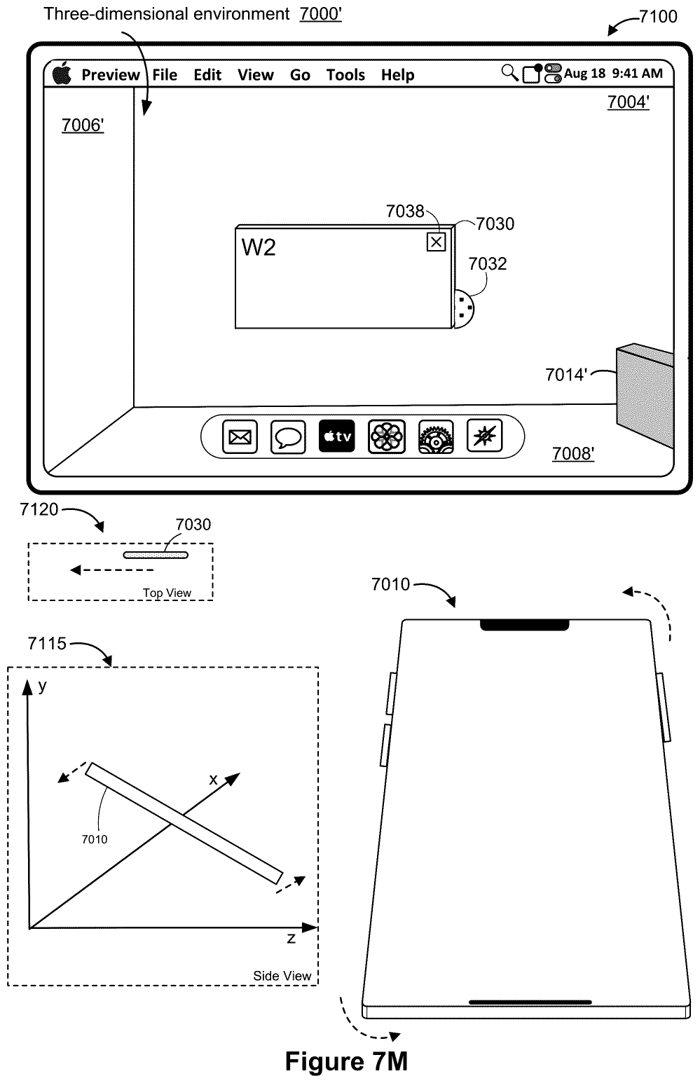

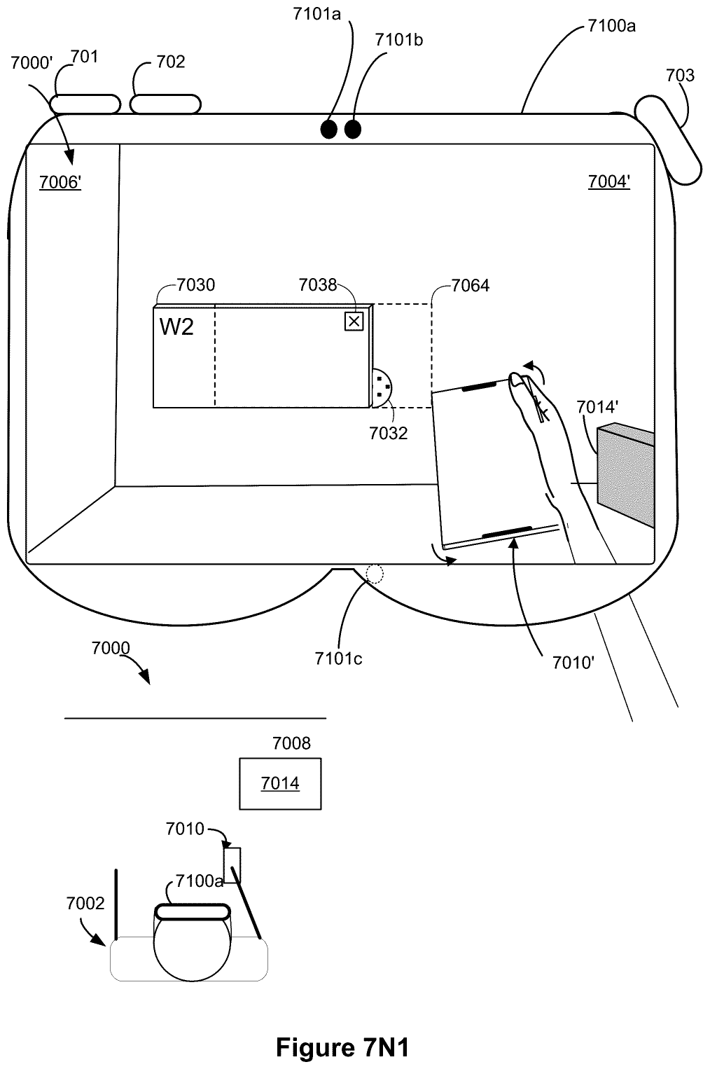

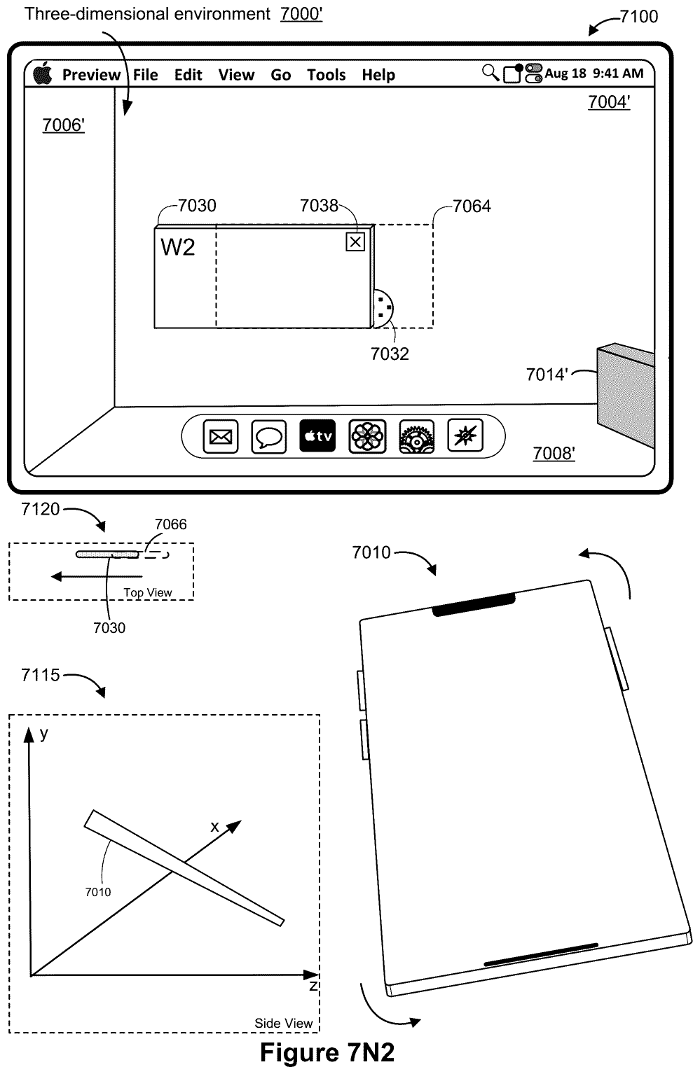

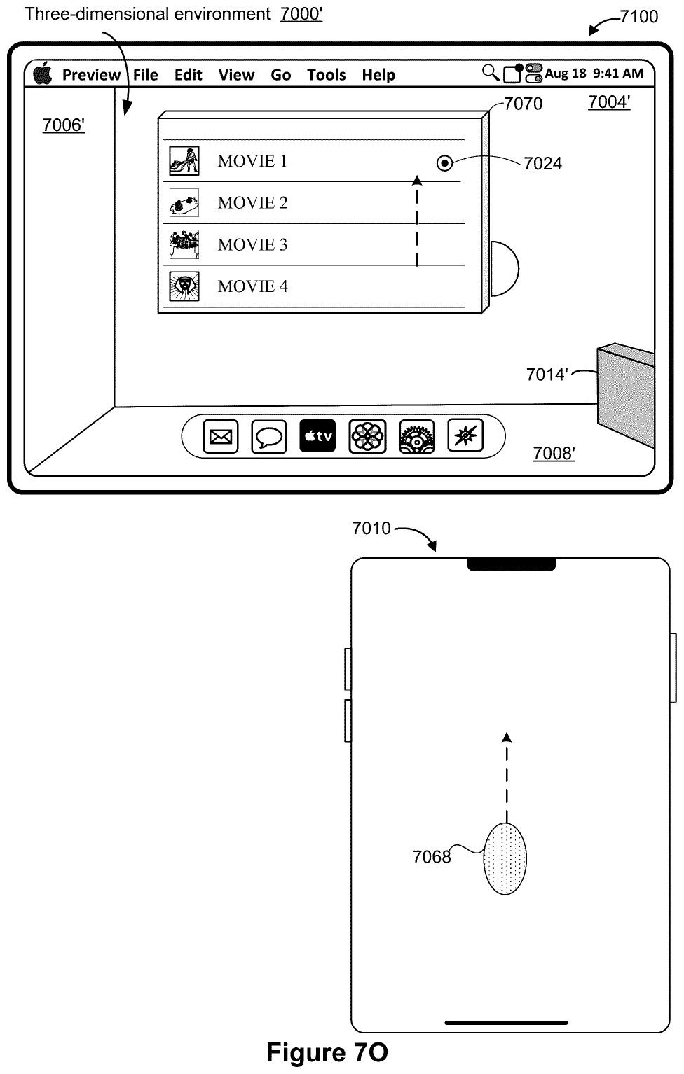

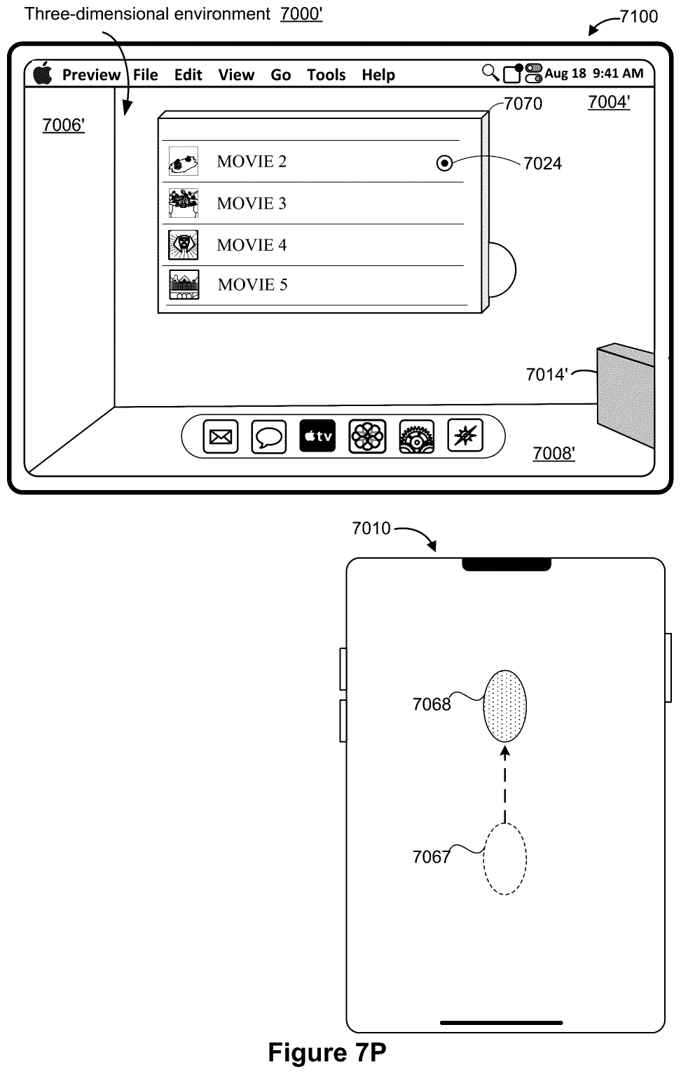

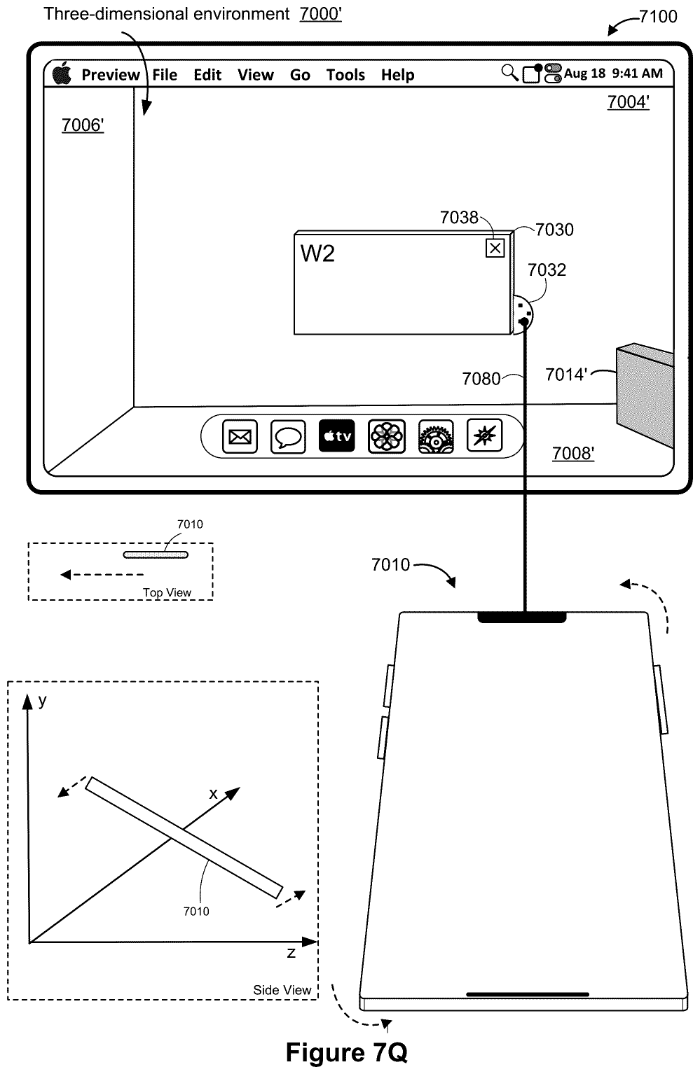

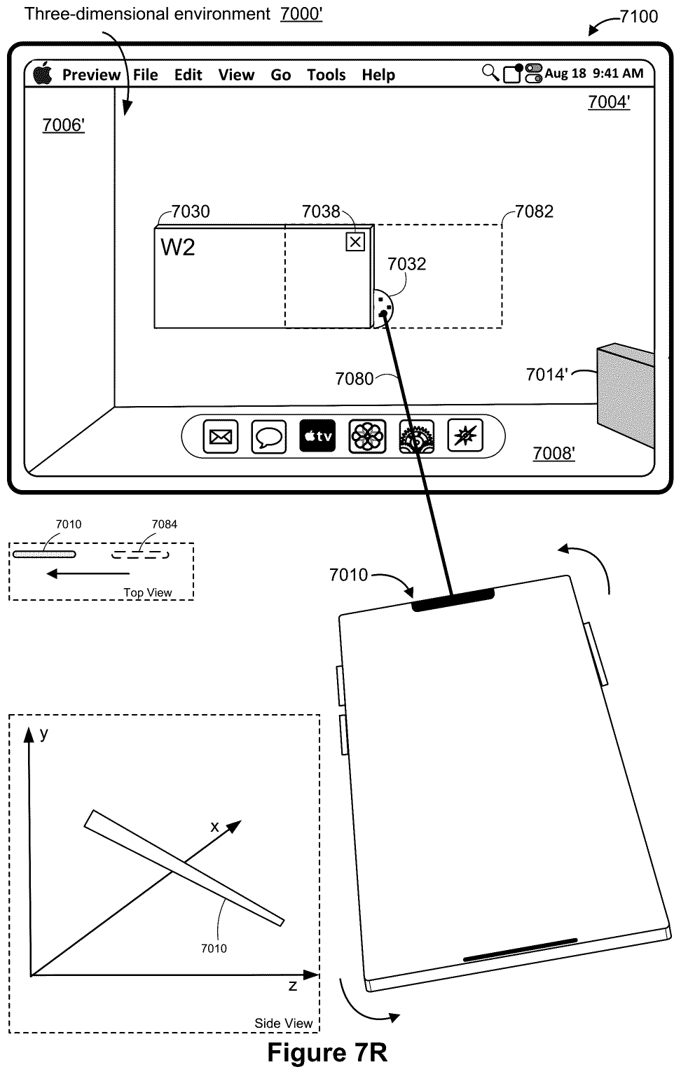

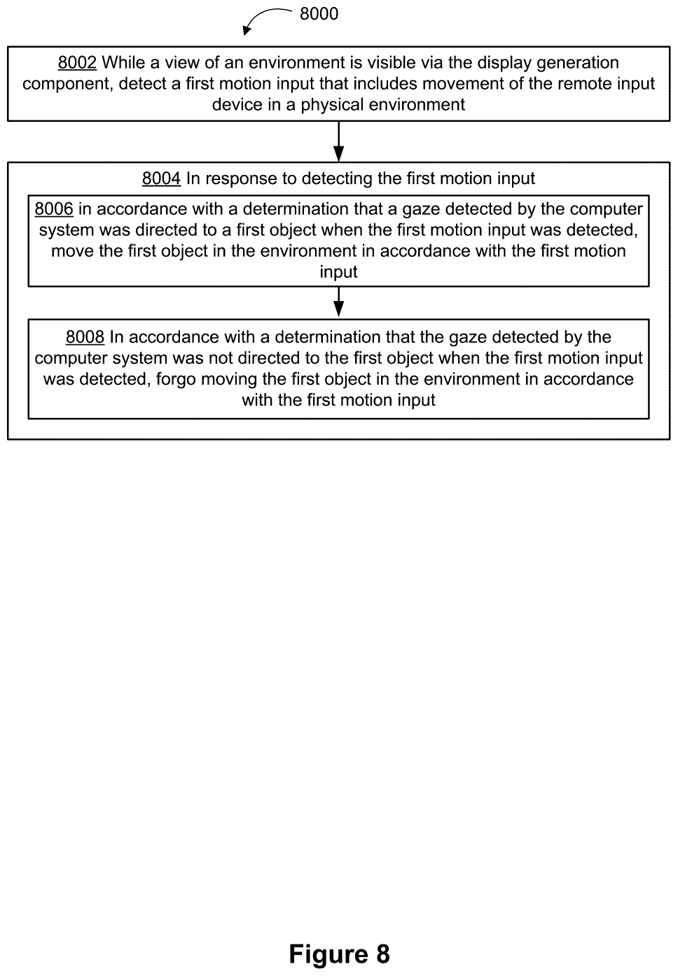

FIGS. 1A-6 provide a description of example computer systems for providing XR experiences to users. FIGS. 7A-7R illustrate example techniques for controlling selection, placement, and manipulation of objects in an extended reality three-dimensional environment using a remote input device, in accordance with some embodiments. FIG. 8 is a flow diagram of methods of controlling selection, placement, and manipulation of objects in an extended reality three-dimensional environment using a remote input device, in accordance with various embodiments. The user interfaces in FIGS. 7A-7R are used to illustrate the processes in FIG. 8, in accordance with some embodiments.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques may also reduce power usage and improve battery life of the device by enabling the user to use the device more quickly and efficiently. Saving on battery power, and thus weight, may improve the ergonomics of the device. These techniques may also allow the use of fewer and/or less precise sensors resulting in a more compact, lighter, and/or lower cost device, and/or enable the device to be used in a variety of lighting conditions. These techniques may reduce energy usage, thereby reducing heat emitted by the device, which is particularly important for a wearable device that is directly in contact with a wearer's skin. Other advantages and benefits are also possible in accordance with various embodiments.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device). In some embodiments, a remote input device, which is an input device that is not integrated into the same housing as the display generation component and is movable in the physical environment independent of and/or relative to the display generation component, communicates with the computer system and/or the display generation component, via one or more wired and/or wireless connections to provide input to the computer system.

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, an XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in an XR environment may be made in response to representations of physical motions (e.g., vocal commands). A person may sense and/or interact with an XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

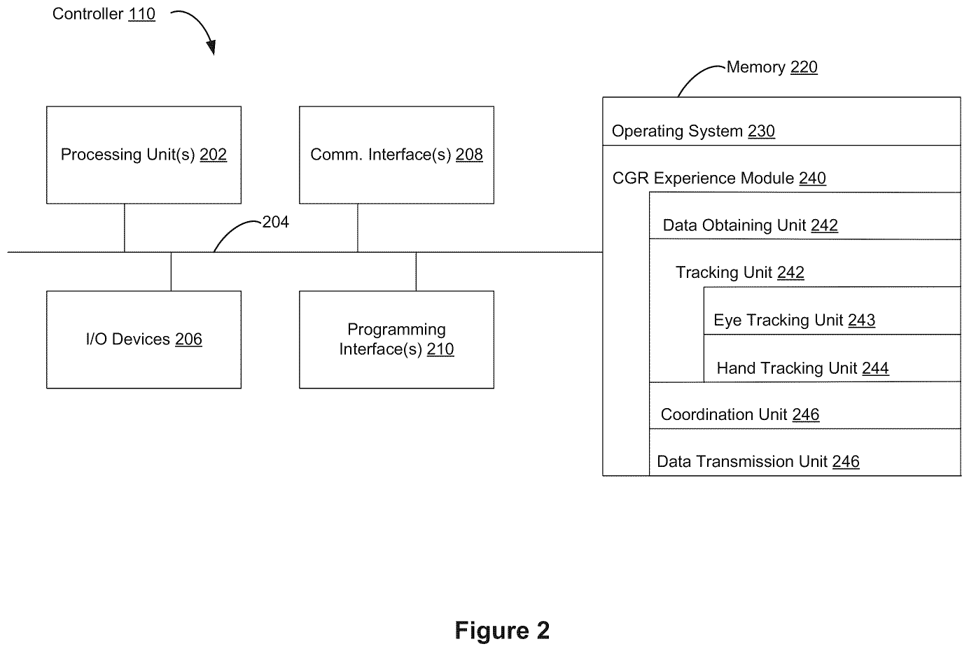

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate an XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

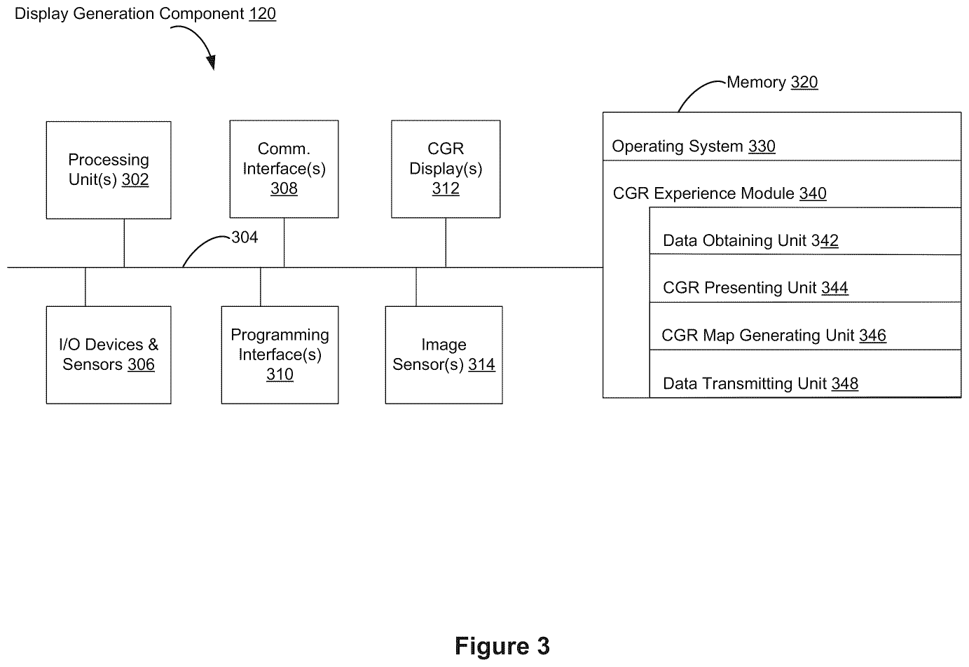

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is an XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be clastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-IF can be included, cither alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-IF and described herein. Likewise, any of the features, components, and/or parts, including the arrangements and configurations thereof shown and described with reference to FIGS. 1B, 1C, and 1E-1F can be included, cither alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and IF and described herein. Likewise, any of the features, components, and/or parts, including the arrangements and configurations thereof shown and described with reference to FIGS. 1B-1D and IF can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the checks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-IL can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 11 and 1K-1L and described herein. Likewise, any of the features, components, and/or parts, including the arrangements and configurations thereof shown and described with reference to FIGS. 11 and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 11-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 11-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and an XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 242, a tracking unit 244, a coordination unit 246, and a data transmitting unit 248.

In some embodiments, the data obtaining unit 242 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 242 includes instructions and/or logic therefor, and heuristics and metadata therefor.

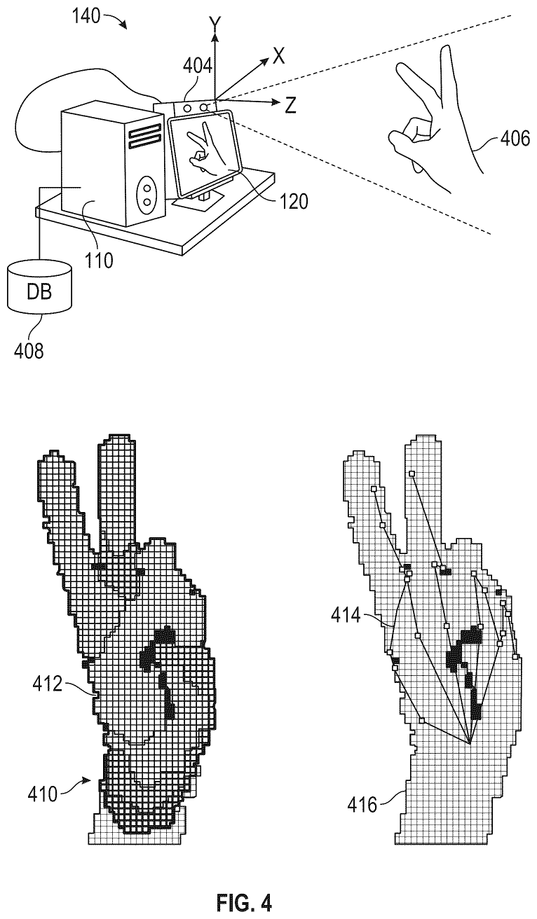

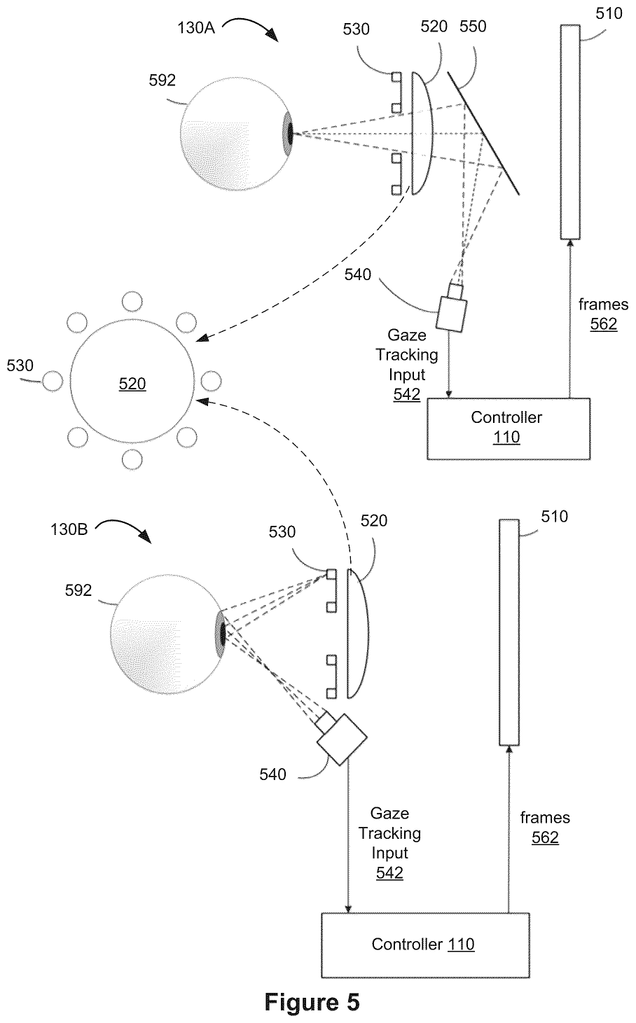

In some embodiments, the tracking unit 244 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 244 includes instructions and/or logic therefor, and heuristics and metadata therefor. In some embodiments, the tracking unit 244 includes hand tracking unit 245 and/or eye tracking unit 243. In some embodiments, the hand tracking unit 245 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 245 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 242, the tracking unit 244 (e.g., including the eye tracking unit 243 and the hand tracking unit 245), the coordination unit 246, and the data transmitting unit 248 are shown as residing on a single device (e.g., the controller 110), it should be understood that in other embodiments, any combination of the data obtaining unit 242, the tracking unit 244 (e.g., including the eye tracking unit 243 and the hand tracking unit 245), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transistor (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes an XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and an XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, an XR presenting unit 344, an XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate an XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1A) is controlled by hand tracking unit 245 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environment of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving their hand 406 and/or changing their hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves their hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and fingertips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands). In some embodiments, movement between the user's two hands (e.g., to increase and/or decrease a distance or relative orientation between the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user, user inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, wherein the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, fingertips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or an XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., light sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight light sources 530 (e.g., LEDs) are arranged around each lens 520 as an example. However, more or fewer light sources 530 may be used, and other arrangements and locations of light sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

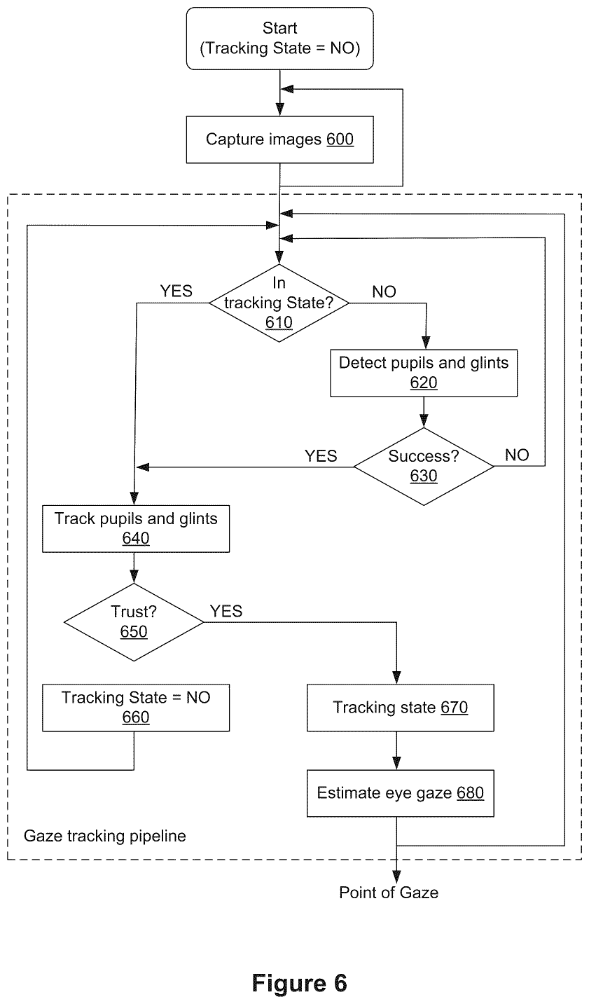

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as a portable multifunction device or a head-mounted device, in communication with a display generation component, one or more input devices, and optionally one or cameras.

FIGS. 7A-7R include illustrations of three-dimensional environments that are visible via a display generation component (e.g., a display generation component 7100, display generation component 7100-t, and/or a display generation component 120) of a computer system (e.g., computer system 101, or another computer system and/or HMD) and interactions that occur in the three-dimensional environments in accordance with user inputs directed to the three-dimensional environments and/or inputs received from other computer systems and/or sensors, in accordance with some embodiments.

In some embodiments, an input is directed to a virtual object within a three-dimensional environment by a user's gaze detected in the region occupied by the virtual object, or by a hand gesture performed at a location in the physical environment that corresponds to the region of the virtual object. In some embodiments, an input is directed to a virtual object within a three-dimensional environment by a hand gesture that is performed (e.g., optionally, at a location in the physical environment that is independent of the region of the virtual object in the three-dimensional environment) while the virtual object has input focus (e.g., while the virtual object has been selected by a concurrently and/or previously detected gaze input, selected by a concurrently or previously detected pointer input, and/or selected by a concurrently and/or previously detected gesture input). In some embodiments, an input is directed to a virtual object within a three-dimensional environment by an input device that has positioned a focus selector object (e.g., a pointer object or selector object) at the position of the virtual object. In some embodiments, an input is directed to a virtual object within a three-dimensional environment via other means (e.g., voice and/or control button). In some embodiments, an input is directed to a representation of a physical object or a virtual object that corresponds to a physical object by the user's hand movement (e.g., whole hand movement, whole hand movement in a respective posture, movement of one portion of the user's hand relative to another portion of the hand, and/or relative movement between two hands) and/or manipulation with respect to the physical object (e.g., touching, swiping, tapping, opening, moving toward, and/or moving relative to).

In some embodiments, the computer system displays some changes in the three-dimensional environment (e.g., displaying additional virtual content, ceasing to display existing virtual content, and/or transitioning between different levels of immersion with which visual content is being displayed) in accordance with inputs from sensors (e.g., image sensors, temperature sensors, biometric sensors, motion sensors, and/or proximity sensors) and contextual conditions (e.g., location, time, and/or presence of others in the environment).

In some embodiments, the computer system displays some changes in the three-dimensional environment (e.g., displaying additional virtual content, ceasing to display existing virtual content, and/or transitioning between different levels of immersion with which visual content is being displayed) in accordance with inputs from other computers used by other users that are sharing the computer-generated environment with the user of the computer system (e.g., in a shared computer-generated experience, in a shared virtual environment, and/or in a shared virtual or augmented reality environment of a communication session).

In some embodiments, the computer system displays some changes in the three-dimensional environment (e.g., displaying movement, deformation, and/or changes in visual characteristics of a user interface, a virtual surface, a user interface object, and/or virtual scenery) in accordance with inputs from sensors that detect movement of other persons and objects and movement of the user that may not qualify as a recognized gesture input for triggering an associated operation of the computer system.

In some embodiments, a three-dimensional environment that is visible via a display generation component described herein is a virtual three-dimensional environment that includes virtual objects and content at different virtual positions in the three-dimensional environment without a representation of the physical environment.

In some embodiments, the three-dimensional environment is a mixed reality environment that displays virtual objects at different virtual positions in the three-dimensional environment that are constrained by one or more physical aspects of the physical environment (e.g., positions and orientations of walls, floors, surfaces, direction of gravity, time of day, and/or spatial relationships between physical objects).

In some embodiments, the three-dimensional environment is an augmented reality environment that includes a representation of the physical environment. In some embodiments, the representation of the physical environment includes respective representations of physical objects and surfaces at different positions in the three-dimensional environment, such that the spatial relationships between the different physical objects and surfaces in the physical environment are reflected by the spatial relationships between the representations of the physical objects and surfaces in the three-dimensional environment. In some embodiments, when virtual objects are placed relative to the positions of the representations of physical objects and surfaces in the three-dimensional environment, they appear to have corresponding spatial relationships with the physical objects and surfaces in the physical environment.

In some embodiments, the computer system transitions between displaying the different types of environments (e.g., transitions between presenting a computer-generated environment or experience with different levels of immersion, adjusting the relative prominence of audio/visual sensory inputs from the virtual content and from the representation of the physical environment) based on user inputs and/or contextual conditions.

In some embodiments, the display generation component includes a pass-through portion in which the representation of the physical environment is displayed or visible. In some embodiments, the pass-through portion of the display generation component is a transparent or semi-transparent (e.g., see-through) portion of the display generation component revealing at least a portion of a physical environment surrounding and within the field of view of a user (sometimes called “optical passthrough”). For example, the pass-through portion is a portion of a head-mounted display or heads-up display that is made semi-transparent (e.g., less than 50%, 40%, 30%, 20%, 15%, 10%, or 5% of opacity) or transparent, such that the user can see through it to view the real world surrounding the user without removing the head-mounted display or moving away from the heads-up display. In some embodiments, the pass-through portion gradually transitions from semi-transparent or transparent to fully opaque when displaying a virtual or mixed reality environment. In some embodiments, the pass-through portion of the display generation component displays a live feed of images or video of at least a portion of physical environment captured by one or more cameras (e.g., rear facing camera(s) of a mobile device or associated with a head-mounted display, or other cameras that feed image data to the computer system) (sometimes called “digital passthrough”). In some embodiments, the one or more cameras point at a portion of the physical environment that is directly in front of the user's eyes (e.g., behind the display generation component relative to the user of the display generation component). In some embodiments, the one or more cameras point at a portion of the physical environment that is not directly in front of the user's eyes (e.g., in a different physical environment, or to the side of or behind the user).

In some embodiments, when displaying virtual objects at positions that correspond to locations of one or more physical objects in the physical environment (e.g., at positions in a virtual reality environment, a mixed reality environment, or an augmented reality environment), at least some of the virtual objects are displayed in place of (e.g., replacing display of) a portion of the live view (e.g., a portion of the physical environment captured in the live view) of the cameras. In some embodiments, at least some of the virtual objects and content are projected onto physical surfaces or empty space in the physical environment and are visible through the pass-through portion of the display generation component (e.g., viewable as part of the camera view of the physical environment, or through the transparent or semi-transparent portion of the display generation component). In some embodiments, at least some of the virtual objects and virtual content are displayed to overlay a portion of the display and block the view of at least a portion of the physical environment visible through the transparent or semi-transparent portion of the display generation component.

In some embodiments, the display generation component displays different views of the three-dimensional environment in accordance with user inputs or movements that change the virtual position of the viewpoint of the currently displayed view of the three-dimensional environment relative to the three-dimensional environment. In some embodiments, when the three-dimensional environment is a virtual environment, the viewpoint moves in accordance with navigation or locomotion requests (e.g., in-air hand gestures, and/or gestures performed by movement of one portion of the hand relative to another portion of the hand) without requiring movement of the user's head, torso, and/or the display generation component in the physical environment. In some embodiments, movement of the user's head and/or torso, and/or the movement of the display generation component or other location sensing elements of the computer system (e.g., due to the user holding the display generation component or wearing the HMD 7100a), relative to the physical environment, cause corresponding movement of the viewpoint (e.g., with corresponding movement direction, movement distance, movement speed, and/or change in orientation) relative to the three-dimensional environment, resulting in corresponding change in the currently displayed view of the three-dimensional environment. In some embodiments, when a virtual object has a respective spatial relationship relative to the viewpoint (e.g., is anchored or fixed to the viewpoint), movement of the viewpoint relative to the three-dimensional environment would cause movement of the virtual object relative to the three-dimensional environment while the position of the virtual object in the field of view is maintained (e.g., the virtual object is said to be head locked). In some embodiments, a virtual object is body-locked to the user, and moves relative to the three-dimensional environment when the user moves as a whole in the physical environment (e.g., carrying or wearing the display generation component and/or other location sensing component of the computer system), but will not move in the three-dimensional environment in response to the user's head movement alone (e.g., the display generation component and/or other location sensing component of the computer system rotating around a fixed location of the user in the physical environment). In some embodiments, a virtual object is, optionally, locked to another portion of the user, such as a user's hand or a user's wrist, and moves in the three-dimensional environment in accordance with movement of the portion of the user in the physical environment, to maintain a respective spatial relationship between the position of the virtual object and the virtual position of the portion of the user in the three-dimensional environment. In some embodiments, a virtual object is locked to a preset portion of a field of view provided by the display generation component, and moves in the three-dimensional environment in accordance with the movement of the field of view, irrespective of movement of the user that does not cause a change of the field of view.

In some embodiments, as shown in FIGS. 7A-7R, the views of a three-dimensional environment do not include representation(s) of a user's hand(s), arm(s), and/or wrist(s). In some embodiments, as shown in FIGS. 7A-7R, the views of a three-dimensional environment do not include a representation of a remote input device that is used to control the interaction with the three-dimensional environment. In some embodiments, the representation(s) of a user's hand(s), arm(s), and/or wrist(s), and/or the remote input device are included in the views of a three-dimensional environment (e.g., as illustrated in FIG. 7N1, where representation 7010′ of remote input device 7010 and/or a representation of the user's hand are displayed by HMD 7100a). In some embodiments, the representation(s) of a user's hand(s), arm(s), and/or wrist(s), and/or the representation of the remote input device, are included in the views of a three-dimensional environment as part of the representation of the physical environment provided via the display generation component. In some embodiments, the representations are not part of the representation of the physical environment and are separately captured (e.g., by one or more cameras pointing toward the user's hand(s), arm(s), and wrist(s)), and/or the remote input device, and displayed in the three-dimensional environment independent of the currently displayed view of the three-dimensional environment. In some embodiments, the representation(s) include camera images as captured by one or more cameras of the computer system(s), or stylized versions of the arm(s), wrist(s) and/or hand(s), and/or the remote input device, based on information captured by various sensors). In some embodiments, the representation(s) replace display of, are overlaid on, or block the view of, a portion of the representation of the physical environment. In some embodiments, when the display generation component does not provide a view of a physical environment, and provides a completely virtual environment (e.g., no camera view and no transparent pass-through portion), real-time visual representations (e.g., stylized representations or segmented camera images) of one or both arms, wrists, and/or hands of the user, and/or of the remote input device, are, optionally, still displayed in the virtual environment. In some embodiments, if a representation of the user's hand is not provided in the view of the three-dimensional environment, the position that corresponds to the user's hand is optionally indicated in the three-dimensional environment, e.g., by the changing appearance of the virtual content (e.g., through a change in translucency and/or simulated reflective index) at positions in the three-dimensional environment that correspond to the location of the user's hand in the physical environment. In some embodiments, if a representation of the remote input device is not provided in the view of the three-dimensional environment, the position that corresponds to the remote input device is optionally indicated in the three-dimensional environment, e.g., by the changing appearance of the virtual content (e.g., through a change in translucency and/or simulated reflective index) at positions in the three-dimensional environment that correspond to the location of the remote input device in the physical environment. In some embodiments, if a representation of the user's hand is not provided in the view of the three-dimensional environment, the position that corresponds to the user's hand is optionally indicated in the three-dimensional environment, e.g., by the changing appearance of the virtual content (e.g., through a change in translucency and/or simulated reflective index) at positions in the three-dimensional environment that correspond to the location of the user's hand in the physical environment. In some embodiments, if a representation of the remote input device is not provided in the view of the three-dimensional environment, the position that corresponds to the remote input device is optionally indicated in the three-dimensional environment, e.g., by the changing appearance of the virtual content (e.g., through a change in translucency and/or simulated reflective index) at positions in the three-dimensional environment that correspond to the location of the remote input device in the physical environment. In some embodiments, the representation of the user's hand or wrist is outside of the currently displayed view of the three-dimensional environment while the virtual position in the three-dimensional environment that corresponds to the location of the user's hand or wrist is outside of the current field of view provided via the display generation component; and the representation of the user's hand or wrist is made visible in the view of the three-dimensional environment in response to the virtual position that corresponds to the location of the user's hand or wrist being moved within the current field of view due to movement of the display generation component, the user's hand or wrist, the user's head, and/or the user as a whole. In some embodiments, the representation of the remote input device is outside of the currently displayed view of the three-dimensional environment while the virtual position in the three-dimensional environment that corresponds to the location of the remote input device is outside of the current field of view provided via the display generation component; and the representation of the remote input device is made visible in the view of the three-dimensional environment in response to the virtual position that corresponds to the location of the remote input device being moved within the current field of view due to movement of the display generation component.

FIGS. 7A-7R illustrate examples of controlling selection, placement, and manipulation of objects in an extended reality three-dimensional environment using a remote input device. FIG. 8 is a flow diagram of an exemplary method 800 for controlling selection, placement, and manipulation of objects in an extended reality three-dimensional environment using a remote input device. The user interfaces in FIGS. 7A-7R are used to illustrate the processes described below, including the processes in FIG. 8.

As shown in the examples in FIGS. 7A-7R, display generation component 7100 of computer system 101 includes a touchscreen, in accordance with some embodiments. In some embodiments, the display generation component of computer system 101 is a head-mounted display worn on user 7002's head (e.g., what is shown in FIGS. 7A-7R as being visible via display generation component 7100 of computer system 101 corresponds to user 7002's field of view when wearing a head-mounted display (e.g., HMD 7100a, FIG. 7N1)). In some embodiments, the display generation component is a standalone display, a projector, or another type of display. In some embodiments, the computer system is in communication with one or more input devices (e.g., various types of sensors, cameras, touch-sensitive surfaces, portable multifunctional device 7010 that includes one or more input devices and/or sensors, handheld controllers, and/or another types of input device).

In some embodiments, display generation component 7100 of computer system 101 comprises a head mounted display (HMD) 7100a. For example, as illustrated in FIG. 7N1, the head mounted display 7100a includes one or more displays that displays a representation of a portion of the three-dimensional environment 7000′ that corresponds to the perspective of the user, while an HMD typically includes multiple displays including a display for a right eye and a separate display for a left eye that display slightly different images to generate user interfaces with stereoscopic depth, in the figures a single image is shown that corresponds to the image for a single eye and depth information is indicated with other annotations or description of the figures. In some embodiments, HMD 7100a includes one or more sensors (e.g., one or more interior- and/or exterior-facing image sensors 314), such as sensor 7101a, sensor 7101b and/or sensor 7101c for detecting a state of the user, including facial and/or eye tracking of the user (e.g., using one or more inward-facing sensors 7101a and/or 7101b) and/or tracking hand, torso, or other movements of the user (e.g., using one or more outward-facing sensors 7101c). In some embodiments, HMD 7100a includes one or more input devices that are optionally located on a housing of HMD 7100a, such as one or more buttons, trackpads, touchscreens, scroll wheels, digital crowns that are rotatable and depressible or other input devices. In some embodiments input elements are mechanical input elements, in some embodiments input elements are solid state input elements that respond to press inputs based on detected pressure or intensity. For example, in FIG. 7N1, HMD 7100a includes one or more of button 701, button 702 and digital crown 703 for providing inputs to HMD 7100a. It will be understood that additional and/or alternative input devices may be included in HMD 7100a.

The bottom portion of FIG. 7N1 illustrates a top-down view of the user 7002 in the physical environment 7000. For example, the user 7002 is wearing HMD 7100a, such that the remote input device 7010 is physically present within the physical environment 7000 behind the display of HMD 7100a, and optionally in front of the physical object 7014 (e.g., where a representation 7014′ of the physical object 7014 is displayed as farther away from the user's viewpoint).

FIG. 7N1 illustrates an alternative display generation component of the computer system than the display generation component 7100 illustrated in FIGS. 7A-7M and 7N2-7R. It will be understood that the processes, features and functions described herein with reference to the display generation component 7100 described in FIGS. 7A-7M and 7N2-7R are also applicable to HMD 7100a, illustrated in FIG. 7N1.

In some embodiments, the one or more input devices include cameras or other sensors and input devices that detect movement of the user's hand(s), movement of the user's body as whole, and/or movement of the user's head in the physical environment. In some embodiments, the one or more input devices detect the movement and the current postures, orientations, and positions of the user's hand(s), face, and/or body as a whole. In some embodiments, user inputs are detected via a touch-sensitive surface or touchscreen. In some embodiments, the one or more input devices include an eye tracking component that detects location and movement of the user's gaze. In some embodiments, the display generation component, and optionally, at least some of the one or more input devices and the computer system, are parts of a head-mounted device that moves and rotates with the user's head in the physical environment, and changes the viewpoint of the user in the three-dimensional environment provided via the display generation component. In some embodiments, the display generation component is a heads-up display that does not move or rotate with the user's head or the user's body as a whole, but, optionally, changes the viewpoint of the user in the three-dimensional environment in accordance with the movement of the user's head or body relative to the display generation component. In some embodiments, the display generation component (e.g., a touchscreen, or a standalone display) is optionally moved and rotated by the user's hand relative to the physical environment or relative to the user's head, and changes the viewpoint of the user in the three-dimensional environment in accordance with the movement of the display generation component relative to the user's head or face or relative to the physical environment.

In some embodiments, the one or more input devices include portable multifunctional device 7010 (also referred to remote input device 7010), and the computer system 101 is in communication with remote input device 7010. As shown in FIG. 7A, computer system 101 is positioned in front of user 7002, such that user 7002's left hand 7020 and right hand 7022 are free to interact with computer system 101 and/or remote input device 7010. Computer system 101 includes or is in communication with a display generation component 7100.

In some embodiments, remote input device 7010 includes an input surface, and some movement inputs used to interact with the three-dimensional environment are detected based on movements relative to the input surface. In some embodiments, the input surface includes a touch-sensitive surface and is used to detect location, movements, and/or intensities of contacts with and/or relative to the touch-sensitive surface. In some embodiments, the input surface is not touch-sensitive (e.g., is a plain surface, or a surface with visual and/or nonvisual markers to guide the movement inputs and/or calibrate the movement inputs) or is used independent of the touch-sensors of the touch-sensitive surface. In some embodiments, movement inputs relative to the input surface are detected via one or more sensors that track the location and/or movement of the inputs (e.g., optical sensors tracking the user's hands and/or fingers relative to the non-sensitive surface, such as by tracking movement of the user's hands or a handheld controller relative to a surface of a desk, table, or another portion of the user's body such as their leg or arm).

In some embodiments, remote input device 7010 includes one or more hardware affordances, such as buttons, switches, and/or sliders, that actuates in response to a user touching, pressing, and/or otherwise manipulating the hardware affordances and provides inputs to the operating system of the remote input device 7010 and/or provides inputs to the computer system 101 that is in communication with the remote input device 7010. In some embodiments, the remote input device 7010 includes one or more solid state affordances and provide simulated physical inputs in response to a user touching, pressing, and/or otherwise manipulating a touch-sensitive surface of a respective solid state affordance to the operating system of the remote input device 7010 and/or to the computer system 101 that is in communication with the remote input device 7010. In some embodiments, the remote input device 7010 includes one or more internal sensors (e.g., location sensors, motion sensors, and/or proximity sensors) that collect and/or track the positions, orientations, and/or movement of the remote input device 7010 and provide the data as inputs to the remote input device 7010 and/or to the computer system 101. In some embodiments, the computer system obtains inputs from other sensors (e.g., cameras, proximity sensors, and other sensors) external to the remote input device 7010, based on the position, orientation, and/or movement of the remote input device 7010. More details of the remote input device 7010 is provided below with respect to FIGS. 7B-7R, in accordance with various embodiments.

In some embodiments, one or more portions of the view of physical environment 7000 that is visible to user 7002 via display generation component 7100 are digital passthrough portions that include representations of corresponding portions of physical environment 7000 captured via one or more image sensors of computer system 101. In some embodiments, one or more portions of the view of physical environment 7000 that is visible to user 7002 via display generation component 7100 are optical passthrough portions, in that user 7002 can see one or more portions of physical environment 7000 through one or more transparent or semi-transparent portions of display generation component 7100.

FIG. 7A illustrates physical environment 7000 that includes user 7002 interacting with remote input device 7010 and computer system 101, including display generation component 7100. The user 7002 has two hands, hand 7020 and hand 7022. The physical environment 7000 includes physical objects and/or physical surfaces (e.g., physical object 7014, and physical walls 7004 and 7006). The physical environment 7000 further includes physical floor 7008. In some embodiments, the physical surfaces in the physical environment, such as the walls, the floor, and/or the table top, are used as reference planes for determining the directions in the physical environment (e.g., horizontal direction, vertical direction, and/or other canonical directions) in accordance with one or more coordinate systems. In some embodiments, one or more coordinate systems and/or directions therein are defined based on the surfaces (e.g., display surface, top surface, front surface, and/or other canonical surfaces) of the remote input device 7010 and/or of the display generation component 7100. In some embodiments, the display generation component of computer system 101 is a head-mounted display worn on user 7002's head (e.g., what is shown in FIGS. 7A-7R as being visible via the display generation component of computer system 101 corresponds to the user 7002's field of view when wearing a head-mounted display). In some embodiments, the display generation component is a standalone display, a projector, or another type of display. In some embodiments, the computer system 101 is in communication with the remote input device 7010. In some embodiments, the computer system 101 and/or the remote input device 7010 include cameras or other sensors and input devices that detect movement of the user's hand(s), movement of the user's body as whole, and/or movement of the user's head in the physical environment. In some embodiments, the computer system 101 and/or the remote input device 7010 detect the movement and the current postures, orientations, and positions of the user's hand(s), face, and/or body as a whole. In some embodiments, user inputs are detected via a touch-sensitive surface or touchscreen of the computer system 101 and/or the remote input device 7010. In some embodiments, the one or more input devices include an eye tracking component that detects location and movement of the user's gaze. In some embodiments, the display generation component, and optionally, the one or more input devices and the computer system, are parts of a head-mounted device that moves and rotates with the user's head in the physical environment, and changes the viewpoint of the user in the three-dimensional environment provided via the display generation component. In some embodiments, the display generation component is a heads-up display that does not move or rotate with the user's head or the user's body as a whole, but, optionally, changes the viewpoint of the user in the three-dimensional environment in accordance with the movement of the user's head or body relative to the display generation component. In some embodiments, the display generation component is optionally moved and rotated by the user's hand relative to the physical environment or relative to the user's head, and changes the viewpoint of the user in the three-dimensional environment in accordance with the movement of the display generation component relative to the user's head or face or relative to the physical environment.

FIG. 7B illustrates a view of three-dimensional environment 7000′ that is visible to user 7002 via display generation component 7100 (e.g., a virtual three-dimensional environment, an augmented reality environment, a pass-through view of a physical environment, and/or a camera view of physical environment 7000). The view of the three-dimensional environment 7000′ includes representation 7004′ of the physical wall 7004, representation 7006′ of the physical wall 7006, representation 7008′ of the physical floor 7008, and representation 7014′ of the physical object 7014. The spatial relationship between the respective representations of physical objects and/or surfaces in the three-dimensional environment 7000′ correspond to the spatial relationship between the physical objects and/or surfaces in the physical environment, in accordance with some embodiments. The spatial relationship between the viewpoint corresponding to the currently displayed view of the three-dimensional environment 7000′ and the respective representation of a physical object and/or surface in the three-dimensional environment 7000′ correspond to the spatial relationship between the viewpoint of the user and the physical object and/or surface in the physical environment, in accordance with some embodiments.

The computer system 101 is in communication with remote input device 7010, in accordance with some embodiments. In some embodiments, remote input device 7010 includes a touch sensitive surface (e.g., a touch-sensitive display, or another a touch-sensitive surface). In these embodiments, as well as others described below, a user is enabled to select, interact, and manipulate objects visible via display generation component 7100 of computer system 101 by making a gesture on the touch sensitive surface of remote input device 7010, for example, with one or more fingers, styluses, and/or other input objects (e.g., optionally, without the need to select graphics or icons displayed on the remote input device 7010 (e.g., displayed on the touch-screen display, or displayed on a display that display objects at positions corresponding to positions on the touch-sensitive surface). In some embodiments, the gesture optionally includes one or more taps, one or more swipes (from left to right, right to left, upward and/or downward) and/or a rolling of a finger (from right to left, left to right, upward and/or downward) that has made contact with remote input device 7010. The touch screen of remote input device 7010 optionally displays one or more user interface objects (e.g., graphics, icons, windows, and/or controls) within a user interface. In these embodiments, as well as others described below, a user is enabled to select and/or interact with the one or more of the user interface objects by making a gesture on the user interface object, for example, with one or more fingers or one or more styluses (or other input object). In some embodiments, selection of one or more user interface objects occurs when the user breaks contact with the one or more user interface objects. In some embodiments, contact with a user interface object that is visible via display generation component 7100 or visible on the display of the remote input device 7010 does not select the user interface object, while the remote input device 7010 is used to control and interact with objects in the three-dimensional environment using the processes described herein.

In some embodiments, remote input device 7010 includes one or more physical buttons, such as a power button, volume buttons, and/or a “home” or a menu button. In some embodiments, computer system 101 includes one or more physical buttons, such as a power button, volume buttons, and/or a “home” or a menu button. A menu button is, optionally, used to navigate to any application in a set of applications that are, optionally executed by an operating system of a computer system or device. In some embodiments, a menu button is implemented as a soft key in a user interface displayed on a display, or as a system gesture such as an upward edge swipe or another type of gesture. In some embodiments, remote input device 7010 includes a touch-screen display, an optional menu button, a push button 2006 for powering the device on/off and locking the device, volume adjustment button(s) 2008, a Subscriber Identity Module (SIM) card slot, a head set jack, and/or a docking/charging external port. In some embodiments, remote input device 7010 also accepts verbal input for activation or deactivation of some functions through a microphone. In some embodiments, remote input device 7010 includes one or more contact intensity sensors for detecting intensities of contacts on the touch-sensitive display and/or one or more tactile output generators for generating tactile outputs for a user of remote input device 7010.

In FIG. 7B, the view of the three-dimensional environment 7000′ includes virtual content that are spatially positioned relative to the representation of the physical environment (e.g., relative to the representations 7004′, 7006′, 7008′ and 7014′ of walls 7004 and 7006, floor 7008, and physical object 7014 in the physical environment 7000). In some embodiments, as shown in FIG. 7B, the virtual content includes a user interface “W1” 7026 and a user interface “W2” 7030. In some embodiments, user interface “W1” 7026 is an application window corresponding to an application installed on computer system 101, and user interface “W2” 7030 is an application window corresponding to the same or different application installed on computer system 101. The user interface “W1” 7026 includes a close affordance 7034 (e.g., for ceasing to display the user interface “W1” 7026), a search bar 7036 (discussed in greater detail below, with reference to FIGS. 7C-7E), and a grabber affordance 7028 (e.g., an affordance for moving and/or resizing the user interface “W1” 7026). The user interface “W2” 7030 includes a close affordance 7038 (e.g., for ceasing to display the user interface “W2” 7030) and a grabber affordance 7032 (e.g., an affordance for moving and/or resizing the user interface “W2” 7030). In some embodiments, as shown in FIG. 7B, the affordances (e.g., close affordance 7034, grabber affordance 7028, and/or other window control affordances) for controlling the user interface W1 are displayed within a boundary enclosing a content region of user interface W1. In some embodiments, at least some of the affordances for controlling the user interface W1 (e.g., close affordance 7034, grabber affordance 7028, and/or other window control affordances) are displayed outside of the boundary enclosing the content region of user interface W1, optionally with a gap between a respective affordance and the boundary of the content region of the user interface W1, and optionally with a portion of the representation of the physical environment visible through the gap.

In FIG. 7B, the computer system 101 displays a visual indication (referred to herein as the user's attention 7024) at a location on the display generation component 7100 that corresponds to a location of the attention of user 7002. In some embodiments, the user's attention 7024 is displayed at a location that corresponds to a location of a gaze of the user 7002 (e.g., the user's attention 7002 indicates the location on the display of the computer system 101 that corresponds to the location where the user is looking or gazing). In some embodiments, the user's attention 7024 is displayed at a location that corresponds to a location of an input via an external device (e.g., a handheld controller, computer system 101, and/or remote input device 7010). In some embodiments, computer system 101 (and/or the remote input device 7010) tracks the user's attention, but the user's attention 7024 is not displayed (e.g. is not visually indicated via the display generation component 7100), or is only displayed in some contexts (e.g., the computer system 101 tracks the user's gaze, but does not display the user's attention 7024 while the user's gaze is outside a threshold distance (e.g., 0.5 mm, 1 mm, 2 mm, 5 mm, or 10 mm) from a user interface object that the user 7002 can interact with, while the user's gaze is moving, and/or while the user's gaze has not remained substantially stationary for more than a threshold amount of time (e.g., 0.1, 0.2, 0.3, 0.5, 1, 2, or 3 seconds).

In some embodiments, a user can select, manipulate, and/or interact with objects (including a respective object as a whole, and/or subsets of internal content of the a respective object), such as user interface “W1” 7026 and user interface “W2” 7030, in an extended reality three-dimensional environment using a combination of gaze input (e.g., detected via on or more cameras of computer system 101, or other sensors in communication with the computer system 101) and touch input detected via a remote input device, such as remote input device 7010, as described in more detail below with reference to FIGS. 7B-7L.

FIGS. 7B-7C illustrate closing user interface “W2” 7030 using a combination of gaze input and touch input, where the touch input is detected via a remote input device 7010, according to some embodiments.

FIG. 7B illustrates that the user's attention 7024 (e.g., based on the location of the user's gaze, and/or a location of another type of attention input) is directed to the close affordance 7038. While the user's attention 7024 is directed to the close affordance 7038, the remote input device 7010 detects user input 7050 on a touch-sensitive surface (e.g., a touch screen, a touch pad, and/or other touch-sensitive surface) of the remote input device 7010. In some embodiments, the user input 7050 is a tap input. In some embodiments, the user input 7050 is a long press, deep press, a touch and hold, and/or other selection input detected via the touch-sensitive surface of remote input device 7010.

FIG. 7C shows a transition from FIG. 7B in response to user input 7050 detected on the touch-sensitive surface of remote input device 7010 while user's attention 7024 is directed to the close affordance 7038. In response to detecting the user input 7050, the computer system 101 closes and ceases to display the user interface “W2” 7030, while continuing to maintain display of user interface “W1” 7026. In some embodiments, in response to detecting the user input 7050, the computer system 101 transmits instructions to the display generation component 7100 that cause the display generation component 7100 to cease to display the user interface “W2” 7030. In some embodiments, the computer system 101 ceases to display user interface “W1” 7026 while continuing to maintain display of user interface “W2” 7030, in accordance with a determination that user's attention 7024 is directed to the close affordance 7034 instead of close affordance 7038 when user input 7050 is detected.

FIGS. 7C-7E illustrate that the remote input device 7010 automatically, without additional user input, displays virtual keyboard 7102 on a display of the remote input device 7010 (e.g., the touch-sensitive display, or a display corresponding to the touch-sensitive surface of the remote input device 7010) in response to selecting a text field, such as a search bar 7036 for entering search queries or other text entries in user interface “W1” 7026, in accordance with some embodiments.

FIG. 7C shows that the user's attention 7024 is directed to the search bar 7036 of the user interface “W1” 7026. While user's attention 7024 is directed to the search bar 7036, the remote input device 7010 detects a user input 7052 on the touch-sensitive surface of the remote input device 7010. In some embodiments, the user input 7052 is a selection input, analogous to user input 7050, that selects the object that is displayed at the location of the user's attention 7024. In some embodiments, the user input 7052 is a tap input. In some embodiments, the user input 7052 is a press input, a long press input, a touch and hold input, or another type of input that meet selection criteria.

FIG. 7D shows a transition from FIG. 7C in response to user input 7052 detected on the touch-sensitive surface of remote input device 7010 while user's attention 7024 is directed to the search bar 7036. In response to detecting the user input 7052 in FIG. 7C, the remote input device 7010 automatically displays virtual keyboard 7102 for typing text entries (e.g., a text keyboard for entering text into the search bar 7036, or another text field that currently has input focus). The remote input device 7010 displays virtual keyboard 7102 without the need for a user input requesting to specifically display a virtual keyboard, e.g., selection of a text field such as search box 7036 (e.g., to transfer input focus onto the text field) is a sufficient condition to cause the remote input device 7010 to display virtual keyboard 7102 on a display of the remote input device 7010. In addition to displaying virtual keyboard 7102 via the display of the remote input device 7010, the computer system 101 displays, via display generation component 7100, an insertion cursor (e.g., a caret or another indicator indicating a location at which text will be input) in the search bar 7026. In some embodiments (e.g., as shown in FIG. 7D), while displaying the insertion cursor in the search bar 7026, the computer system 101 does not display an indication of the user's attention (e.g., even if the user's gaze is directed to a portion of the display of the computer system 101 other than the search bar 7036, the computer system 101 continues to display the insertion cursor in the search bar 7036, and no additional indication or other indication of the user's attention is displayed via the display generation component 7100).

In some embodiments, the virtual keyboard 7102 displayed via the display of remote input device 7010 includes a number of affordances (e.g., character keys and/or controls) for entering letters, numbers, symbols, and/or punctuations. In some embodiments, the virtual keyboard 7102 includes one or more affordances for other inputs (e.g., other than text-based inputs), such as an affordance to switch to a different keyboard (e.g., keyboard for entering emojis and/or avatars, a keyboard for a foreign language and/or a different input method for the language), and/or an affordance for activating speech-based input. In some embodiments, the keyboard of the remote input device 7010 includes one or more other options for interacting with (e.g., modifying and/or editing) the search bar 7036 and/or text entered into the search bar 7036 (e.g., a backspace button).

FIG. 7E illustrates that by typing on virtual keyboard 7102, user 7002 can enter text in text fields displayed in the three-dimensional environment 7000′. Accordingly, in FIG. 7E, the user 7002 performs a user input 7054 (e.g., a tap input) on the respective affordance representing letter “H” in the virtual keyboard 7102. In response, the computer system 101 displays text 7056 (e.g., the letter “H”) in the search bar 7036 displayed in the three-dimensional environment 7000′. In some embodiments, the computer system 101 and/or the remote input device 7010 displays, via the display of the remote input device 7010, a copy of the characters that have been entered into search bar 7036 in user interface W1 “7026” as the user continues to enter text using the virtual keyboard 7102. In some embodiments, after search terms are entered in search bar 7036 and submitted (e.g., by pressing the “return” key in virtual keyboard 7102), the computer system 101 performs the search and present search results that correspond to the search terms in the three-dimensional environment 7000′ (e.g., in user interface “W1” 7026, or in a new user interface different from the user interface “W1” 7026).

In some embodiments, a user can select an object, such as user interface “W1” 7026, using a gaze input, and relocate selected object in an extended reality three-dimensional environment using a touch movement input detected via a touch-sensitive surface of a remote input device, such as remote input device 7010, as described in more detail below with reference to FIGS. 7F-7J.

FIGS. 7F-7J illustrate a scenario in which user interface “W1” 7026 is relocated or moved, from an initial location to a target location, in three-dimensional environment 7000′ in response movement inputs detected via the touch-sensitive surface of remote input device 7010 while user interface “W1” 7026 is selected. Accordingly, in FIG. 7F, the user 7002 selects grabber affordance 7028 of user interface “W1” 7026. For example, the computer system 101 detects, via the remote input device 7010, contact 7058 which provides a selection input (e.g., a tap input, a tap and hold, or other selection input) on the touch-sensitive surface of the remote input device 7010, while the user's attention 7024 is directed to the grabber affordance 7028. In some embodiments, a touch input is not required in addition to a gaze input to select an object in the three-dimensional environment, such as grabber affordance 7028. For example, a gaze and dwell input can be used to select an object, where the gaze is directed to a target object for at least a threshold amount of time to select the target object. In some embodiments, the computer system 101 displays visual feedback to user 7002 in response to detecting a selection input, as described in further detail with reference to FIG. 7G.

FIG. 7G illustrates that in response to detecting the contact 7058 while the user's attention 7024 is directed to the grabber affordance 7028, the computer system 101 changes a visual appearance of the grabber affordance 7028 (e.g., to indicate that grabber affordance 7028 has been successfully selected). In some embodiments, the change in visual appearance can take different forms such as changing color, translucency, size, and/or shape of the grabber affordance 7028, and/or displaying a selection object (e.g., a selection ring, or a selection box, and/or highlighting) around grabber affordance 7028. In some embodiments, the grabber affordance 7028 is an affordance for repositioning the user interface “W1” 7026 (e.g., user 7002 can grab and move a respective window by selecting and dragging a corresponding grabber affordance), and the computer system 101 displays the grabber affordance 7028 with a different appearance to indicate that the user interface “W1” 7026 can be (or is currently being) repositioned.

In some embodiments, the computer system 101 displays the grabber affordance 7028 with the different visual appearance (e.g., after changing the visual appearance of the grabber affordance 7028) and ceases to display the user's attention 7024 (e.g., because the user 7002 is now interacting with the user interface “W1” 7026, and said interaction can proceed even as the user's attention moves around in the three-dimensional environment (e.g., to search for a target location for the user interface “W1” 7026, or for other purposes)). In some embodiments, the computer system 101 displays the grabber affordance 7028 with a different visual appearance and maintains display of the user's attention 7024 (e.g., but inputs and other user interactions directed to other user interfaces and/or user interface objects while the grabber affordance 7028 is selected are optionally ignored by the computer system 101).

Further, FIG. 7G illustrates initiation of movement input that corresponds to movement of contact 7058 in a rightward direction (e.g., towards a right edge of the remote input device 7010) across the touch-sensitive surface of remote input device 7010, while the grabber object 7028 is selected.

FIG. 7H illustrates a transition from FIG. 7G in response to detecting movement of contact 7058 in the rightward direction across the touch-sensitive surface of remote input device 7010. For example, user 7002 is sliding a finger in a rightward direction across the touch-sensitive surface of remote input device 7010. In FIG. 7H, in contrast to FIG. 7G, the contact 7058 has moved across the touch-sensitive surface of the remote input device 7010, to a new position. An outline 7057 indicates the previous position of contact 7058 (e.g., the position of the contact 7058 in FIG. 7G). In response to detecting the movement of contact 7058 in the rightward direction across the touch-sensitive surface of remote input device 7010 while the grabber object 7028 of user interface “W1” 7026 is selected, the computer system 101 moves grabber object 7028 and user interface “W1” 7026 to a new position in three-dimensional environment 7000′. User interface “W1” 7026 is moved in accordance with direction and other characteristics of the movement input that corresponds to movement of contact 7058 (e.g., speed, velocity, distance, and/or other characteristics of the movement input). For example, the user interface “W1” 7026 in FIG. 7H is further to the right (e.g., closer to the right edge of the field of view of display generation component 7100), as compared to the position of the user interface “W1” 7026 in FIG. 7G, in response to the movement input detected on the touch-sensitive surface of the remote input device 7010 (e.g., the swipe gesture performed by contact 7058).

In some embodiments, the computer system 101 updates the position of the user interface “W1” 7026 in real time and/or continuously (e.g., as the user 7002 moves contact 7058 across the touch-sensitive surface of the computer system 101). In some embodiments, the computer system 101 updates the position of the user interface “W1” 7026 at preset time intervals (e.g., with a respective frame rate, or refresh rate) but the movement appears to user 7002 continuous and without obvious interruptions. In some embodiments, the computer system 101 updates the position of the user interface “W1” 7026 if the computer system 101 (and/or the remote input device 7010) detects more than a threshold amount of movement (e.g., 1 mm, 2 mm, 5 mm, or 10 mm of movement) of contact 7058 (e.g., to prevent accidental or unintentional movement of the user interface “W1” 7026). In some embodiments, contact 7058 remains in contact with the touch-sensitive surface of remote input device 7010 while the movement input in FIGS. 7G-7H is performed. In some embodiments, a liftoff or break in contact with the touch-sensitive surface of remote input device 7010 is detected before the movement input that corresponds to movement of contact 7058 is performed. For example, user 7002 can break contact with the touch-sensitive surface of remote input device 7010 before and during the movement input (e.g., performing a tap to select and an air swipe to move (e.g., in the same plane and/or in three-dimensional space)) and still cause the computer system 101 to move user interface “W1” 7026 in accordance with movement of contact 7058 (e.g., in the rightward direction, or another direction that corresponds to the direction of the movement input).

FIGS. 7I-7J illustrate yet another movement of contact 7058 across the touch-sensitive surface of remote input device 7010 in another direction, such as in a downward direction, that is different from to the rightward direction illustrated in FIGS. 7G-7H. Accordingly, FIG. 7I illustrates initiation of movement input that corresponds to movement of contact 7058 in a downward direction (e.g., downwards, and/or towards the bottom edge of the remote input device 7010) across the touch-sensitive surface of remote input device 7010. In FIG. 7J, in contrast to FIG. 7I, the contact 7058 has moved across the touch-sensitive surface of the remote input device 7010, to yet another updated position. An outline 7059 indicates the previous position of contact 7058 (e.g., the position of the contact 7058 in FIG. 7I). In response to detecting the movement of contact 7058 in the downward direction across the touch-sensitive surface of remote input device 7010, the computer system 101 moves user interface “W1” 7026 to yet another updated position in three-dimensional environment 7000′. User interface “W1” 7026 is moved in accordance with the direction and other characteristics of the movement input that corresponds to movement of contact 7058 (e.g., speed, velocity, distance, and/or other characteristics of the movement input). For example, the user interface “W1” 7026 in FIG. 7J is further down or lower (e.g., closer to the bottom edge of the field of view of the display generation component 7100), as compared to the position of the user interface “W1” 7026 in FIG. 7I. In some embodiments, a liftoff or break in contact with the touch-sensitive surface of remote input device 7010 is detected before the movement input that corresponds to movement of contact 7058 is performed. For example, user 7002 can break contact with the touch-sensitive surface of remote input device 7010 before and during the movement input (e.g., performing a tap to select and an air swipe to move (e.g., in the same plane and/or in three-dimensional space)) and still cause the computer system 101 to move user interface “W1” 7026 in accordance with movement of contact 7058 (e.g., in the downward direction, or another direction that corresponds to the direction of the movement input).

In some embodiments, a selected object, such as user interface “W2” 7030, is moved in three-dimensional environment 7000′ in response detecting movements of a remote input device (e.g., remote input device 7010, or another remote input device), such as tilting and/or translational motions of the remote input device itself, as described in further detail below with reference to FIGS. 7K-7N.

FIGS. 7K-7L illustrate moving selected user interface “W2” 7030 further away from a viewpoint of user 7002 (e.g., in the z-direction, and/or in the increasing direction of the simulated depth dimension) in response to detecting tilting motion of remote input device 7010, in accordance with some embodiments.

In FIG. 7K, the user 7002 selects user interface “W2” 7030 by grabber affordance 7032. For example, the computer system 101 detects user input 7060 (e.g., a tap, a touch and hold, or other selection input) on the touch-sensitive surface of the remote input device 7010 while the user's attention 7024 is directed to the grabber affordance 7032. In some embodiments, the user input 7060 is instead performed (and/or detected) via another input mechanism, such as a physical button of the remote input device 7010. In response, the computer system 101 changes a visual appearance of the grabber affordance 7032 (e.g., to indicate that grabber affordance 7032 and its corresponding user interface “W2” 7030 have been successfully selected). In some embodiments, while user interface “W2” 7030 is selected (e.g., via selection of the grabber affordance, via selection of a chrome of the user interface window, or via selection of another portion of the user interface “W2”), a rotation of the remote input device is detected (e.g., via one or more sensors of the remote input device and/or one or more sensors of the computer system 101) that causes the computer system 101 to move user interface “W2” 7030 away from the viewpoint of the user 7002, as described in further detail below with reference to FIGS. 7K-7L.

FIG. 7K includes a top view 7120 of user interface “W2” 7030 and a side view 7115 of the remote input device 7010. In the top view 7120, a view of the top edge of the user interface 7030 is visible, and a front surface of the user interface 7030 (e.g., the surface of the window that is facing toward the viewer) is shown facing downward in the top view 7120. The upward arrow in the top view 7120 indicates a movement away from the viewer that is facing toward the front surface of the user interface 7030. In the side view 7115, a view of a side edge (e.g., left edge) of the remote input device is visible, and the front surface of the remote input device is shown with a higher position than the back surface of the remote input device. The arrows with the counter-clockwise directions in the side view 7115 indicates a rotation of the top edge of the remote input device away from a user facing toward the front surface of the remote input device, around a transverse axis that pass through the remote input device (e.g., a horizontal axis, an axis that goes from left edge to the right edge of the remote input device, an axis that is parallel to the x-axis shown in the side view). In FIG. 7K, the tilting motion of the remote input device is shown to be in one direction, while it can be understood that a titling motion in the opposite direction (e.g., around the same axis, or around any of a number of axes that are parallel to one another) is also possible.

As an example, side view 7115 illustrates a Cartesian coordinate system based on three mutually perpendicular coordinate axes: the x-axis, the y-axis, and the z-axis. The Cartesian coordinate system is used to illustrates the movements or motions of the remote input device 7010 in the physical environment.

For example, rotational motion (e.g., pitching) of remote input device 7010 in the physical environment around an axis that passes through the middle and along the short axis of the remote input device 7010, such as short axis 7130 that passes from one side edge to the other (e.g., passing through from the left edge to the right or from the right edge to the left), corresponds to changing an angle formed by an axis that passes through the middle along the long axis of the simulated remote input device (e.g., from top edge to the bottom edge or from the bottom edge to the top edge, such as long axis 7132) and a plane formed by the x-axis and y-axis in the Cartesian coordinate system and changing an angle formed by long axis 7132 of simulated remote input device and z-axis in the Cartesian coordinate system. Furthermore, rotational motion (e.g., rolling) of remote input device 7010 in the physical environment around the long axis 7132 corresponds to changing an angle formed by the short axis 7130 and a plane formed by the x-axis and the z-axis in the Cartesian coordinate system, and changing an angle formed by short axis 7130 of the simulated remote input device and z-axis in the Cartesian coordinate system. Furthermore, rotational motion (e.g., yawing) of remote input device 7010 in the physical environment around an axis that passes through center 7134 (e.g., pivot point where long axis 7132 and short axis 7130 intersect) and that is perpendicular to short axis 7130 and long axis 7132 (e.g., a vertical axis), corresponds to changing an angle formed by the long axis 7132 of the simulated remote input device and the plane formed by the x-axis and the y-axis, and changing an angle formed by the short axis 7130 of the simulated remote input device and the plane formed by the x-axis and the y-axis.

It should be understood that the dashed lines in FIG. 7K that illustrate short axis 7130 and long axis 713, respectively, and the cross that illustrates center 7134, are not visible to user 7002 and are drawn for illustrative purposes. Rotations may occur around axes that are parallel or substantially parallel to these axes or pivot point shown in FIG. 7K, in actual movements of the remote input device, and the coordinate system may be translated and/or rotated according to the initial position and orientation of the remote input device and/or the initial position and/or orientation of the user's hand holding the remote input device. Further, in these figures, tilting or rotational motions of remote input device 7010 that are about to occur in the physical environment 7000 are illustrated with dashed arrows representing corresponding movements in the Cartesian coordinate system of the three-dimensional environment (e.g., as in FIG. 7K), and completed tilting or rotational motions of remote input device 7010 in the physical environment 7000 are illustrated with continuous (e.g., without dashes) arrows representing corresponding movement in the Cartesian coordinate system of the three-dimensional environment (e.g., as in FIG. 7L).

With reference to FIGS. 7K-7N, top view 7120 illustrates user interface 7030 as seen from above (e.g., bird's view from the top) (e.g., in contrast to seen from the from as in three-dimensional environment 7000′ visible via display generation component 7100).

In FIG. 7K, while user interface “W2” 7030 is selected, remote input device 7010 is to be rotated about or around short axis 7130 (e.g., pitching around short axis 7130), e.g., the rotation is caused by a pivoting motion of a wrist of user 7002, where the top edge of remote input device 7010 is moved toward the floor 7008 and a bottom edge of the remote input device is moved away from floor 7008, as illustrated in side view 7115 in FIG. 7K. For example, an angle formed by a plane that runs through the touch-sensitive surface of the remote input device and floor 7008 is changed. In some embodiments, user interface “W2” 7030 is being selected optionally by user 7002 maintaining contact of input 7060 with the touch-sensitive surface of remote input device 7010. For example, the user 7002 maintains the user input 7060 on the touch-sensitive surface of the remote input device 7010 (and, optionally, maintains the user input 7060 in order to cause the computer system to displace the user interface “W2” 7030). In some embodiments, an object, such as user interface “W2” 7030, can continue to be selected without the need to maintain and hold contact with the touch-sensitive surface of remote input device 7010. For example, after the user interface “W2” 7030 is selected, the user interface “W2” 7030 can be moved continuously as long as the remote input device 7010 detects that a plane that runs through the touch-sensitive surface of the remote input device and floor 7008 (e.g., plane formed by x-axis and z-axis in the Cartesian coordinate system) are not substantially parallel to each other.

FIG. 7L illustrates a transition from FIG. 7K showing that a position of user interface “W2” 7030 is changed in three-dimensional environment 7000′ in response to detecting the rotational motion of remote input device 7010 about the short axis 7130 (e.g., pinching around short axis 71300, described with reference to FIG. 7K). In response to detecting the rotational motion of remote input device 7010 about the short axis 7130, user interface “W2” 7030 moves further away from the viewpoint of user 7002. Dashed outline 7062 illustrates previous location of user interface “W2” 7030 in three-dimensional environment 7000′, e.g., the location corresponding to location of user interface “W2” 7030 in FIG. 7K. For example, top view 7120 illustrates that user interface “W2” 7030 is pushed back in the simulated depth dimension (e.g., z direction, and/or at a larger distance from the viewpoint of the user), and thus appear to be smaller and farther away in the view of the three-dimensional environment. Continuous arrows in the side view 7115 illustrate, in the Cartesian coordinate system, the already completed rotational motion, in the physical environment, of remote input device 7010 about short axis 7130. FIG. 7L also shows a perspective view of the remote input device 7010 (lower right of FIG. 7L) after the rotation from the frontal view shown in FIG. 7K.

In some embodiments, rotation motion of remote input device 7010 about the short axis 7130 (e.g., pitching about short axis 7130) in an opposite direction (e.g., rotational motion is caused by a backward pivoting motion of a wrist of user 7002, where the top edge of remote input device 7010 is moved away the floor 7008 and a bottom edge of the remote input device is toward floor 7008) causes computer system 101 to move user interface “W2” 7030 (or other selected object) toward the viewpoint of user 7002. In some embodiments, the coordinate system that characterizes the rotational motion of the remote input device is defined based on the location and orientation of the hand and wrist of the user, or other portions such as the shoulder or elbow of the user that is connected to the hand that holds and manipulates the remote input device, and as such, the rotational axes shown in FIGS. 7K-7L are merely illustrative for a general description of the type of rotation that is performed, and should not be used to limit the scope of the disclosed techniques, unless otherwise specified.

FIGS. 7M-7N illustrate moving selected user interface “W2” 7030 in a leftward direction (e.g., without changing the distance from the viewpoint of the user 7002) in the three-dimensional environment 7000′ in response to detecting tilting motion of remote input device 7010 (e.g., yawing around the vertical axis that passed through center 7134), as described in further detail below.

In FIG. 7M, while user interface “W2” 7030 is selected, remote input device 7010 is to be rotated in a counterclockwise direction in the physical environment around the axis that passes through center 7134 and that is perpendicular to short axis 7130 and long axis 7132 (e.g., yawing in a counterclockwise direction around the vertical axis that passed through center 7134). For example, the rotation is caused by a counterclockwise rotation of the wrist that is connected to a hand of user 7002 holding the remote input device 7010, where the angle formed by the plane that runs through the touch-sensitive surface of the remote input device 7010 and the plane of the floor 7008 remains substantially unchanged while the top left corner of remote input device 7010 moves in a counterclockwise direction and toward the viewpoint of user 7002, and the bottom right corner of remote input device 7010 moves in the counterclockwise direction and away from the viewpoint of user 7002. The dashed arrows in side view 7115 in FIG. 7M illustrate the described rotation of the remote input device 7010 that is about to be performed (e.g., as opposed to already being performed). Similarly, the dashed arrow in top view 7120 illustrate that the user interface “W2” 7030 is about to be moved in the leftward direction in three-dimensional environment in response to the rotational movement that is to be performed as illustrated in FIG. 7M. In some embodiments, in order to reposition the user interface “W2” 7030, the user 7002 performs an analogous user input to the user input 7060 of FIG. 7K on the touch-sensitive surface of the remote input device 7010 (e.g., a tap input while the user's attention 7024 is directed to the grabber affordance 7032). In some embodiments, user interface “W2” 7030 is selected via another input mechanism (e.g., press on a physical button of the remote input device 7010 or point to location that has input focus by changing orientation and posture of the remote input device 7010). In some embodiments, an object, such as user interface “W2” 7030, can continue to be selected without the need to maintain and hold contact with the touch-sensitive surface of remote input device 7010. For example, after the user interface “W2” 7030 is selected, the user interface “W2” 7030 can be moved continuously as long as the remote input device 7010 continuous to be tilted.

FIG. 7N (e.g., FIGS. 7N1-7N2) (e.g., where a user interface analogous to the user interface described in FIG. 7N2 is shown on HMD 7100a in FIG. 7N1) illustrates a transition from FIG. 7M showing that a position of user interface “W2” 7030 is changed in three-dimensional environment 7000′ in response to detecting the clockwise rotational motion of remote input device 7010 about the vertical axis that passes through center 7134 and that is perpendicular to short axis 7130 and long axis 7132 (e.g., yawing in a counterclockwise direction around the vertical axis that passed through center 7134, described with reference to FIG. 7M). In response to detecting said counterclockwise rotation, user interface “W2” 7030 moves in a leftward direction in three-dimensional environment 7000′ while maintaining distance from the viewpoint of user 7002. Dashed outline 7064 illustrates previous location of user interface “W2” 7030 in three-dimensional environment 7000′, e.g., the location corresponding to location of user interface “W2” 7030 in FIG. 7M. For example, continuous arrow in top view 7120 illustrates that user interface “W2” 7030 is moved in the leftward direction. Continuous arrows in the side view 7115 illustrate, in the Cartesian coordinate system, the already completed rotational motion, in the physical environment, of remote input device 7010 about the center 7134. Top view 7120 illustrates that user interface “W2” 7030 is moved in a leftward direction (e.g., while optionally maintaining distance from the viewpoint of the user 7002).

In some embodiments, rotation motion of remote input device 7010 in the opposite direction around the axis that passes through center 7134 and that is perpendicular to short axis 7130 and long axis 7132 (e.g., yawning around the vertical axis in a clockwise direction) causes computer system to move the user interface “W2” 7030 in the rightward direction in three-dimensional environment 7000′. For example, rotation motion of remote input device 7010 in the opposite direction is caused by a clockwise rotation of the wrist that is connected to a hand of user 7002 holding the remote input device 7010, where the angle formed by the plane that runs through the touch-sensitive surface of the remote input device 7010 and the plane of the floor 7008 remains unchanged while top left corner of remote input device 7010 moves in a clockwise direction and away from the viewpoint of user 7002, and the bottom right corner of remote input device 7010 moves in the clockwise direction and toward the viewpoint of the user 7002.

In some embodiments, a rotational movement of remote input device 7010 that is different from the rotation movement described with reference to FIGS. 7M-7N can cause movement of an object, such as user interface “W2” 7030, in a leftward-rightward direction in the three-dimensional environment 7000′. For example, a rotational movement about the long axis 7132 in which left edge of remote input device 7010 moves closer to floor 7008 (and optionally right edge moves further away from floor 7008 toward a ceiling or the sky) can cause movement of selected object in a leftward direction, and a rotational movement about the long axis 7132 in which right edge of remote input device 7010 moves closer to floor 7008 (and optionally left edge moves further away from floor 7008 toward a ceiling or the sky) can cause movement of selected object in a rightward direction. For example, rolling around the long axis 7132 can cause the computer system to move the user interface “W2” 7030 in a leftward-rightward direction.

In some embodiments, moving the remote input device up and down along the vertical axis that that passes through center 7134 and that is perpendicular to short axis 7130 and long axis 7132 (e.g., moving upwards away from floor 7008 or moving downward toward floor 7008) can cause the computer system to move a selected object, such as user interface “W2” 7030, in an upward-downward direction (e.g., vertically) in the three-dimensional environment 7000′.

In some embodiments, the movement of the remote input device 7010 that is described with respect to FIGS. 7K-7L is used moving the selected object (e.g., user interface 7030, or another selected object) in the three-dimensional environment in the up and down direction, instead of in the simulated depth dimension.

In some embodiments, the methods described above with reference to FIGS. 7K-7L and FIGS. 7M-7N are performed with different types of movement of the remote input device 7010 (e.g., instead of rotation of the remote input device 7010 about a respective axis, the method involves translational movement of the remote input device 7010 along a respective axis). In some embodiments, the methods described above with reference to FIGS. 7K-7L and FIGS. 7M-7N are performed with rotation of the remote input device 7010 about different axis than those described above. In some embodiments, the methods described above with reference to FIGS. 7K-7L and FIGS. 7M-7N are performed with a combination of different types of movement of the remote input device 7010 (e.g., simultaneous rotation about at least two axis, simultaneous translation along at least two axis, and/or a combination of rotational and translational movement), e.g., to accomplish movement of the selected object in any direction in the three-dimensional space.

FIGS. 70-7P illustrate an exemplary method of scrolling display of content on the display (e.g., the display generation component 7100, or another display) of the computer system 101 in an analogous manner as scrolling display of content on the display of the remote input device (e.g., the remote input device 7010, or another remote input device), in accordance with some embodiments. In FIG. 7O, the computer system 101 displays, via display generation component 7100, a user interface 7070 that includes scrollable content (e.g., four movies MOVIE 1, MOVIE 2, MOVIE 3, and MOVIE 4). The user interface 7070 includes more than the four displayed movies (e.g., additional content items are available for display, but are not currently visible in the user interface 7070).

The computer system 101 detects, via remote input device 7010, a user input 7068 on the touch-sensitive surface of the remote input device 7010 (e.g., while the user's attention 7024 is directed to the user interface 7070). As shown by the dashed arrow, in some embodiments, the user input 7068 includes movement of the contact in a first direction (e.g., a swipe in an upward direction, or another movement input) along the touch-sensitive surface of the remote input device 7010. The dashed arrow in the user interface 7070 indicates a direction of scrolling (e.g., that corresponds to the direction of movement of the user input 7068 along the touch-sensitive surface of the remote input device 7010).

FIG. 7P shows a transition from FIG. 7O in response to detecting a scrolling input on touch-sensitive surface of remote input device 7010. In FIG. 7P, in response to detecting movement of the user input 7068 from a first position (e.g., shown by an outline 7067, which corresponds to the location of the user input 7068 in FIG. 7O) to a second position (e.g., shown by the location of the user input 7068 in FIG. 7O), the computer system 101 scrolls display of the content in the user interface 7070 in a first direction (e.g., the content of the user interface 7070 is moved upwards on the display of the computer system 101). The computer system ceases to display MOVIE 1 (e.g., MOVIE 1 is “scrolled off” the user interface 7070), and the computer system displays MOVIE 5 (e.g., MOVIE 5, which was not displayed in FIG. 7O, is “scrolled onto” the user interface 7070).

In some embodiments, the user 7002 can redisplay MOVIE 1 by performing another user input that includes movement in a direction opposite or substantially opposite the dashed arrow in FIGS. 70 and 7P (e.g., downwards, or substantially downward). In response to detecting the user input that includes movement in the opposite or substantially opposite direction, the computer system 101 scrolls display of the content of the user interface 7070 in the opposite direction (e.g., the content of the user interface 7070 is moved downwards on the display of the computer system 101).

In some embodiments, the same type of scrolling input that would cause remote input device 7010 to scroll scrollable content displayed on the touch-sensitive display of remote input device 7010 is also used to scroll content in the three-dimensional environment 7000′. In some embodiments, to scroll content in the three-dimensional environment 7000′, such as content displayed in user interface 7070, it is not necessary that the content is also displayed on the display of remote input device 7010. In some embodiments, in order to scroll content in the three-dimensional environment 7000′, such as content displayed in user interface 7070, it is required that no scrollable graphics are displayed on the display of remote input device 7010. In some embodiments, a scroll input detected via the remote input device is used to scroll content in the three-dimensional environment 7000′, in accordance with a determination that the user's attention is directed to scrollable content in the three-dimensional environment, irrespective of whether scrollable content is displayed at a location of the scroll input on the display of the remote input device.

FIGS. 7Q-7R illustrate an exemplary method of repositioning a selected object, e.g., the user interface “W2” 7030 or another object in the three-dimensional environment. In some embodiments, the method described in FIGS. 7Q-7R is used in addition to, or in lieu of, the methods described above with reference to FIGS. 7F-71, and FIGS. 7M-7N. FIGS. 7Q and 7R are analogous to FIGS. 7M and 7N (e.g., FIGS. 7N1-7N2), however, instead of detecting an amount of rotation of the remote input device 7010 about the vertical axis (as described above with reference to FIGS. 7M-7N), in FIGS. 7Q and 7R, the user interface “W2” 7030 is repositioned in accordance with movement of the remote input device 7010. Specifically, as shown by a ray 7080, the user 7002 orients the remote input device 7010 such that the ray 7080 points to the location of the user interface 7030 and/or the grabber object 7032 shown on the display generation component 7100, and the computer system 101 moves the user interface “W2” 7030 in accordance with the movement of the ray 7080 (e.g., such that the grabber affordance 7032 is always displayed at a location where the ray 7080 intersects the plane of the user interface 7030).

In some embodiments, the computer system 101 displays a visual indication that corresponds to the ray 7080, e.g., at a location corresponding to where the ray 7080 intersects the plane of the user interface 7030. In some embodiments, the computer system 101 does not display a visual indication that corresponds to the ray 7080 (e.g., the user 7002 infers the orientation of the ray 7080 based on the movement of the user interface “W2” 7030).

In some embodiments, the user interface “W2” 7030 is repositioned as described above (e.g., with reference to the ray 7080, or another type of pointing object) while a user input is detected by the remote input device 7010 (e.g., a user input on a touch-sensitive surface of the remote input device 7010, and/or a user input via a hardware button of the remote input device 7010). In some embodiments, the computer system 101 ceases to reposition the user interface “W2” 7030 once the user input is no longer detected by the remote input device 7010 (e.g., and maintains display of the user interface “W2” 7030 at a position that corresponds to a time when the user input was last detected on the remote input device).

Additional descriptions regarding FIGS. 7A-7R are provided below in reference to method 800 described with respect to FIGS. 7A-7R.

FIG. 8 is a flow diagram of an exemplary method 8000 for controlling selection, placement, and manipulation of objects in an extended reality three-dimensional environment using a remote input device, in accordance with some embodiments. In some embodiments, method 8000 is performed at a computer system (e.g., computer system 101 in FIG. 1A) including a display generation component (e.g., display generation component 120 in FIGS. 1A, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head), and one or more input devices, including a remote input device (e.g., remote input device 7010). In some embodiments, the method 8000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 8000 are, optionally, combined and/or the order of some operations is, optionally, changed.

In some embodiments, the remote input device includes a touch-sensitive surface, such as a touch-sensitive surface in a touch-sensitive display, a touch-pad, or other touch-sensitive input devices. In some embodiments, the remote input device is a mobile phone, a tablet device, a gaming device, or another handheld device. In some embodiments, the one or more input devices include one or more optical sensors and/or eye-tracking devices, e.g., in addition to the remote input device, or as part of the remote input device. In some embodiments, the display generation component is a device that is separately housed from the remote input device. In some embodiments, the display generation component is a head-mounted display generation component (HMD) (e.g., HMD 7100a). In some embodiments, the display generation component is a heads-up display. In some embodiments, the remote input device has a display that is separate and distinct from the display generation component. In some embodiments, the remote input device has a frontal surface that includes the touch-sensitive surface and/or touch-screen display, and a top edge of the remote input device corresponds to the top edge of the touch-sensitive surface and/or touch-screen display, and in a default pose relative to which the motion input is measured, the remote input device is positioned with its frontal surface facing upward and its top edge farther away from the user than the bottom edge. In some embodiments, the remote input device has other shapes and configurations, and default pose relative to which the motion input is measured.

As described herein, method 8000 provides an improved input mechanism for controlling selection, placement, and manipulation of objects in a mixed reality three-dimensional environment. Placement and/or movement of an object in the mixed reality three-dimensional environment is controlled by movement inputs using a remote input device and optionally user's gaze. The user's gaze is used to determine which object has input focus, and the object that has input focus is moved in accordance with characteristics of movement inputs that move the remote device in the physical environment (e.g., including changing orientation, pose, and/or position of the remote device). Movement inputs also include touch inputs that are detected on a touch-sensitive surface of the remote input device or a combination of touch inputs and tilting motions of the remote device itself. The new input mechanism provides an additional input modality (e.g., use of remote device in addition to input through gaze and/or air gestures) for target selection and movement in the mixed-reality three-dimensional environment, thereby allowing a user to efficiently perform complex input gestures in the mixed reality three-dimensional. Controlling placement and/or movement of an object based on movement inputs performed using the remote device, reduces the amount of time, the number of inputs, and/or the complexity of inputs needed to move a selected object in the mixed-reality three-dimensional (e.g., by requiring less precision and without the need to select user interface controls).

In method 8000, while a view of an environment is visible via the display generation component (e.g., the environment being a two-dimensional or three-dimensional environment that includes one or more computer-generated portions and optionally one or more passthrough portions), the computer system detects (8002) a first motion input that includes movement of the remote input device in a physical environment (e.g., the motion input includes rotation of the remote input device from a first angle of rotation to a second angle of rotation relative to an axis or pivot point, e.g., tilting or panning the remote input device, and/or includes translation of the remote input device from a first position to a second position in the environment). In some embodiments, the first motion input is registered when the remote input device is moved relative to the physical environment, while the remote input device is held in a user's hand, or worn on a user's hand, wrist, or finger. In some embodiments, the motion input is registered when the remote input device is oriented with its touch-sensitive surface and/or display having a first spatial relationship relative to the user's face, hand, wrist, or finger (e.g., substantially parallel to the palm of the user's hand, facing substantially upward, and/or having other spatial relationships relative to the user or a portion of the user). In some embodiments, the first spatial relationship is satisfied by any of a range of positions and poses of the remote input device during the movement of the remote input device and the movement of the user's hand.

In response to detecting the first motion input (8004) and in accordance with a determination that a gaze detected by the computer system was directed to (e.g., remains substantially stationary (e.g., having less than a threshold amount of movement in a unit of time, for at least a threshold amount of time) within a region of) a first object (e.g., a user interface object, a control, a window, a virtual object, and/or other moveable items in a three-dimensional environment, such as a mixed reality environment or a virtual reality environment) when the first motion input was detected (e.g., optionally, while the first object is selected (e.g., by the gaze, optionally in conjunction with another gesture, or by another type of selection input)), the computer system moves (8006) the first object in the environment in accordance with the first motion input. For example, in FIGS. 7F-7J, user interface “W1” 7026 is selected via a gaze input, and is relocated in three-dimensional environment 7000′ in response detecting, while user interface “W1” 7026 is being selected, movement inputs detected via the touch-sensitive surface of remote input device 7010. In some embodiments, moving the first object includes dragging, pivoting, rotating, and/or otherwise changing the position and pose of the first object in the environment, in accordance with the characteristics of the first motion input (e.g., direction, speed, amount, acceleration, and other movement characteristics). In some embodiments, the computer system further determines that a respective control application on the remote input devices is launched and/or a respective remote control mode is activated in the three-dimensional environment and/or the remote input device, in order to move objects in the three-dimensional environment based on the motion input of the remote input device (e.g., a smartphone, or another control device that is separate and distinct from the display generation component and/or the computer system).

In response to detecting the first motion input (8004) and in accordance with a determination that the gaze detected by the computer system was not directed to the first object when the first motion input was detected (e.g., optionally, while the first object is not selected), the computer system forgoes (8008) moving the first object in the environment in accordance with the first motion input (e.g., keeping the first object stationary, or allowing the first object to move in the environment without being influenced by the first motion input). For example, if user interface “W1” 7026 in FIG. 7F-7J is not selected when the movement inputs detected via the touch-sensitive surface of remote input device 7010 are detected, the computer system does not move user interface “W1” 7026, and optionally moves a different object that was selected when the movement inputs were detected.

In some embodiments, in response to detecting the first motion input and in accordance with a determination that the gaze detected by the computer system was directed to a second object, different from the first object, when the first motion input was detected (e.g., optionally, while the second object is selected (e.g., by the gaze, optionally in conjunction with another gesture, or by another type of selection input)), the computer system moves the second object in the environment in accordance with the first motion input without moving the first object in accordance with the first motion input. In some embodiments, moving the second object includes dragging, pivoting, rotating, and/or otherwise changing the position and pose of the second object in the environment, in accordance with the characteristics of the first motion input (e.g., direction, speed, amount, acceleration, and other movement characteristics), while keeping the first object stationary, or allowing the first object to move in the environment without being influenced by the first motion input. For example, in FIG. 7B, either user interface “W1” 7026 or user interface “W2” 7030 can be move in response to detecting movement touch inputs via touch-sensitive surface of remote input device 7010, depending on where user 7002's attention is directed when the movement touch inputs are detected or when a selection input is performed that precedes the movement touch inputs. Using direction of user's gaze to determine the target of motion inputs performed with the remote input device makes user-device interaction in the mixed-reality three-dimensional environment more efficient by reducing the amount of time and number of inputs needed to select and move a target object.

In some embodiments, in response to detecting the first motion input and in accordance with a determination that the gaze detected by the computer system was directed to the first object when the first motion input was detected, the computer system moves the first object in the environment in accordance with the first motion input without moving the second object in accordance with the first motion input (e.g., dragging, pivoting, rotating, and/or otherwise changing the position and pose of the first object in the environment, in accordance with the characteristics of the first motion input (e.g., direction, speed, amount, acceleration, and other movement characteristics), while keeping the second object stationary, or allowing the second object to move without being influenced by the first motion input). For example, depending which user interface of user interfaces “W1” 7026 or “W2” 7030 has input focus based on user 7002's gaze when the movement touch inputs via touch-sensitive surface of remote input device 7010, the computer system moves the user interface with the input focus and does not move the user interface or other objects that lack input focus (FIG. 7B). Using direction of user's gaze to determine the target of motion inputs performed with the remote input device makes user-device interaction in the mixed-reality three-dimensional environment more efficient by reducing the amount of time and number of inputs needed to select and move a target object.

In some embodiments, detecting the first motion input includes detecting tilting motion of the remote input device (e.g., rotational movement of the remote input device as a whole around an axis or a pivot point). Moving the first object in the environment in accordance with the first motion input includes: in accordance with a determination that the tilting motion is in a first rotational direction (e.g., rotation around a respective axis or a respective pivot point in a respective coordinate system of the physical environment, in a positive direction or in a negative direction relative to a reference angle), moving the first object in a first translational direction in the environment (e.g., translating the first object in an increasing or decreasing x direction, y direction, or in a positive or negative direction relative to a reference position) that corresponds to the first rotational direction. For example, the first translational direction is a direction in a respective coordinate system of the computer-generated environment that corresponds to the first rotational direction in the respective coordinate system of the physical environment. For example, FIGS. 7M-7N (e.g., FIGS. 7N1-7N2) illustrate moving selected user interface “W2” in a leftward direction (e.g., optionally without changing the distance from the viewpoint of the user 7002) in the three-dimensional environment 7000′ in response to detecting tilting motion of remote input device 7010 (e.g., rotation motion of remote input device 7010 in a counterclockwise direction around the axis that passes through center 7134 and that is perpendicular to short axis 7130 and long axis 7132). Moving the first object in the environment in accordance with the first motion input includes: in accordance with a determination that the tilting motion is in a second rotational direction (e.g., rotation around another respective axis or another respective pivot point in the same or another respective coordinate system of the physical environment, in a positive direction or in a negative direction relative to a reference angle), different from the first rotational direction (e.g., different in direction, axis, pivot point, amount, and/or coordinate system), moving the first object in a second translational direction in the environment (e.g., translating the first object in an increasing or decreasing x direction, y direction, or in a positive or negative direction relative to a reference position) that corresponds to the second rotational direction, the second translational direction being different from the first translational direction. For example, the second translational direction is a direction in said same or other coordinate system of the computer-generated environment that corresponds to the second rotational direction in said same or other coordinate system of the physical environment. For example, rotation motion of remote input device 7010 in the opposite (e.g., clockwise) direction around the axis that passes through center 7134 and that is perpendicular to short axis 7130 and long axis 7132 moves the user interface “W2” 7030 in the rightward direction. In some embodiments, the second translational direction is different from the first translational direction in direction, amount, and/or coordinate system. In some embodiments, the second rotational direction is substantially orthogonal to the first rotational direction, in the same coordinate system of the physical environment. In some embodiments, the second rotational direction is substantially orthogonal to the first rotational direction, but they are relative to different coordinate systems of the physical environment. In some embodiments, the second rotational direction is not substantially orthogonal to the first rotational direction, and they are relative to different coordinate systems of the physical environment. In some embodiments, detecting the first motion input includes detecting tilting motion of the remote input device in a sequence of movements that include respective tilting motions in different rotational directions (e.g., different in direction, axis, pivot point, amount, and/or coordinate system), and as a result, the computer system causes a sequence of movements (e.g., translational movements that differ in terms of direction, amount, and/or coordinate system) of the first object in the environment that are respectively based on the respective tilting motions in the different rotational directions. In some embodiments, tilting motion of the remote input device around a respective axis includes moving the remote input device to an updated tilt angle in a positive direction or in a negative direction relative to the reference angle. In some embodiments, holding the remote input device at the updated angle optionally causes the computer system to continuously move the first object in the first or second rotational direction, respectively (e.g., continuously move the first object until the updated tilt angle is reversed back to the reference angle by moving the remote input device). In some embodiments, the first object is moved with constant speed or with varying speed, e.g., based on duration of the hold. Moving a selected object in a leftward-rightward or upward-downward direction the mixed-reality three-dimensional environment by tilting the remote input device (e.g., rotating the remote device along an axis or a pivot point in the physical environment) reduces the amount of time, the number of inputs, and/or the complexity of inputs needed to move a selected object the mixed-reality three-dimensional (e.g., by requiring less precision and without the need to select user interface controls).

In some embodiments, the first rotational direction includes rotation around a respective axis in a first coordinate system (e.g., rolling clockwise or counterclockwise, optionally partially, around a longitudinal axis of the remote input device; and/or pivoting leftward or rightward around a vertical axis that passes through the wrist or the elbow joint), and the first translational direction includes a horizontal direction (e.g., laterally, or in a rightward or leftward direction, respectively) in a second coordinate system different from the first coordinate system. For example, FIGS. 7M-7N (e.g., FIGS. 7N1-7N2) illustrate moving selected user interface “W2” in a leftward direction (e.g., optionally without changing the distance from the viewpoint of the user 7002) in the three-dimensional environment 7000′ in response to detecting tilting motion of remote input device 7010, such as rotation motion of remote input device 7010 in a counterclockwise direction around the axis that passes through center 7134 and that is perpendicular to short axis 7130 and long axis 7132), and rotation motion of remote input device 7010 in the opposite (e.g., clockwise) direction around the axis that passes through center 7134 and that is perpendicular to short axis 7130 and long axis 7132 moves the user interface “W2” 7030 in the rightward direction. In some embodiments, horizontal movement of the first object in the environment can be executed in response to one or more types of rotational movements of the remote input device, such as (1) a clockwise and counterclockwise rotation of the remote input device around its longitudinal axis, (2) a rotation of the remote input device caused by a clockwise and counterclockwise rotation of the wrist that is connected to a hand holding the remote input device, (3) a left and right pivoting motion of the remote input device cause by a hand holding the remote input device and pivoting left and right around the wrist joint, and/or (4) a left and right sweeping motion of the remote input device cause by a hand holding the remote input device and sweeping left and right around the elbow joint. In some embodiments, the remote input device is held by the hand with the top edge pointing upward, with the top edge pointing forward, with the frontal surface facing upward, with the frontal surface facing toward the user, and/or with other spatial relationships between the hand, the user, the direction of gravity, and the remote input device. In some embodiments, the respective axis in the first coordinate system is an axis that is substantially perpendicular to the direction of gravity and that points in a forward direction relative to the user. In some embodiments, the respective axis in the first coordinate system is an axis that is a longitudinal axis in the plane of or parallel to a touch-sensitive surface (e.g., the touch screen, or a touch pad) of the remote input device. In some embodiments, the respective axis in the first coordinate system is an axis that passes through a forearm and a wrist connected to a hand that holds and moves the remote input device in the physical environment. In some embodiments, the respective axis in the first coordinate system is an axis that is substantially parallel to the direction of gravity and that points in an up-and-down direction relative to the user. In some embodiments, the respective axis in the first coordinate system is an axis that is substantially perpendicular to the plane of a touch-sensitive surface (e.g., the touch screen, or a touch pad) of the remote input device. In some embodiments, the respective axis in the first coordinate system is an axis that passes through a palm, a wrist joint, or an elbow joint associated with a hand that holds and moves the remote input device in the physical environment. In some embodiments, the horizontal direction in the second coordinate system is a direction that is substantially perpendicular to the direction of gravity. In some embodiments, the horizontal direction in the second coordinate system is a horizontal direction relative to a user interface in which the first object is displayed. In some embodiments, the horizontal direction in the second coordinate system is a horizontal direction relative to a viewport provided by the display generation component through which the environment is visible. In some embodiments, the first coordinate system is a coordinate system with an origin located at or proximate to a user's wrist, elbow, shoulder, or finger around which the remote input device can be tilted or moved. In some embodiments, the first coordinate system is a coordinate system with an origin located at or proximate to a characteristic point (e.g., center, corner, or center of an edge) of the remote input device. In some embodiments, the second coordinate system is a coordinate system with an origin located at or proximate to a position at which the first object was initially displayed at a time when the first motion input was detected, or a position in the center of the viewport provided by the display generation component. In some embodiments, the second coordinate system is a coordinate system of the environment as a whole. In an example, in some embodiments, rotating the remote input device clockwise around a longitudinal axis of the remote input device causes the computer system to move the first object rightward in the environment (e.g., relative to the viewport through which the environment is visible, and/or relative to the viewpoint of the user), and rotating the remote input device counterclockwise around the longitudinal axis of the remote input device causes the computer system to move the first object leftward in the environment (e.g., relative to the viewport through which the environment is visible, and/or relative to the viewpoint of the user). In some embodiments, the amount and/or speed of the movement executed by the first object in the environment is based on the amount and/or speed of the rotation of the remote input device around the respective axis of the first coordinate system. In another example, in some embodiments, pivoting the remote input device leftward or rightward around a user's wrist or elbow joint causes the computer system to move the first object leftward or rightward in the environment (e.g., relative to the viewport through which the environment is visible, and/or relative to the viewpoint of the user). In some embodiments, rolling the remote input device clockwise around its longitudinal axis, pivoting the remote input device leftward around the user's wrist joint (e.g., while facing the touch-sensitive surface of the remote input device upward, or downward), and/or pivoting the remote input device leftward around the user's elbow joint (e.g., while facing the touch-sensitive surface of the remote input device upward, or downward) cause the computer system to move the first object leftward in the environment (e.g., relative to the viewport through which the environment is visible, and/or relative to the viewpoint of the user). Similarly, in some embodiments, rolling the remote input device counterclockwise around its longitudinal axis, pivoting the remote input device rightward around the user's wrist joint (e.g., while facing the touch-sensitive surface of the remote input device upward, or downward), and/or pivoting the remote input device rightward around the user's elbow joint (e.g., while facing the touch-sensitive surface of the remote input device upward, or downward) cause the computer system to move the first object rightward in the environment (e.g., relative to the viewport through which the environment is visible, and/or relative to the viewpoint of the user). In some embodiments, tilting motion of the remote input device around a respective axis includes moving the remote input device to an updated tilt angle in a positive direction or in a negative direction relative to the reference angle. In some embodiments, holding the remote input device at the updated angle optionally causes the computer system to continuously move the first object in the first or second rotational direction, respectively (e.g., continuously move the first object until the updated tilt angle is reversed back to the reference angle by moving the remote input device). In some embodiments, the first object is moved with constant speed or with varying speed, e.g., based on duration of the hold. Moving first object in rightward-leftward direction the mixed-reality three-dimensional environment by rotating the remote input device (e.g., in the physical environment) clockwise-counterclockwise around a longitudinal axis of the remote input device reduces the amount of time, the number of inputs, and/or the complexity of inputs needed to move a selected object the mixed-reality three-dimensional (e.g., by requiring less precision and without the need to select user interface controls).

In some embodiments, the second rotational direction includes rotation around a respective axis in a third coordinate system (e.g., same as the first coordinate system, or different in one or more aspects from the first coordinate system) (e.g., tilting up and down, optionally partially, around a latitudinal axis of the remote input device; and/or pitching, optionally partially, around latitudinal axis that passes the wrist or elbow), and the second translational direction includes a vertical direction (e.g., longitudinally, or in an upward or downward direction, respectively) in a fourth coordinate system (e.g., same as the second coordinate system, or different in one or more aspects from the second coordinate system, such as different in type (e.g., spherical or Cartesian), origin or center point, and/or different in another aspect) different from the third coordinate system. For example, in FIGS. 7M-7N (e.g., FIGS. 7N1-7N2), moving the remote input device up and down along the vertical axis that that passes through center 7134 and that is perpendicular to short axis 7130 and long axis 7132 (e.g., moving upwards away from floor 7008 or moving downward toward floor 7008) can cause the computer system the move a selected object, such as user interface “W2” 7030, in an upward-downward direction (e.g., vertically) in the three-dimensional environment 7000′. In another example, in FIGS. 7M-7N (e.g., FIGS. 7N1-7N2), pitching motion around short axis 7130 of remote input device can optionally cause a selected object, such as user interface “W2” 7030 to move in an upward-downward direction (e.g., vertically) in the three-dimensional environment 7000′. In some embodiments, vertical movement of the first object in the environment can be executed in response to one or more types of rotational movements of the remote input device, such as (1) a forward and backward rotation of the remote input device around its latitudinal axis, (2) a rotation of the remote input device (e.g., with its top edge moving toward and away from the user's face, while the bottom edge remains substantially stationary or moving in the opposite direction as the top edge) caused by a forward and backward pivoting motion of the wrist (e.g., with the inner wrist facing sideways, upward, or downward) that is connected to a hand holding the remote input device, and/or (3) a upward and downward sweeping motion of the remote input device cause by a hand holding the remote input device and sweeping upward and downward around the elbow joint. In some embodiments, the remote input device is held by the hand with the top edge pointing upward, with the top edge pointing forward, with the frontal surface facing upward, with the frontal surface facing toward the user, and/or with other spatial relationships between the hand, the user, the direction of gravity, and the remote input device. In some embodiments, the respective axis in the third coordinate system is an axis that is substantially perpendicular to the direction of gravity and that points in a left-right direction relative to the user. In some embodiments, the respective axis in the third coordinate system is an axis that is a latitudinal axis in the plane of or parallel to a touch-sensitive surface (e.g., the touch screen, or a touch pad) of the remote input device. In some embodiments, the respective axis in the third coordinate system is an axis that passes transversely (e.g., from left to right when the palm is facing toward the user) through a wrist joint, an elbow joint that is connected to a hand that holds and moves the remote input device in the physical environment. In some embodiments, the vertical direction in the fourth coordinate system is a direction of gravity. In some embodiments, the vertical direction in the fourth coordinate system is a vertical direction relative to a user interface in which the first object is displayed. In some embodiments, the vertical direction in the fourth coordinate system is a vertical direction relative to a viewport provided by the display generation component through which the environment is visible. In some embodiments, the third coordinate system is a coordinate system with an origin located at or proximate to a user's wrist, elbow, shoulder, or finger around which the remote input device can be tilted or moved. In some embodiments, the third coordinate system is a coordinate system with an origin located at or proximate to a characteristic point (e.g., center, corner, or center of an edge) of the remote input device. In some embodiments, the fourth coordinate system is a coordinate system with an origin located at or proximate to a position at which the first object was initially displayed at a time when the first motion input was detected, or a position in the center of the viewport provided by the display generation component. In some embodiments, the fourth coordinate system is a coordinate system of the environment as a whole. In an example, in some embodiments, tilting the remote input device upward around a latitudinal axis of the remote input device or around a transverse axis that passes through the user's wrist (e.g., with the upper edge of the device moving toward the user's face, and the lower edge of the device remaining stationary or moving away from the user's face) causes the computer system to move the first object upward in the environment (e.g., relative to the viewport through which the environment is visible, and/or relative to the viewpoint of the user); and tilting the remote input device downward around the latitudinal axis of the remote input device or around the transverse axis that passes through the user's wrist (e.g., with the upper edge of the input device moving away from the user's face, and the lower edge of the device remaining stationary or moving toward the user's face) causes the computer system to move the first object downward in the environment (e.g., relative to the viewport through which the environment is visible, and/or relative to the viewpoint of the user). In some embodiments, the amount and/or speed of the movement executed by the first object in the environment is based on the amount and/or speed of the rotation of the remote input device around the longitudinal axis of the remote input device. In one example, in some embodiments, tilting or moving the remote input device upward by tiling the palm that holds the remote input device toward the user's face around the wrist, and/or by rotating the forearm toward the user's face around the elbow joint, cause the computer system to move the first object upward in the environment; and tilting or moving the remote input device downward by tiling the palm that holds the remote input device away from the user's face around the wrist, and/or by rotating the forearm away from the user's face around the elbow joint, cause the computer system to move the first object downward in the environment. In some embodiments, tilting motion of the remote input device around a respective axis includes moving the remote input device to an updated tilt angle in a positive direction or in a negative direction relative to the reference angle. In some embodiments, holding the remote input device at the updated angle optionally causes the computer system to continuously move the first object in the first or second rotational direction, respectively (e.g., continuously move the first object until the updated tilt angle is reversed back to the reference angle by moving the remote input device). In some embodiments, the first object is moved with constant speed or with varying speed, e.g., based on duration of the hold. Moving first object in upward-downward direction in the mixed-reality three-dimensional environment by tilting the remote input device upward-downward around a latitudinal axis of the remote input device (e.g., moving the remote input device toward the floor or the ceiling, e.g., while the remote input device remains substantially parallel to the floor) or around a transverse axis that passes through the user's wrist (e.g., with the upper edge of the device moving toward or away from the user's face, respectively, and the lower edge of the device remaining stationary or moving away from or towards the user's face, respectively), reduces the amount of time, the number of inputs, and/or the complexity of inputs needed to move a selected object the mixed-reality three-dimensional (e.g., by requiring less precision and without the need to select user interface controls).

In some embodiments, moving the first object in the environment in accordance with the first motion input includes: in accordance with a determination that the tilting motion is in a third rotational direction (e.g., rotation around yet another respective axis or yet another respective pivot point in the same or another respective coordinate system of the physical environment, in a positive direction or in a negative direction relative to a reference angle), different from the first rotational direction and the second rotational direction (e.g., different in direction, axis, pivot point, amount, and/or coordinate system), moving the first object in a third translational direction in the environment (e.g., translating the first object in an increasing or decreasing z direction, or in a positive or negative direction relative to a reference position) that corresponds to the third rotational direction, the third translational direction being different from the first translational direction and the second translational direction (e.g., the third translational direction is a direction in said same or other coordinate system of the computer-generated environment that corresponds to the third rotational direction in said same or other coordinate system of the physical environment). For example, in FIGS. 7K-7L, in response to detecting a rotational motion of remote input device 7010 about the short axis 7130 (e.g., rotational motion moving the top edge of remote input device 7010 toward the floor 7008 and a bottom edge of the remote input device away from floor 7008, such as pitching around short axis 7130), user interface “W2” 7030 user interface “W2” 7030 is pushed back in the simulated depth dimension (e.g., z direction, and/or at a larger distance away from the viewpoint of the user 7002). In some embodiments, the third translational direction is different from the first translational direction and the second translational direction in direction, amount, and/or coordinate system. In some embodiments, the third rotational direction is substantially orthogonal to the first and/or second rotational directions, in the same coordinate system of the physical environment. In some embodiments, the third rotational direction is substantially orthogonal to the first and/or second rotational directions, but they are relative to different coordinate systems of the physical environment. In some embodiments, the third rotational direction is not substantially orthogonal to the first and/or second rotational directions, and they are relative to different coordinate systems of the physical environment. In some embodiments, detecting the first motion input includes detecting tilting motion of the remote input device in a sequence of movements that include respective tilting motions in different rotational directions (e.g., different in direction, axis, pivot point, amount, and/or coordinate system), and as a result, the computer system causes a sequence of movements (e.g., translational movements that differ in terms of direction, amount, and/or coordinate system) of the first object in the environment that are respectively based on the respective tilting motions in the different rotational directions. In some embodiments, tilting motion of the remote input device around a respective axis includes moving the remote input device to an updated angle in a positive direction or in a negative direction relative to the reference angle. In some embodiments, holding the remote input device at the updated angle optionally causes the computer system to continuously move the first object in the third rotational direction (e.g., continuously move the first object until the updated tilt angle is reversed back to the reference angle by moving the remote input device). In some embodiments, the first object is moved with constant speed or with varying speed, e.g., based on duration of the hold. Moving first object toward or away from a viewpoint of the user in the mixed-reality three-dimensional environment by tilting the remote input device upward-downward around a latitudinal axis of the remote input device or around a transverse axis that passes through the user's wrist (e.g., with the upper edge of the device moving toward or away from the user's face, respectively, and the lower edge of the device remaining stationary or moving away from or towards the user's face, respectively), reduces the amount of time, the number of inputs, and/or the complexity of inputs needed to move a selected object the mixed-reality three-dimensional (e.g., by requiring less precision and without the need to select user interface controls).

In some embodiments, the third rotational direction includes rotation around a respective axis in a fifth coordinate system (e.g., same as the first and/or third coordinate system, or different in one or more aspects from the first and/or third coordinate system, such as different in type (e.g., spherical or Cartesian) or having different origin or center point) (e.g., tilting up and down, optionally partially, around a latitudinal axis of the remote input device; and/or pitching, optionally partially, around latitudinal axis that passes the wrist or elbow), and the third translational direction includes a depth direction (e.g., away or toward the viewpoint of the user; and/or away or toward the plane of the viewport through which the environment is visible) in a sixth coordinate system (e.g., same as the second and/or fourth coordinate system, or different in one or more aspects from the second and/or fourth coordinate system) different from the fifth coordinate system. For example, in FIGS. 7K-7L, in response to detecting a rotational motion of remote input device 7010 about the short axis 7130 (e.g., rotational motion moving the top edge of remote input device 7010 toward the floor 7008 and a bottom edge of the remote input device away from floor 7008, such as pitching around short axis 7130), user interface “W2” 7030 moves further away from the viewpoint of user 7002. In some embodiments, movement of the first object away or toward the user's viewpoint in the environment and/or away or toward the plane of the viewport through which the environment is visible can be executed in response to one or more types of rotational movements of the remote input device, such as (1) a forward and backward rotation of the remote input device around its latitudinal axis, (2) a rotation of the remote input device (e.g., with its top edge moving toward and away from the user's face, while the bottom edge remains substantially stationary or moving in the opposite direction as the top edge) caused by a forward and backward pivoting motion of the wrist (e.g., with the inner wrist facing sideways, upward, or downward) that is connected to a hand holding the remote input device, and/or (3) a upward and downward sweeping motion of the remote input device cause by a hand holding the remote input device and sweeping upward and downward around the elbow joint. In some embodiments, the remote input device is held by the hand with the top edge pointing upward, with the top edge pointing forward, with the frontal surface facing upward, with the frontal surface facing toward the user, and/or with other spatial relationships between the hand, the user, the direction of gravity, and the remote input device. In some embodiments, motion inputs that respectively trigger the vertical movement of the first object and the depth movement of the first object are disambiguated by criteria that distinguish at least two of the three movement types mentioned above. For example, in some embodiments, tilting the remote input device up and down around its latitudinal axis and/or around the wrist joint of the hand holding the remote input device causes the vertical movement of the first object in the environment, while up and down sweeping movement of the remote input device around the elbow joint associated with the hand holding the remote input device causes the depth movement of the first object in the environment. In another example, in some embodiments, tilting the remote input device up and down around its latitudinal axis and/or around the wrist joint of the hand holding the remote input device causes the depth movement of the first object in the environment, while up and down sweeping movement of the remote input device around the elbow joint associated with the hand holding the remote input device causes the vertical movement of the first object in the environment. In some embodiments, motion inputs that respectively trigger the vertical movement of the first object and the depth movement of the first object are disambiguated based on how the remote input device is held in the user's hand when one or more types of movement mentioned above are detected. For example, in some embodiments, when the remote input device is held in the user's hand with its frontal surface facing upward (or facing downward), the up and down tilt motion of the remote input device around the user's wrist causes the first object to move vertically in the environment; and when the remote input device is held in the user's hand with its side edge facing upward, the up and down tilt motion of the remote input device around the user's wrist causes the first object to move toward or away from the viewpoint or the viewport in the environment. Other types of criteria (e.g., special add-on inputs, position of user's fingers, and/or other accompanying inputs) are optionally used to disambiguate the request to move the first object vertically or in the depth direction, in various embodiments. In some embodiments, the respective axis in the fifth coordinate system is an axis that is substantially perpendicular to the direction of gravity and that points in a left-right direction relative to the user. In some embodiments, the respective axis in the fifth coordinate system is an axis that is a latitudinal axis in the plane of or parallel to a touch-sensitive surface (e.g., the touch screen, or a touch pad) of the remote input device. In some embodiments, the respective axis in the fifth coordinate system is an axis that passes transversely (e.g., from left to right when the palm is facing toward the user) through a wrist joint, an elbow joint that is connected to a hand that holds and moves the remote input device in the physical environment. In some embodiments, the depth direction in the sixth coordinate system is a direction pointing forward relative to the user's viewpoint. In some embodiments, the depth direction in the sixth coordinate system is a depth direction or z-direction relative to a user interface in which the first object is displayed. In some embodiments, the depth direction in the sixth coordinate system is a depth direction relative to a viewport provided by the display generation component through which the environment is visible. In some embodiments, the fifth coordinate system is a coordinate system with an origin located at or proximate to a user's wrist, elbow, shoulder, or finger around which the remote input device can be tilted or moved. In some embodiments, the fifth coordinate system is a coordinate system with an origin located at or proximate to a characteristic point (e.g., center, corner, or center of an edge) of the remote input device. In some embodiments, the sixth coordinate system is a coordinate system with an origin located at or proximate to a position at which the first object was initially displayed at a time when the first motion input was detected, or a position in the center of the viewport provided by the display generation component. In some embodiments, the sixth coordinate system is a coordinate system of the environment as a whole. In an example, in some embodiments, tilting the remote input device upward around a latitudinal axis of the remote input device or around a transverse axis that passes through the user's wrist (e.g., with the upper edge of the device moving toward the user's face, and the lower edge of the device remaining stationary or moving away from the user's face) causes the computer system to move the first object toward the viewpoint of the user in the environment; and tilting the remote input device downward around the latitudinal axis of the remote input device or around the transverse axis that passes through the user's wrist (e.g., with the upper edge of the input device moving away from the user's face, and the lower edge of the device remaining stationary or moving toward the user's face) causes the computer system to move the first object away from the viewpoint of the user in the environment. In some embodiments, the amount and/or speed of the movement executed by the first object in the environment is based on the amount and/or speed of the rotation of the remote input device around the longitudinal axis of the remote input device. In one example, in some embodiments, tilting or moving the remote input device upward by tiling the palm that holds the remote input device toward the user's face around the wrist, and/or by rotating the forearm toward the user's face around the elbow joint, cause the computer system to move the first object toward the viewpoint of the user in the environment; and tilting or moving the remote input device downward by tiling the palm that holds the remote input device away from the user's face around the wrist, and/or by rotating the forearm away from the user's face around the elbow joint, cause the computer system to move the first object away from the viewpoint of the user in the environment. Moving first object toward or away from a viewpoint of the user in the mixed-reality three-dimensional environment by tilting the remote input device upward-downward around a latitudinal axis of the remote input device or around a transverse axis that passes through the user's wrist (e.g., with the upper edge of the device moving toward or away from the user's face, respectively, and the lower edge of the device remaining stationary or moving away from or towards the user's face, respectively), reduces the amount of time, the number of inputs, and/or the complexity of inputs needed to move a selected object the mixed-reality three-dimensional (e.g., by requiring less precision and without the need to select user interface controls).

In some embodiments, while the view of the environment is visible via the display generation component, the computer system detects a first touch input that includes movement of a first contact on the remote input device (e.g., movement of the finger contact on the touch-sensitive surface or touch-screen display of the remote input device, optionally, while the remote input device is held and/or moved by the hand including the finger). In response to detecting the first touch input and in accordance with a determination that the gaze detected by the computer system was directed to (e.g., remains substantially stationary (e.g., having less than a threshold amount of movement in a unit of time, for at least a threshold amount of time) within a region of) the first object (e.g., a user interface object, a control, a window, a virtual object, and/or other moveable items in a three-dimensional environment, such as a mixed reality environment or a virtual reality environment) when the first touch input was detected (e.g., optionally, while the first object is selected (e.g., by the gaze, optionally in conjunction with another gesture, or by another type of selection input)), the computer system moves the first object in the environment in accordance with the first touch input (e.g., dragging, pivoting, rotating, and/or otherwise changing the position and pose of the first object in the environment, in accordance with the characteristics of the first touch input (e.g., direction, speed, amount, acceleration, and other movement characteristics)). For example, in FIGS. 7F-7J, user interface “W1” 7026 is selected in response to a gaze input in combination with a touch input detected via the remote input device 7010, and then while selected, user interface “W1” 7026 is relocated in three-dimensional environment 7000′ using a touch movement input detected via a touch-sensitive surface of remote input device 7010. In some embodiments, in response to detecting the first touch input, in accordance with a determination that the gaze detected by the computer system was not directed to the first object when the first touch input was detected (e.g., optionally, while the first object is not selected), forgoing moving the first object in the environment in accordance with the first touch input (e.g., keeping the first object stationary, or allowing the first object to move in the environment without being influenced by the first touch input). In some embodiments, the computer system moves the first object in different directions in response to both movement of the remote input device in the physical environment (e.g., the first motion input, and/or other motion input) and movement of contact(s) on the remote input device (e.g., the first touch input, and/or other touch inputs). In some embodiments, movements in some directions (e.g., horizontal direction, vertical direction, and/or depth direction) are controlled by either motion inputs or touch inputs, while movements in other directions are controlled by both motion inputs and touch inputs, or a combination of motion inputs and touch inputs. Moving the first object in the mixed-reality three-dimensional environment by touch inputs detected on a touch-sensitive surface of the remote input device provides an additional input modality (e.g., use of a touch-sensitive surface of a remote input device in addition to inputs through movements in the physical environment of the remote input devices itself, gaze and/or air gestures), thereby reducing the amount of time, the number of inputs, and/or the complexity of inputs needed to move a selected object the mixed-reality three-dimensional (e.g., by requiring less precision and without the need select user interface controls).

In some embodiments, moving the first object in the environment in accordance with the first touch input includes: in accordance with a determination that the movement of the first contact is in a first direction (e.g., up and down direction relative to the touch-sensitive surface of the remote input device, along the longitudinal axis of the remote input device, and/or in a direction pointing toward or away from the user) relative to the remote input device, the computer system moves the first object in a respective translational direction in the environment that corresponds to the first direction. For example, in FIGS. 71-7J, user interface “W1” 7026 can be moved further away or closer to the viewpoint of the user 7002 (e.g., in simulated z-dimension) in response to detecting the movement of contact 7058 in an upward-downward direction across the touch-sensitive surface of remote input device 7010. Moving the first object in the mixed-reality three-dimensional environment by touch inputs that include movement of a contact in upward-downward direction (e.g., sliding a finger, or other input object, up and down) along a touch-sensitive surface of the remote input device provides an additional input modality (e.g., use of touch inputs in addition to inputs through movements in the physical environment of the remote input devices itself, gaze and/or air gestures), thereby reducing the amount of time, the number of inputs, and/or the complexity of inputs needed to move a selected object the mixed-reality three-dimensional (e.g., by requiring less precision and without the need to select user interface controls).

In some embodiments, the first direction is an up and down direction relative to the first remote device, and the respective translational direction in the environment that corresponds to the first direction is a depth direction in the environment (e.g., the third translational direction in the environment, and/or the depth direction in the sixth coordinate system mentioned above, such as in a direction toward or away from the viewpoint of the user). For example, in FIGS. 7I-7J, user interface “W1” 7026 can be moved further away or closer to the viewpoint of the user 7002 (e.g., in simulated z-dimension) in response to detecting the movement of contact 7058 in an upward-downward direction across the touch-sensitive surface of remote input device 7010. In some embodiments, the first direction is an up and down direction relative to the first remote device, and the respective translational direction in the environment is a vertical direction in the environment. In some embodiments, the first touch input including movements in the up and down direction causes the first object to move in the vertical direction, while the remote input device is held in an upright orientation relative to the user (e.g., with its top edge above the bottom edge, and its frontal surface facing toward the user). In some embodiments, the first touch input including movements in the up and down direction causes the first object to move in the depth direction, while the remote input device is held facing upward or facing downward). Moving the first object in the mixed-reality three-dimensional environment by touch inputs that include movement of a contact in upward-downward direction (e.g., sliding a finger, or other input object, up and down) along a touch-sensitive surface of the remote input device provides an additional input modality (e.g., use of touch inputs in addition to inputs through movements in the physical environment of the remote input devices itself, gaze and/or air gestures), thereby reducing the amount of time, the number of inputs, and/or the complexity of inputs needed to move a selected object the mixed-reality three-dimensional (e.g., by requiring less precision and without the need to select user interface controls).

In some embodiments, moving the first object in the environment in accordance with the first touch input includes: in accordance with a determination that the movement of the first contact is in a second direction (e.g., left and right direction relative to the touch-sensitive surface of the remote input device, along the latitudinal axis of the remote input device, and/or in a direction pointing left and right relative to the user), different from the first direction, relative to the remote input device, moving the first object in a respective translational direction in the environment that corresponds to the second direction, wherein the respective translational direction that corresponds to the second direction is different from the respective translational direction that corresponds to the first direction. For example, in FIGS. 7G-7H, selected user interface “W1” 7026 is moved in a rightward direction in three-dimensional environment 7000′ in response to detecting movement of a contact in the rightward direction across the touch-sensitive surface of remote input device 7010 (e.g., sliding a finger in the rightward direction across the touch-sensitive surface of remote input device 7010). Moving the first object in the mixed-reality three-dimensional environment by touch inputs that include movement of a contact in leftward-rightward direction (e.g., sliding a finger, or other input object, left and right) along a touch-sensitive surface of the remote input device provides an additional input modality (e.g., use of touch inputs in addition to inputs through movements in the physical environment of the remote input devices itself, gaze and/or air gestures), thereby reducing the amount of time, the number of inputs, and/or the complexity of inputs needed to move a selected object the mixed-reality three-dimensional (e.g., by requiring less precision and without the need to select user interface controls).

In some embodiments, the second direction is a left or right direction relative to the first remote device, and the respective translational direction in the environment that corresponds to the second direction is a horizontal direction in the environment (e.g., the first translational direction in the environment, and/or the horizontal direction in the second coordinate system mentioned above). For example, in FIGS. 7G-7H, selected user interface “W1” 7026 is moved in a rightward direction in three-dimensional environment 7000′ in response to detecting movement of a contact in the rightward direction across the touch-sensitive surface of remote input device 7010 (e.g., sliding a finger in the rightward direction across the touch-sensitive surface of remote input device 7010). In some embodiments, the second direction is a left and right direction relative to the first remote device, and the respective translational direction in the environment is a horizontal direction in the environment. In some embodiments, the first touch input including movements in the left and right direction causes the first object to move in the horizontal direction, while the remote input device is held in an upright orientation relative to the user (e.g., with its top edge above the bottom edge, and its frontal surface facing toward the user) and/or while the remote input device is held facing upward or facing downward. Moving the first object in the mixed-reality three-dimensional environment by touch inputs that include movement of a contact in leftward-rightward direction (e.g., sliding a finger, or other input object, left and right) along a touch-sensitive surface of the remote input device provides an additional input modality (e.g., use of touch inputs in addition to inputs through movements in the physical environment of the remote input devices itself, gaze and/or air gestures), thereby reducing the amount of time, the number of inputs, and/or the complexity of inputs needed to move a selected object the mixed-reality three-dimensional (e.g., by requiring less precision and without the need to select user interface controls).

In some embodiments, while the view of the environment is visible via the display generation component, the computer system detects a second touch input that includes detecting a second contact on the remote input device. In response to detecting the second touch input that includes detecting the second contact on the remote input device, in accordance with a determination that the second contact is detected at a location on the remote input device that corresponds to a location of the first object in the environment and that the second touch input meets selection criteria, the computer system selects the first object in the environment. In some embodiments, it is not required that the second contact is detected at a location on the remote input device that corresponds to the location of the first object in the environment for the first object to be selected. In some embodiments, in accordance with a determination that that the second touch input does not meet the selection criteria, the computer system forgoes selecting the first object (and optionally performs a different operation, such as scrolling. While the first object is selected in the environment, the computer system detects a second motion input that includes movement of the remote input device in the physical environment. In response to detecting the second motion input, in accordance with a determination that the first object has been selected by a respective touch input when the detecting the second motion input, the computer system moves the first object in the environment in accordance with the second motion input. In some embodiments, in accordance with a determination that the first object has not been selected by the respective touch input when the second motion input was detected, the computer system forgoes moving the first object in the environment (and optionally performs a different operation, or moves a different object in the environment in accordance with a determination that the different object has been selected by the respective touch input when the second motion input was detected. For example, in some embodiments, in addition to selecting the target of the motion input using the location of the gaze, the computer system further allows a user to select a target of the motion input using other means such as a touch input on a touch-sensitive surface of the remote input device. For example, in FIG. 7B, close affordance 7038 is selected by a tap input (e.g., user input 7050) on the touch-sensitive surface of remote input device 7010 that is detected while user's attention 7024 is directed to the close affordance 7038. In another example, in FIG. 7D search bar 7036 is selected by a tap input (e.g., user input 7052) on the touch-sensitive surface of remote input device 7010 that is detected while user's attention 7024 is directed to the search bar 7036. In some embodiments, the remote input device has a touch-sensitive surface that is mapped to the viewport through which the environment is visible via the display generation component, and the user can select the first object by moving a focus selector to the location of the first object in the environment by moving the contact on the touch-sensitive surface, or directly tapping at a location on the touch-sensitive surface that corresponds to the location of the first object. In some embodiments, the first object has a corresponding representation in the user interface presented on the touch-screen display of the remote input device, and the first object is selected in response to a tap or selection input on the representation of the first object shown on the touch-screen display of the remote input device. In some embodiments, the computer system displays a focus indicator (e.g., a cursor, reticle, highlight, outline, or other visual marker) at a location in the environment that corresponding to the current location of a contact on the touch-sensitive surface of the remote input device, and moves the focus indicator in accordance with the movement of the contact on the touch-sensitive surface of the remote input device. In some embodiments, a focus indicator is also displayed to indicate the detected position of the gaze, if no touch input is detected concurrently. Moving the first object in the mixed-reality three-dimensional environment by touch inputs that include movement of a contact in leftward-rightward direction (e.g., sliding a finger, or other input object, left and right) along a touch-sensitive surface of the remote input device provides an additional input modality (e.g., use of touch inputs in addition to inputs through movements in the physical environment of the remote input devices itself, gaze and/or air gestures), thereby reducing the amount of time, the number of inputs, and/or the complexity of inputs needed to move a selected object the mixed-reality three-dimensional (e.g., by requiring less precision and without the need to select user interface controls).

In some embodiments, the selection criteria are met when the input includes (or, optionally, is) a tap input. For example, in some embodiments, the first object is selected by a tap input on a representation of the first object shown on the touch-screen display of the remote input device. In some embodiments, the first object is selected by a tap input on a touch-sensitive surface of the remote input device while a gaze input is directed to the first object in the environment. In some embodiments, the first object is selected by a tap input on a touch-sensitive surface of the remote input device after a focus indicator has been moved to the location of the first object in the environment (e.g., by the same contact or by a previous contact detected on the touch-sensitive surface). For example, in FIG. 7B, close affordance 7038 is selected by a tap input (e.g., user input 7050) on the touch-sensitive surface of remote input device 7010 that is detected while user's attention 7024 is directed to the close affordance 7038. In another example, in FIG. 7D search bar 7036 is selected by a tap input (e.g., user input 7052) on the touch-sensitive surface of remote input device 7010 that is detected while user's attention 7024 is directed to the search bar 7036. Using touch inputs detected on a touch-sensitive surface of the remote input device to select an object in the mixed-reality three dimensional environment provides an additional input modality (e.g., use of touch inputs in addition to inputs through movements in the physical environment of the remote input devices itself, gaze and/or air gestures), thereby reducing the amount of time, the number of inputs, and/or the complexity of inputs needed to move a selected object the mixed-reality three-dimensional (e.g., by requiring less precision and without the need to select user interface controls).

In some embodiments, the first object displays content of a first application or is concurrently displayed with the content of the first application (e.g., the first object is an application window or is an affordance for selecting and moving the window, such as a window grabber affordance), and moving the first object in the environment corresponds to moving a display position of the content of the first application in the environment. For example, FIGS. 7F-7J illustrate a scenario in which user interface “W1” 7026 is relocated or moved, from an initial location to a target location, in three-dimensional environment 7000′ in response movement inputs detected via the touch-sensitive surface of remote input device 7010 while user interface “W1” 7026 is selected. Controlling placement and/or movement of a user interface corresponding to an application using movement inputs that include touch inputs on a touch-sensitive surface of a remote input device and/or movements of the remote input device itself in the physical environment, reduces the amount of time, the number of inputs, and/or the complexity of inputs needed to move a selected user interface corresponding to an application in the mixed-reality three-dimensional (e.g., by requiring less precision and without the need select user interface controls:

In some embodiments, while moving the first object in accordance with the first motion input, the computer system detects a change in at least one of an orientation or a position of the remote input device. In response to detecting the change in at least one of the orientation or position of the remote input device and in accordance with a determination that the change in at least one of the orientation or position of the remote input device would cause a change in a respective spatial relationship between the first object and a first reference region (e.g., a point, an area, or a volume) that corresponds to the remote input device in the environment (e.g., first object does not have or ceases to have the respective spatial relationship to the first reference region if the line connecting the first object and the first reference region would be intersecting rather than aligned with a longitudinal axis of the remote input device, or a direction pointed by the remote input device), the computer system changes at least one of an orientation or a position of the first object in the environment to maintain the respective spatial relationship between first object and the first reference region in the environment (e.g., first object has the respective spatial relationship to the first reference region or continues to have the respective spatial relationship when the line connecting the first object and the first reference region remains aligned with the longitudinal axis of the remote input device, or the direction pointed by the remote input device, as a result of the adjustment to the position and orientation of the first object in accordance with the change in position and/or orientation of the remote input device). For example, in FIGS. 7Q-7R, user interface user interface “W2” 7030 is moves as if connected to a virtual ray extending from remote input device 7010, where user interface “W2” 7030 moves to a position that corresponds to or is indicated by the virtual ray extending from remote input device 7010. In response to detecting the change in at least one of the orientation or position of the remote input device and in accordance with a determination that the change in at least one of the orientation or position of the remote input device would not cause a change in the respective spatial relationship between the first object and the first reference region that corresponds to the remote input device in the environment, the computer system forgoes changing the at least one of the orientation or the position of the first object in the environment (e.g., some movement of the remote input device would not causes changes in the position and orientation of the first object, such as rotation of the remote input device around its longitudinal axis, and/or translation of the remote input device in the direction pointed at by the remote input device). For example, in some embodiments, the first object is locked to a point of intersection between the longitudinal axis of the remote input device and a surface in which the first object is permitted to move; and by changing the position and/or orientation of the remote input device that changes the position of the point of intersection, the user can move the first object in the environment (e.g., as if the remote input device is a laser pointer, and the first object follows the light spot created by the laser pointer on a surface on which the first object is confined to move). Controlling placement and/or movement by using the remote input device as if the remote input device is a laser pointer and the first object is attached to a virtual ray extending from the remote input device provides an additional input modality and reduces the amount of time, the number of inputs, and/or the complexity of inputs needed to move a selected object in the mixed-reality three-dimensional (e.g., by requiring less precision and without the need to select user interface controls).

In some embodiments, the first object includes or is concurrently displayed with a respective grabber affordance that corresponds to the first object, in the view of the environment, and moving the first object in the environment in accordance with the first motion input is performed further in accordance with a determination that the respective grabber affordance that corresponds to the first object is selected at a time when the first motion input was detected (e.g., the first object is an application window and has an associated grabber affordance for selecting and moving the application window). In method 8000, while displaying the first object including or concurrently with the respective grabber affordance, the computer system detects a third motion input that includes movement of the remote input device in the physical environment (e.g., after detecting the first motion input, or before detecting the first motion input). In response to detecting the third motion input, in accordance with a determination that the gaze detected by the computer system was not directed to the first object or that the respective grabber affordance that corresponds to the first object was not selected, when the third motion input was detected, the computer system forgoes moving the first object in accordance with the third motion input. For example, in FIGS. 7F-7N (e.g., FIGS. 7N1-7N2), the computer system moves user interface “W2” 7030 in the mixed-reality using movement inputs performed using the remote device 7010 (e.g., movements of the remote input device itself in the physical environment and/or touch inputs detected on a touch-sensitive surface of the remote input device) when the grabber affordance 7032 of user interface “W2” 7030 is selected, and the computer system keeps user interface “W2” 7030 stationary if the movement inputs are detected when the respective grabber affordance 7032 of is not selected. In some embodiments, the first object is an application window or other virtual object including a grabber affordance or is displayed with a corresponding grabber affordance, where the grabber affordance is optionally displayed in response to detecting the gaze directed to the corner or edge of the window or virtual object, and/or becomes selected when the gaze is directed to the grabber affordance; and the motion input of the remote input device causes the window or virtual object to be moved in the environment while the grabber affordance remains selected, and does not cause further movement of the window or virtual object in the environment when the grabber affordance is no longer selected (e.g., when the user selects another affordance, or object in the environment, or toggle the selection state of the grabber using another input). For example, in FIGS. 7F-7N, the computer system moves user interface “W2” 7030 in the mixed-reality using movement inputs performed using the remote device 7010 (e.g., movements of the remote input device itself in the physical environment and/or touch inputs detected on a touch-sensitive surface of the remote input device) when the grabber affordance 7032 of user interface “W2” 7030 is selected, and the computer system keeps user interface “W2” 7030 stationary if the movement inputs are detected when the respective grabber affordance 7032 of is not selected. Moving a selected object in the mixed-reality using movement inputs performed using the remote device (e.g., movements of the remote input device itself in the physical environment and/or touch inputs detected on a touch-sensitive surface of the remote input device) when a respective grabber affordance is selected and keeping the selected object stationary if the movement inputs are detected when the respective grabber affordance is not selected, disambiguates user's intent to use the remote input device as an additional input modality, thereby reducing the amount of time and/or number of inputs needed to move a selected object in the mixed-reality three-dimensional (e.g., by avoiding accidental movements or unintended inputs).

In some embodiments, the environment is a three-dimensional environment (e.g., a virtual reality environment or an augmented reality environment), where the view of the three-dimensional environment changes in accordance with movement of a viewpoint of a user of the environment via the one or more display generation components. For example, in FIGS. 7B-7R, the portions of the physical environment 7000 or three-dimensional environment 7000′ that are visible via display generation component 7100 can change in conjunction with changes in the viewpoint of user 7002. Moving a selected object in the mixed-reality using movement inputs performed using the remote device (e.g., movements of the remote input device itself in the physical environment and/or touch inputs detected on a touch-sensitive surface of the remote input device) provides an additional input modality, thereby reducing the amount of time, the number of inputs, and/or the complexity of inputs needed to move a selected object in the mixed-reality three-dimensional (e.g., by requiring less precision and without the need to select user interface controls).

In some embodiments, the remote input device is an electronic device with a touch-screen display and that displays a user interface that is distinct from the view of the environment (e.g., the remote device is a smartphone that connects to the internet and has an operating system and its own user interfaces). For example, in FIGS. 7B-7R, remote input device 7010 that is used to interact with and manipulate objects in the three-dimensional environment 7000′ has a touch-sensitive display. In some embodiments, the remote input device communicates with the computer system that controls the display generation component and generates the three-dimensional environment, and provides input to the computer system in one operation mode; and the remote input device performs functions (e.g., telephony function, word processing function, email function, internet browsing function, and other functions on a smart handheld device) and provide user interface interactions on its own touch-screen display, without the computer system that generates the three-dimensional environment. Moving a selected object in the mixed-reality environment using movement inputs performed using a smartphone reduces the need for additional hardware controllers by retrofitting existing hardware and provides an additional input modality, thereby reducing the amount of time, the number of inputs, and/or the complexity of inputs needed to move a selected object in the mixed-reality three-dimensional (e.g., by requiring less precision and without the need to select user interface controls).

In some embodiments, the remote input device has a plurality of hardware affordances (e.g., touch-sensitive regions, buttons, switches, and/or other affordances based on mechanical, electrical, solid state, and/or other sensing and actuation means), including a first hardware button associated with a first function and a second hardware button associated with a second function. The computer system detects an input directed at a respective hardware button of the plurality of hardware affordances. In response to detecting the input directed at the respective hardware affordance and in accordance with a determination that the input is directed at the first hardware button (e.g., the volume button, the power button, a switch, and/or other hardware affordance on the remote input device), the computer system performs the first function with respect to the environment (e.g., changing volume of audio output associated with the environment, changing screen brightness associated with the environment, changing the level of immersion with which the environment is displayed (e.g., decreasing the amount of virtual content that is displayed in the environment), and/or performing other functions that changes one or more states of the environment as a whole and/or the states of one or more of the objects in the environment). In response to detecting the input directed at the respective hardware affordance and in accordance with a determination that the input is directed at the second hardware button (e.g., the volume button, the power button, a switch, and/or other hardware affordance on the remote input device, different from the first hardware button), the computer system performs the second function with respect to the environment (e.g., navigating to another page, or user interface, closing an application, changing to a different experience, terminating or starting a communication session, scrolling content, and/or performing other operations with respect to the computer system or the content displayed in the environment). In some embodiments, hardware buttons on the smartphone are used to perform corresponding functions in the three-dimensional environment. For example, volume adjustment button(s) 2008 of remote input device 7010 can be used to adjust the volume outputted by computer system 101, and push button 2006 can be used to turn on/off display of the three-dimensional environment 7000′ via display generation component 7100 (FIG. 7B). In some embodiments, the buttons perform same or similar functions in the environment as in the user interface of the remote input device when the remote input device is used independent of the computer system that generates the environment. Using hardware buttons (e.g., including solid-state buttons) as an additional input modality to control operations in the mixed-reality three-dimensional environment provides reliable input mechanism (e.g., tactile touch/mechanical actuation) without the need to display user interface controls, thereby reducing the number of inputs and/or the amount of time needed to manipulate objects and interact with the mixed-reality three-dimensional environment (e.g., by requiring less precision, reducing clutter, and without the need to select and or locate user interface controls).

In some embodiments, the first hardware button is a volume control for adjusting an output volume of a speaker of the electronic device (e.g., when the electronic device is used independently of the computer system that generates the environment), and performing the first function with respect to the environment includes changing an output volume of a speaker of the computer system. For example, volume adjustment button(s) 2008 of remote input device 7010 can be used to adjust the volume outputted by computer system 101 (FIG. 7B). Using hardware buttons as an additional input modality to control volume in the mixed-reality three-dimensional environment provides reliable input mechanism (e.g., tactile touch/mechanical actuation) without the need to display user interface controls, thereby reducing the number of inputs and/or the amount of time needed to control volume in the mixed-reality three-dimensional environment (e.g., by requiring less precision, reducing clutter, and without the need to select and or locate user interface controls).

In some embodiments, the second hardware button is a power button for turning on or off the electronic device, and performing the second function with respect to the environment includes switching turning on or off display of the environment on the computer system. In some embodiments, the power button that is used to turn on and off the smartphone can also be used to turn on and off the computer system. For example, push button 2006 can be used to turn on/off display of the three-dimensional environment 7000′ via display generation component 7100 (FIG. 7B). Using hardware buttons as an additional input modality to turning on or off display of the mixed-reality three-dimensional environment on the computer system provides reliable input mechanism (e.g., tactile touch/mechanical actuation) without the need to display user interface controls, thereby reducing the number of inputs and/or the amount of time needed to turn on and off the computer system (e.g., by requiring less precision, reducing clutter, and reducing the need to select and or locate user interface controls).

In some embodiments, while the first object in the environment has input focus (e.g., when gaze is directed to the content region of the first object, or when the first object is selected, or has input focus via other methods), the computer system detects a first scrolling input that includes movement of one or more contacts on a touch-sensitive surface of the remote input device (e.g., a swipe or a drag gesture). In response to detecting the scrolling input and in accordance with a determination that the first object includes scrollable content, the computer system ceases to display a first portion of the scrollable content and displaying a second portion of the scrollable content. In some embodiments, the same algorithm that is used for scrolling a user interface on a smartphone is also used for scrolling content in the environment. For example, the same scrolling input that would cause remote input device 7010 to scroll scrollable content displayed on the touch-sensitive display of remote input device 7010 is also used to scroll content user interface 7070 in the three-dimensional environment 7000′ (FIGS. 70-7P). In some embodiments, when a user interface displayed on the touch-screen display of the remote input device has input focus, the electronic device scrolls the content in the user interface displayed on the touch-screen display of the remote input device in response to a second scrolling input that includes movement of one or more contacts on a touch-sensitive surface of the remote input device (e.g., a swipe or a drag gesture). Using the same touch unput and the same algorithm that is used for scrolling a user interface on a smartphone for scrolling content in the mixed-reality three-dimensional environment provides an additional input modality, thereby reducing the amount of time, the number of inputs, and/or the complexity of inputs needed to scroll content of an object in the mixed-reality three-dimensional (e.g., by requiring less precision and without the need to select user interface controls).

In some embodiments, while displaying the view of the environment, the computer system detects that the remote input device is oriented to point at a respective object in the view of the environment. While the remote input device is oriented to point at the respective object in the view of the environment, the computer system detects a tap input via a touch-sensitive surface of the remote input device. In response to detecting the tap input while the remote input device is oriented to point at the respective object in the view of the environment, the computer system selects the respective object as a target for a subsequent operation performed by the remote input device (e.g., using a motion input to move the respective object in the environment, scrolling the content within the respective object in response to scroll input provided via the remote input device, or performing other operations with respect to the respective object in the environment). For example, in FIG. 7Q, the computer system selects an object, such as grabber affordance 7031, that correspond to a location at which a virtual ray extending from remote input device 7010 is pointing. Using orientation of the remote input device as a pointer or focus indicator to indicate a target object that has focus input in conjunction with tap input via the touch-sensitive surface of the remote input device to select a target object, makes user-device interaction in the mixed-reality three-dimensional environment more efficient by reducing the amount of time and number of inputs needed to select a target object and/or content within the target object.

In some embodiments, while displaying the view of the environment, the computer system detects that the remote input device is oriented to point at a respective object in the view of the environment. While the remote input device is oriented to point at the respective object in the view of the environment, the computer system detects touch-down of a first swipe input via a touch-sensitive surface of the remote input device. In response to detecting the first swipe input after the touch-down of the first swipe input (e.g., optionally, while the remote input device is no longer oriented to point at the respective object in the view of the environment), the computer system scrolls content within the respective object in accordance with the first swipe input (e.g., scrolling sideways in accordance with a horizontal swipe; and scrolling up and down in accordance with a vertical swipe). For example, in FIGS. 70-7P, instead of scrolling in response to movement touch inputs detected via the touch-sensitive surface of remote input device 7010, the computer system scrolls content of user interface 7070 using orientation of the remote input device to indicate what content has input focus in conjunction with drag input via the touch-sensitive surface of the remote input device 7010. Using orientation of the remote input device as a pointer or focus indicator to indicate a target object that has focus input in conjunction with drag input via the touch-sensitive surface of the remote input device to scroll content, makes user-device interaction in the mixed-reality three-dimensional environment more efficient by reducing the amount of time and number of inputs needed to scroll content.

In some embodiments, while displaying the view of the environment, the computer system detects that the remote input device is oriented to point at a respective object in the view of the environment. While the remote input device is oriented to point at the respective object in the view of the environment, the computer system detects touch-down of a second swipe input via a touch-sensitive surface of the remote input device. In response to detecting the second swipe input followed by an end of the second swipe input (e.g., liftoff of a contact used to perform the swipe input and/or an end of movement of a contact used to perform the swipe input) (e.g., optionally, while the remote input device is no longer oriented to point at the respective object in the view of the environment), the computer system moves the respective object in the environment in accordance with the second swipe input, and placing the respective object or a copy thereof at a location in the environment that corresponds to a location of the respective object at the end of the second swipe input (e.g., dragging the respective object in a direction and/or by a distance that are based on the direction and/or distance of the second swipe input, and dropping the respective object at the termination of the second swipe input). In some embodiments, the respective object is dragged and dropped in response to a touch, slide, and lift off of a contact with the touch-sensitive of the remote input device, where the respective object is selected by the pointing of the remote input device at the time that the touch-down of the contact is detected. For example, in FIGS. 7Q-7R, the computer system drags and drops user interface 7070 using orientation of the remote input device to indicate what content has input focus in conjunction with touch, slide, and lift off of a contact via the touch-sensitive of the remote input device 7010. Using orientation of the remote input device as a pointer or focus indicator to indicate a target object that has focus input in conjunction with touch, slide, and lift off of a contact via the touch-sensitive of the remote input device to drag and drop an object, makes user-device interaction in the mixed-reality three-dimensional environment more efficient by reducing the amount of time and number of inputs needed to drag and drop an object.

In some embodiments, while the view of the environment is visible via the display generation component, the computer system detects a fourth motion input (e.g., same motion input as the first motion input, or different from the first motion input) that includes movement of the remote input device in the physical environment. In response to detecting the fourth motion input and in accordance with a determination that the remote input device is oriented to point at the first object at a start of the fourth motion input (e.g., the remote input device has remained in an orientation that points at the first object for at least a threshold amount of time to select the first object, before the fourth motion input is started), moving the first object in accordance with the fourth motion input. In response to detecting the fourth motion input and in accordance with a determination that the remote input device is oriented to not point at the first object at the start of the fourth motion input (e.g., the remote input device has not remained in an orientation that points at the first object for at least a threshold amount of time to select the first object, before the fourth motion input is started), the computer system forgoes moving the first object in accordance with the fourth motion input. For example, instead of using user's attention 7024 in FIGS. 7B-7C, user 7002 can switch to a mode in which the user 7002 can use the remote input device 7010 as a focus indicator, e.g., where a virtual ray extending from remote input device 7010 indicates what object or content has input focus. Switching between using gaze or orientation of the remote input device as a pointer or focus indicator to indicate a target object that has focus input provides an additional input modality, thereby making user-device interaction in the mixed-reality three-dimensional environment more efficient (e.g., by reducing the amount of time and number of inputs needed to select a target object).

In some embodiments, the computer system detects a selection input directed to a text input region displayed in the environment (e.g., in the first object, in the second object, in another object) (e.g., a field in which alphanumerical input can be entered, such as a text box, an address bar, a word document). In response to detecting the selection input that is directed to the text input region displayed in the environment, the computer system displays of a virtual keyboard on a display of the remote input device (e.g., a touch sensitive display). For example, the remote input device 7010 automatically (without additional user input) displays a virtual keyboard 7102 on the touch-sensitive surface of the remote input device 7010 in response to selecting search box 7036 for entering search queries or other text entries (FIG. 7D). In some embodiments, the virtual keyboard is displayed on the remote input device in conjunction with displaying the focus selector in a location in the environment that is occupied by the text entry field. In some embodiments, detecting the selection input includes detecting a gaze directed to the text input region. In some embodiments, detecting the selection input includes detecting that the remote input device is oriented to point at the text input region, optionally, in conjunction with detecting a confirmation input (e.g., a tap input, and/or a touch-down of a contact on the remote input device). Displaying a virtual keyboard on the touch-sensitive surface of the remote input device in response to selecting a text field, makes the user-device interaction in the mixed-reality three-dimensional environment more efficient (e.g., by reducing the amount of time and number of inputs needed to enter text).

In some embodiments, while displaying the text input region in the environment and while the virtual keyboard is displayed on the display of the remote input device, the computer system receives textual input via the virtual keyboard displayed on the display of the remote input device. In response to receiving the textual input, the computer system displays one or more symbols (e.g., alphanumeric symbols) in the text input region, wherein the one or more symbols correspond to the textual input received via the virtual keyboard displayed on the display of the remote input device. For example, FIG. 7E illustrates that by typing on virtual keyboard 7102 displayed on the display of remote input device 7010, user 7002 in search box 7036 displayed in the three-dimensional environment 7000′ that is visible via display generation component 7100. Entering text via a virtual keyboard on the touch-sensitive surface of the remote input device provides an additional input modality, thereby reducing the amount of time and number of inputs needed to enter text (e.g., without the need for physical keyboard or without the need to display a virtual keyboard in the mixed-reality three-dimensional environment).

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In another example, users can select not to provide data for customization of services. In yet another example, users can select to limit the length of time data is maintained or entirely prohibit the development of a customized service. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can generated by inferring preferences based on non-personal information data or a bare minimum amount of personal information, such as the content being requested by the device associated with a user, other non-personal information available to the service, or publicly available information.

What is claimed is:

1. A method, comprising:
at a computer system that is in communication with a display generation component and with one or more input devices, including a remote input device:
while a view of an environment is visible via the display generation component, detecting a first motion input that includes movement of the remote input device in a physical environment;
in response to detecting the first motion input:
in accordance with a determination that a gaze detected by the computer system was directed to a first object when the first motion input was detected, moving the first object in the environment in accordance with the first motion input; and
in accordance with a determination that the gaze detected by the computer system was not directed to the first object when the first motion input was detected, forgoing moving the first object in the environment in accordance with the first motion input.

2. The method of claim 1, including:
in response to detecting the first motion input:
in accordance with a determination that the gaze detected by the computer system was directed to a second object, different from the first object, when the first motion input was detected, moving the second object in the environment in accordance with the first motion input without moving the first object in accordance with the first motion input.

3. The method of claim 2, including:
in response to detecting the first motion input:
in accordance with a determination that the gaze detected by the computer system was directed to the first object when the first motion input was detected, moving the first object in the environment in accordance with the first motion input without moving the second object in accordance with the first motion input.

4. The method of claim 1, wherein:
detecting the first motion input includes detecting tilting motion of the remote input device, and
moving the first object in the environment in accordance with the first motion input includes:
in accordance with a determination that the tilting motion is in a first rotational direction, moving the first object in a first translational direction in the environment that corresponds to the first rotational direction; and
in accordance with a determination that the tilting motion is in a second rotational direction, different from the first rotational direction, moving the first object in a second translational direction in the environment that corresponds to the second rotational direction, the second translational direction being different from the first translational direction.

5. The method of claim 4, wherein the first rotational direction includes rotation around a respective axis in a first coordinate system, and the first translational direction includes a horizontal direction in a second coordinate system different from the first coordinate system.

6. The method of claim 4, wherein the second rotational direction includes rotation around a respective axis in a third coordinate system, and the second translational direction includes a vertical direction in a fourth coordinate system different from the third coordinate system.

7. The method of claim 4, wherein moving the first object in the environment in accordance with the first motion input includes:
in accordance with a determination that the tilting motion is in a third rotational direction, different from the first rotational direction and the second rotational direction, moving the first object in a third translational direction in the environment that corresponds to the third rotational direction, the third translational direction being different from the first translational direction and the second translational direction.

8. The method of claim 7, wherein the third rotational direction includes rotation around a respective axis in a fifth coordinate system, and the third translational direction includes a depth direction in a sixth coordinate system different from the fifth coordinate system.

9. The method of claim 1, including:
while the view of the environment is visible via the display generation component, detecting a first touch input that includes movement of a first contact on the remote input device; and
in response to detecting the first touch input:
in accordance with a determination that the gaze detected by the computer system was directed to the first object when the first touch input was detected, moving the first object in the environment in accordance with the first touch input.

10. The method of claim 9, wherein moving the first object in the environment in accordance with the first touch input includes:
in accordance with a determination that the movement of the first contact is in a first direction relative to the remote input device, moving the first object in a respective translational direction in the environment that corresponds to the first direction.

11. The method of claim 10, wherein the first direction is an up or down direction relative to the remote input device, and the respective translational direction in the environment that corresponds to the first direction is a depth direction in the environment.

12. The method of claim 10, wherein moving the first object in the environment in accordance with the first touch input includes:
in accordance with a determination that the movement of the first contact is in a second direction, different from the first direction, relative to the remote input device, moving the first object in a respective translational direction in the environment that corresponds to the second direction, wherein the respective translational direction that corresponds to the second direction is different from the respective translational direction that corresponds to the first direction.

13. The method of claim 12, wherein the second direction is a left or right direction relative to the remote input device, and the respective translational direction in the environment that corresponds to the second direction is a horizontal direction in the environment.

14. The method of claim 1, including:
while the view of the environment is visible via the display generation component, detecting a second touch input that includes detecting a second contact on the remote input device;
in response to detecting the second touch input that includes detecting the second contact on the remote input device:
in accordance with a determination that the second contact is detected at a location on the remote input device that corresponds to a location of the first object in the environment and that the second touch input meets selection criteria, selecting the first object in the environment;
while the first object is selected in the environment, detecting a second motion input that includes movement of the remote input device in the physical environment; and
in response to detecting the second motion input:
in accordance with a determination that the first object has been selected by a respective touch input when the detecting the second motion input, moving the first object in the environment in accordance with the second motion input.

15. The method of claim 14, wherein the selection criteria are met when the second touch input includes a tap input.

16. The method of claim 1, wherein:
the first object displays content of a first application or is concurrently displayed with the content of the first application; and
moving the first object in the environment corresponds to moving a display position of the content of the first application in the environment.

17. The method of claim 1, including:
while moving the first object in accordance with the first motion input, detecting a change in at least one of an orientation or a position of the remote input device; and
in response to detecting the change in at least one of the orientation or position of the remote input device:
in accordance with a determination that the change in at least one of the orientation or position of the remote input device would cause a change in a respective spatial relationship between the first object and a first reference region that corresponds to the remote input device in the environment, changing at least one of an orientation or a position of the first object in the environment to maintain the respective spatial relationship between first object and the first reference region in the environment; and
in accordance with a determination that the change in at least one of the orientation or position of the remote input device would not cause a change in the respective spatial relationship between the first object and the first reference region that corresponds to the remote input device in the environment, forgoing changing the at least one of the orientation or the position of the first object in the environment.

18. The method of claim 1, wherein:
the first object includes or is concurrently displayed with a respective grabber affordance that corresponds to the first object, in the view of the environment; and
moving the first object in the environment in accordance with the first motion input is performed further in accordance with a determination that the respective grabber affordance that corresponds to the first object is selected at a time when the first motion input was detected; and the method includes:
while displaying the first object including or concurrently with the respective grabber affordance, detecting a third motion input that includes movement of the remote input device in the physical environment; and
in response to detecting the third motion input, in accordance with a determination that the gaze detected by the computer system was not directed to the first object or that the respective grabber affordance that corresponds to the first object was not selected, when the third motion input was detected, forgoing moving the first object in accordance with the third motion input.

19. The method of claim 1, wherein:
the environment is a three-dimensional environment, where the view of the three-dimensional environment changes in accordance with movement of a viewpoint of a user of the environment via the display generation component.

20. The method of claim 1, wherein:
the remote input device is an electronic device with a touch-screen display and that displays a user interface that is distinct from the view of the environment.

21. The method of claim 20, wherein:
the remote input device has a plurality of hardware affordances, including a first hardware button associated with a first function and a second hardware button associated with a second function;
detecting an input directed at a respective hardware button of the plurality of hardware affordances; and
in response to detecting the input directed at the respective hardware button:
in accordance with a determination that the input is directed at the first hardware button, performing the first function with respect to the environment; and
in accordance with a determination that the input is directed at the second hardware button, performing the second function with respect to the environment.

22. The method of claim 21, wherein:
the first hardware button is a volume control for adjusting an output volume of a speaker of the computer system; and
performing the first function with respect to the environment includes changing an output volume of a speaker of the computer system.

23. The method of claim 21, wherein:
the second hardware button is a power button for turning on or off the computer system; and
performing the second function with respect to the environment includes switching turning on or off display of the environment on the computer system.

24. The method of claim 20, including:
while the first object in the environment has input focus, detecting a first scrolling input that includes movement of one or more contacts on a touch-sensitive surface of the remote input device; and
in response to detecting the first scrolling input:
in accordance with a determination that the first object includes scrollable content, ceasing to display a first portion of the scrollable content and displaying a second portion of the scrollable content.

25. The method of claim 1, including:
while displaying the view of the environment, detecting that the remote input device is oriented to point at a respective object in the view of the environment;
while the remote input device is oriented to point at the respective object in the view of the environment, detecting a tap input via a touch-sensitive surface of the remote input device; and
in response to detecting the tap input while the remote input device is oriented to point at the respective object in the view of the environment, selecting the respective object as a target for a subsequent operation performed by the remote input device.

26. The method of claim 1, including:
while displaying the view of the environment, detecting that the remote input device is oriented to point at a respective object in the view of the environment;
while the remote input device is oriented to point at the respective object in the view of the environment, detecting touch-down of a first swipe input via a touch-sensitive surface of the remote input device; and
in response to detecting the first swipe input after the touch-down of the first swipe input, scrolling content within the respective object in accordance with the first swipe input.

27. The method of claim 1, including:
while displaying the view of the environment, detecting that the remote input device is oriented to point at a respective object in the view of the environment;
while the remote input device is oriented to point at the respective object in the view of the environment, detecting touch-down of a second swipe input via a touch-sensitive surface of the remote input device; and
in response to detecting the second swipe input followed by an end of the second swipe input, moving the respective object in the environment in accordance with the second swipe input, and placing the respective object or a copy thereof at a location in the environment that corresponds to a location of the respective object at the end of the second swipe input.

28. The method of claim 1, including:
while the view of the environment is visible via the display generation component, detecting a fourth motion input that includes movement of the remote input device in the physical environment; and
in response to detecting the fourth motion input:
in accordance with a determination that the remote input device is oriented to point at the first object at a start of the fourth motion input, moving the first object in accordance with the fourth motion input; and
in accordance with a determination that the remote input device is oriented to not point at the first object at the start of the fourth motion input, forgoing moving the first object in accordance with the fourth motion input.

29. The method of claim 1, including:
detecting a selection input directed to a text input region displayed in the environment; and
in response to detecting the selection input that is directed to the text input region displayed in the environment, causing display of a virtual keyboard on a display of the remote input device.

30. The method of claim 29, including:
while displaying the text input region in the environment and while the virtual keyboard is displayed on the display of the remote input device, receiving textual input via the virtual keyboard displayed on the display of the remote input device; and
in response to receiving the textual input, displaying one or more symbols in the text input region, wherein the one or more symbols correspond to the textual input received via the virtual keyboard displayed on the display of the remote input device.

31. A computer-readable storage medium storing one or more programs configured to be executed by one or more processors of a computer system that is in communication with a display generation component and one or more input devices, including a remote input device, the one or more programs including instructions for:
while a view of an environment is visible via the display generation component, detecting a first motion input that includes movement of the remote input device in a physical environment;
in response to detecting the first motion input:
in accordance with a determination that a gaze detected by the computer system was directed to a first object when the first motion input was detected, moving the first object in the environment in accordance with the first motion input; and
in accordance with a determination that the gaze detected by the computer system was not directed to the first object when the first motion input was detected, forgoing moving the first object in the environment in accordance with the first motion input
detecting, via the one or more input devices, a user input; and
displaying, via the display generation component, an affordance based on the user input.

32. A computer system that is in communication with a display generation component and one or more input devices, including a remote input device, the computer system comprising:
one or more processors; and
memory storing one or more programs configured to be executed by the one or more processors, the one or more programs including instructions for:
while a view of an environment is visible via the display generation component, detecting a first motion input that includes movement of the remote input device in a physical environment;
in response to detecting the first motion input:
in accordance with a determination that a gaze detected by the computer system was directed to a first object when the first motion input was detected, moving the first object in the environment in accordance with the first motion input; and
in accordance with a determination that the gaze detected by the computer system was not directed to the first object when the first motion input was detected, forgoing moving the first object in the environment in accordance with the first motion input.
